(19) United States
(12) Patent Application Publication
(10) Pub. No.: US 2016/0166952 A1
(43) Pub. Date: Jun. 16, 2016

(54) COALESCING FILTER SEPARATION SYSTEM AND METHOD

(71) Applicant: Porous Media Corporation, St. Paul, MN (US)

(72) Inventors: Carl William Hahn, Houston, TX (US); Isaac Aslan Johnson, Cypress, TX (US); Philip Jordan Wade, Houston, TX (US); James Caleb Allen, Houston, TX (US); Paul A. Waters, Conroe, TX (US)

(21) Appl. No.: 14/571,190

(22) Filed: Dec. 15, 2014

(51) Int. Cl. B01D 29/54

(52) U.S. Cl. CPC B01D 29/54

(57) ABSTRACT

Embodiments of the invention provide a coalescing filter assembly including a filter element with longitudinally coupled filter lobes. The filter element can include a fluid inlet, filtration media, and fluid outlets. In some embodiments, the filter element can include a hydrophobic surface, a super-hydrophobic surface, or a super-oleophobic surface. Some embodiments include a coalescing filter assembly system that includes a filter housing defining a lower sump and an upper sump, a vessel inlet and outlet, and a tube sheet with a plurality of openings positioned between the upper and lower sumps. In some embodiments, one or more coalescing filter assemblies can be coupled to risers and to the plurality of openings. In some embodiments, fluid can be filtered by the system by passing fluid from the vessel inlet, through at least one fluid inlet, filtration media, and through a plurality of fluid outlets of at least one filter element.

### BACKGROUND

Petroleum producers, refiners and gas processors (including onshore and offshore), and chemical manufacturers utilize separation systems to filter, process, and recover hydrocarbons and other chemical products from a variety of raw material process fluid streams. Common liquids found in these fluid streams include lubrication oils, water, salt water, acids, caustics, hydrocarbons, completion fluids, glycol and amine. The liquid portion of these types of fluids is generally present in the form of tiny droplets, or aerosols. The size distribution of the aerosols is primarily dependent on the surface tension of the liquid contaminant and the process from which they are generated. As the surface tension is reduced, the size of the aerosol is reduced accordingly.

Separation systems must account for the complex nature of the inlet stream that can comprise a heterogeneous mixture of solids, liquids, and gaseous materials that require processing to achieve separation of one or more components with a predetermined efficiency. Typically, greater than 50% of all aerosols comprising glycols, amines and hydrocarbons, or mixtures thereof by weight are less than one micron in diameter. Conventional filtration/separation equipment such as settling chambers, wire mesh (impingement) separators, centrifugal or vane (mechanical) separators, and coarse glass or cellulose filters are only marginally efficient at one micrometer separations and remove virtually none of the prevalent sub-micron sized aerosols and particles. In order to remove these problem-causing contaminants, high efficiency coalescing filters must be used.

In these applications, it is common to use coalescing elements secured within a pressure-containing vessel or housing to form a coalescing filter assembly. The continuous phase gas or liquid contains dispersed liquid aerosol droplets, sometimes referred to as the discontinuous phase. The mixture enters the assembly through an inlet connection, and then flows to the inside of the coalescing element. As the fluid flows through the filter media of the coalescing element, the liquid droplets contact the fibers in the media and are removed from the fluid stream. Within the media, the droplets coalesce with other droplets, and grow to emerge as large droplets on the downstream surface of the element. These droplets can then be gravitationally separated from the continuous phase fluid. If the density of the droplets is greater than that of the fluid, such as oil droplets in air, the droplets will settle gravitationally to the bottom of the filter assembly, countercurrent to the upward flow of air. If the density of the droplets is less than that of the fluid (e.g., such as oil droplets in water) the droplets will rise to the top of the assembly counter-current to the downward flow of the water.

Furthermore, the pressure drop which results from the gas entering the open end of the element is a function of the inside diameter of the element. The inside diameter of cylindrical elements is limited by the diameter of the housing, the thickness of the wall of the element, and the size of the annular space. The smaller the inside diameter, the higher the pressure drop will be for a given flow rate.

It is advantageous to maintain sufficiently low annular velocities so as not to re-entrain liquid droplets. Moreover, it is desirable to maximize the flow rate of the fluid through the assembly while not reducing separation efficiencies in order to reduce the size of the housing required for a given flow rate and thereby reduce the manufacturing costs.

### SUMMARY

Some embodiments include a coalescing filter assembly comprising at least one filter element comprising at least one opening at a first end, at least one fluid inlet, and a plurality of filter lobes comprising at least one side wall. The at least one side wall comprises a plurality of fluid outlets, and an open end cap positioned at the first end. The open end cap comprises a main opening fluidly coupled to the at least one opening, and a closed end cap positioned at a second end of the filter element.

In some embodiments, the cross-section of at least a portion of the at least one filter element comprises a substantially trefoil shape. In some further embodiments, the plurality of filter lobes comprises at least three lobes comprising a first lobe, a second lobe, and a third lobe. In some embodiments, the at least one side wall is shared between the plurality of filter lobes.

In some embodiments, the at least one filter element includes at least one concave region positioned substantially between at least two of the plurality of filter lobes. Some embodiments include a plurality of filter lobes and the at least one concave region that extend at least partially along the longitudinal length of the at least one filter element.

In some embodiments, the plurality of filter lobes includes more than three lobes. In some further embodiments, the open end cap comprises a plurality of open end cap lobes, and at least one of the open end cap lobes is fluidly coupled to at least one of the at least one openings. In some embodiments, the at least one wall comprises a filtration media. In some embodiments of the invention, the filtration media comprises a plurality of fluid passages.

In some embodiments of the invention, at least a portion of the at least one filter comprises a surface property that is at least one of a hydrophobic surface, a super-hydrophobic surface, and a super-oleophobic surface.

Some embodiments of the invention include a coalescing filter assembly comprising at least one filter element comprising at least one opening at a first end, at least one fluid inlet, and a plurality of lobes comprising at least one side wall. The at least one wall comprises a plurality of fluid outlets, and an open end cap positioned at the first end, where the open end cap comprises a main opening fluidly coupled to the at least one opening. Further, the coalescing filter assembly comprises a closed end cap coupled to a second end of the filter element, where at least a portion of the at least one filter element comprises a surface property that is at least one of a hydrophobic surface, a super-hydrophobic surface, and a super-oleophobic surface.

Some embodiments of the invention include a filter assembly comprising a filter vessel housing a plurality of coalescing filter assemblies. Each coalescing filter assembly comprises at least one filter element comprising at least one opening at a first end, at least one fluid inlet, and a plurality of lobes comprising at least one side wall. The at least one wall comprises a plurality of fluid outlets, and an open end cap is positioned at the first end. The open end cap comprises a main opening fluidly coupled to the at least one opening, and a closed end cap coupled to a second end of the filter element. The plurality of coalescing filter assemblies comprises at least one central filter assembly positioned at a substantial center of the filter vessel, and a plurality of outer filter assemblies positioned substantially encircling the at least one central filter assembly. Further, the plurality of outer filter assemblies includes at least a first outer ring of filter assemblies substantially encircling the at least one central filter assembly.

Some embodiments of the invention include at least a second outer ring of filter assemblies substantially encircling the first outer ring of filter assemblies. Some further embodiments include at least one of the plurality of coalescing filter assemblies that is rotated by about 120° relative to at least one neighboring coalescing filter assembly.

Some embodiments of the invention include a fluid coalescing filter assembly system comprising a filter vessel including a vessel inlet and a vessel outlet, where the filter vessel defines a lower sump and an upper sump. The system comprises a plurality of coalescing filter assemblies positioned within the filter vessel. Further, each coalescing filter assembly comprises at least one filter element comprising at least one opening at a first end, at least one fluid inlet, and a plurality of lobes comprising at least one side wall. The at least one wall comprises a plurality of fluid outlets, and at least a portion of the at least one filter element comprises a surface property that is at least one of a hydrophobic surface, a super-hydrophobic surface, and a super-oleophobic surface. The system comprises an open end cap positioned at the first end and comprises a main opening fluidly coupled to the at least one opening, and a closed end cap positioned at a second end of the filter element. The system includes a plurality of coalescing filter assemblies that comprise at least one central filter assembly positioned at a substantial center of the filter vessel, and a plurality of outer filter assemblies positioned substantially encircling the at least one central filter assembly.

In some embodiments, the filter housing encloses a tube sheet comprising a plurality of openings, the tube sheet positioned between the upper sump and the lower sump. Some embodiments include a plurality of risers each including a first end and a second end. The plurality of risers is positioned coupling the first end to the plurality of openings.

In some embodiments, the plurality of risers include end cap portions at the second end, and the plurality of coalescing filter assemblies are coupled to the plurality of risers by coupling the main opening to the end cap portions.

In some further embodiments of the invention, the plurality of coalescing filter assemblies comprises at least one central filter assembly positioned at a substantial center of the filter vessel, and a plurality of outer ring filter assemblies positioned substantially encircling the at least one central filter assembly.

In some embodiments, a plurality of outer ring filter assemblies includes at least a first outer ring of filter assemblies substantially encircling the at least one central filter assembly and at least a second outer ring of filter assemblies substantially encircling the first outer ring of filter assemblies.

Some embodiments of the system comprise at least one of the plurality of coalescing filter assemblies that is rotated by about 120° relative to at least one neighboring coalescing filter assembly.

### DESCRIPTION OF THE DRAWINGS

FIG. 1A illustrates a perspective view of a coalescing filter assembly according to at least one embodiment of the invention.

FIG. 1B illustrates a perspective view of a coalescing filter assembly according to at least one embodiment of the invention.

FIG. 1C illustrates a side view of a coalescing filter assembly according to at least one embodiment of the invention.

FIG. 1D illustrates a side cross-sectional view of a coalescing filter assembly according to at least one embodiment of the invention.

FIG. 1E shows a section of a coalescing filter element in accordance with some embodiments of the invention.

FIG. 2A illustrates a partial perspective view of a coalescing filter assembly showing an open end cap in accordance with some embodiments of the invention.

FIG. 2B illustrates a partial perspective view of a coalescing filter assembly showing a closed end cap in accordance with some embodiments of the invention.

FIG. 3A illustrates a perspective view of a coalescing filter assembly showing a closed end cap in accordance with some embodiments of the invention.

FIG. 3B illustrates a cross-sectional end view of a coalescing filter assembly showing an open end cap in accordance with some embodiments of the invention.

FIG. 3C illustrates a perspective view of a coalescing filter assembly in accordance with some further embodiments of the invention.

FIG. 3D illustrates a perspective view of a coalescing filter assembly in accordance with some further embodiments of the invention.

FIG. 3E illustrates a perspective view of a cross-section of a coalescing filter assembly in accordance with some further embodiments of the invention.

FIG. 3F illustrates a perspective view of a cross-section of a coalescing filter assembly in accordance with some further embodiments of the invention.

FIG. 3G illustrates a perspective view of a portion of a cross-section of a coalescing filter assembly in accordance with some further embodiments of the invention.

FIG. 3H illustrates a perspective view of a portion of a cross-section of a coalescing filter assembly in accordance with some further embodiments of the invention.

FIG. 3I illustrates a perspective assembly view of a portion of a coalescing filter assembly in accordance with some further embodiments of the invention.

FIG. 3J illustrates a perspective assembly view of a portion of a coalescing filter assembly in accordance with some further embodiments of the invention.

FIG. 3K illustrates a packing arrangement of a plurality of coalescing filter assemblies in accordance with some further embodiments of the invention.

FIG. 3L illustrates a perspective assembly view of a portion of an internal cross-section of coalescing filter assembly in accordance with some further embodiments of the invention.

FIG. 4A illustrates a cross-sectional representation of a design of a coalescing filter assembly in accordance with some embodiments of the invention.

FIG. 4B illustrates a cross-sectional representation of a design of a coalescing filter assembly in accordance with some embodiments of the invention.

FIG. 4C illustrates a cross-sectional representation of a design of a coalescing filter assembly in accordance with some embodiments of the invention.

FIG. 4D illustrates a cross-sectional representation of a design of a coalescing filter assembly in accordance with some embodiments of the invention.

FIG. 4E illustrates a cross-sectional representation of a design of a coalescing filter assembly in accordance with some embodiments of the invention.

FIG. 4F illustrates a cross-sectional representation of a design of a coalescing filter assembly in accordance with some embodiments of the invention.

FIG. 4G illustrates a cross-sectional representation of a design of a coalescing filter assembly in accordance with some embodiments of the invention.

FIG. 5 illustrates a representation of a packing arrangement of a prior art coalescing filter assembly.

FIG. 6 illustrates a representation of a packing arrangement of a prior art coalescing filter assembly.

FIG. 7A illustrates a representation of a packing arrangement of a coalescing filter assembly in accordance with some embodiments of the invention.

FIG. 7B illustrates a perspective view of a representation of a packing arrangement of a coalescing filter assembly in accordance with some embodiments of the invention.

FIG. 7C illustrates a perspective view of a representation of a packing arrangement of a coalescing filter assembly in accordance with some embodiments of the invention.

FIG. 7D illustrates an end view of a representation of a packing arrangement of a coalescing filter assembly showing closed end caps in accordance with some embodiments of the invention.

FIG. 7E illustrates an end view of a representation of a packing arrangement of a coalescing filter assembly showing open end caps in accordance with some embodiments of the invention.

FIG. 8 illustrates a representation of a packing arrangement of a coalescing filter assembly in accordance with some embodiments of the invention.

FIG. 9 illustrates a representation of a packing arrangement of a coalescing filter assembly in accordance with some embodiments of the invention.

FIG. 10 illustrates coalescing filter packing data comparing conventional and coalescing filter assembly in accordance with some embodiments of the invention.

FIG. 11A illustrates a perspective view with a partial cross-section view of a gas coalescence filtration and process system in accordance with some embodiments of the invention.

FIG. 11B illustrates a top view of a gas coalescence filtration and process system in accordance with some embodiments of the invention.

FIG. 11C illustrates a partial perspective view with a partial cross-section view of a gas coalescence filtration and process system in accordance with some embodiments of the invention.

FIG. 12A illustrates a side cross-sectional view of a gas coalescence filtration and process system in accordance with some embodiments of the invention.

FIG. 12B illustrates a perspective cross-sectional view of a gas coalescence filtration and process system in accordance with some embodiments of the invention.

FIG. 12C illustrates a perspective cross-sectional view of a gas coalescence filtration and process system in accordance with some embodiments of the invention.

FIG. 12D illustrates a perspective cross-sectional view of a portion of a gas coalescence filtration and process system in accordance with some embodiments of the invention.

FIG. 12E illustrates a perspective cross-sectional view of a portion of a gas coalescence filtration and process system in accordance with some embodiments of the invention.

FIG. 13A illustrates a plot of carry over as a function of time comparing conventional and a gas coalescence filtration and process system in accordance with some embodiments of the invention.

FIG. 13B illustrates a plot of differential pressure as a function of time comparing conventional and a gas coalescence filtration and process system in accordance with some embodiments of the invention.

FIG. 14A illustrates a graph showing total possible flow through comparing conventional and a gas coalescence filtration and process system in accordance with some embodiments of the invention.

FIG. 14B illustrates a graph showing necessary vessel size for gas throughput through comparing conventional and a gas coalescence filtration and process system in accordance with some embodiments of the invention.

FIG. 15 illustrates a graph of aerosol carryover as a function of time and a variety of flow rates comparing a standard filter element and a standard filter element with surface modification in accordance with some embodiments of the invention.

FIG. 16 illustrates a perspective view of a coalescing filter assembly in accordance with some embodiments of the invention.

FIG. 17 illustrates a perspective view of a coalescing filter assembly in accordance with some embodiments of the invention.

FIG. 18 illustrates a close up view of a region of the coalescing filter assembly shown in FIG. 16 in accordance with some embodiments of the invention.

FIG. 19 illustrates side view of a coalescing filter assembly in accordance with some embodiments of the invention.

FIG. 20 illustrates a top view of a coalescing filter assembly in accordance with some embodiments of the invention.

FIG. 21 illustrates bottom view of a coalescing filter assembly in accordance with some embodiments of the invention.

FIG. 22 illustrates a side sectional view of a coalescing filter assembly in accordance with some embodiments of the invention.

FIG. 23 illustrates a close up view of a region of the coalescing filter assembly shown in FIG. 22 in accordance with some embodiments of the invention.

FIG. 24 illustrates an assembly perspective view of the coalescing filter assembly shown in FIG. 16 in accordance with some embodiments of the invention.

FIG. 25 illustrates an assembly perspective view of the coalescing filter assembly shown in FIG. 17 in accordance with some embodiments of the invention.

FIG. 26 illustrates an assembly close-up view of a region of the coalescing filter assembly shown in FIG. 24 in accordance with some embodiments of the invention.

FIG. 27 illustrates an assembly side view of the coalescing filter assembly shown in FIG. 19 in accordance with some embodiments of the invention.

FIG. 27A shows a close-up view of the region in FIG. 27 in accordance with some embodiments of the invention.

FIG. 28 illustrates a top view of the coalescing filter assembly in accordance with some embodiments of the invention

FIG. 29 illustrates a bottom view of the coalescing filter assembly in accordance with some embodiments of the invention.

FIG. 30 illustrates a side cross sectional view of the coalescing filter assembly of FIG. 27 in accordance with some embodiments of the invention.

FIG. 31 illustrates a close-up of a region of the side cross sectional view of the coalescing filter assembly of FIG. 30 in accordance with some embodiments of the invention.

FIG. 32 illustrates a perspective view of a coalescing filter assembly in accordance with some embodiments of the invention.

FIG. 33 illustrates a perspective view of a coalescing filter assembly in accordance with some embodiments of the invention.

FIG. 34 illustrates a close-up view of a region of the coalescing filter assembly of FIG. 32 in accordance with some embodiments of the invention.

FIG. 35 illustrates a side view of a coalescing filter assembly in accordance with some embodiments of the invention.

FIG. 36 illustrates a top view of a coalescing filter assembly in accordance with some embodiments of the invention.

FIG. 37 illustrates a bottom view of a coalescing filter assembly in accordance with some embodiments of the invention.

FIG. 38 illustrates a side cross sectional view of the coalescing filter assembly in accordance with some embodiments of the invention.

FIG. 39 illustrates a illustrates a close-up of a region of the side cross sectional view of the coalescing filter assembly of FIG. 38 in accordance with some embodiments of the invention.

FIG. 40 illustrates a perspective assembly view of the coalescing filter assembly of FIG. 32 in accordance with some embodiments of the invention.

FIG. 41 illustrates a perspective assembly view of the coalescing filter assembly of FIG. 32 in accordance with some embodiments of the invention.

FIG. 42 illustrates a close up view of a region of the coalescing filter assembly of FIG. 40 in accordance with some embodiments of the invention.

FIG. 43 illustrates a side perspective assembly view of the coalescing filter assembly of FIG. 40 in accordance with some embodiments of the invention.

FIG. 43A illustrates a close up of a region of the coalescing filter assembly of FIG. 43 in accordance with some embodiments of the invention.

FIG. 44 illustrates a top view of the coalescing filter assembly of FIG. 43 in accordance with some embodiments of the invention.

FIG. 45 illustrates a bottom view of the coalescing filter assembly of FIG. 43 in accordance with some embodiments of the invention.

FIG. 46 illustrates a side cross-sectional view of the coalescing filter assembly of FIG. 43 in accordance with some embodiments of the invention.

FIG. 47 illustrates a close up view of a region of the coalescing filter assembly of FIG. 46 in accordance with some embodiments of the invention.

FIG. 48 illustrates a perspective assembly view of the coalescing filter assembly in accordance with some embodiments of the invention.

FIG. 49 illustrates a perspective assembly view of the coalescing filter assembly in accordance with some embodiments of the invention.

FIG. 50 illustrates a close up view of a region of the coalescing filter assembly of FIG. 48 in accordance with some embodiments of the invention.

FIG. 51 illustrates a side view of the coalescing filter assembly of FIG. 48 in accordance with some embodiments of the invention.

FIG. 52 illustrates a top view of the coalescing filter assembly of FIG. 48 in accordance with some embodiments of the invention.

FIG. 53 illustrates a bottom view of the coalescing filter assembly of FIG. 48 in accordance with some embodiments of the invention.

FIG. 54 illustrates a side cross-sectional view of the coalescing filter assembly of FIG. 48 in accordance with some embodiments of the invention.

FIG. 55 illustrates a close up view of a region of the coalescing filter assembly of FIG. 54 in accordance with some embodiments of the invention.

FIG. 56 illustrates a perspective view of a sealing assembly in accordance with some embodiments of the invention.

FIG. 57 illustrates a side view of a sealing assembly in accordance with some embodiments of the invention.

FIG. 58 illustrates an end view of a sealing assembly in accordance with some embodiments of the invention.

FIG. 59 illustrates a perspective view of a sealing coupler in accordance with some embodiments of the invention.

FIG. 60 illustrates an end view of a sealing coupler in accordance with some embodiments of the invention.

FIG. 61 illustrates a side cross-sectional view of a sealing coupler in accordance with some embodiments of the invention.

FIG. 62 illustrates a perspective view of a sealing coupler in accordance with some embodiments of the invention.

FIG. 63 illustrates an end view of a sealing coupler in accordance with some embodiments of the invention.

FIG. 64 illustrates a side cross-sectional view of a sealing coupler in accordance with some embodiments of the invention.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The following detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives that fall within the scope of embodiments of the invention. Moreover, the figures disclosed and described herein represent high-level visualizations. Those of ordinary skill in the art will appreciate that each figure is presented for explanation only and does not include each and every decision, function, and feature that may be implemented. Likewise, the figures and related discussions are not intended to imply that each and every illustrated decision, function, and feature is required or even optimal to achieve the disclosed desired results.

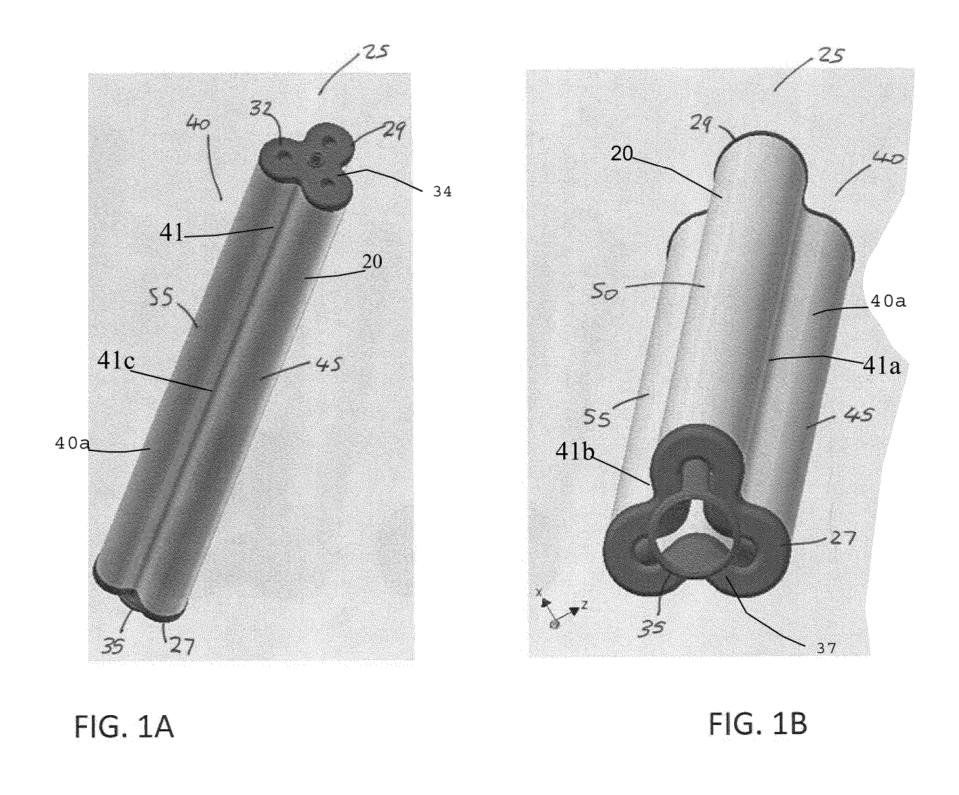

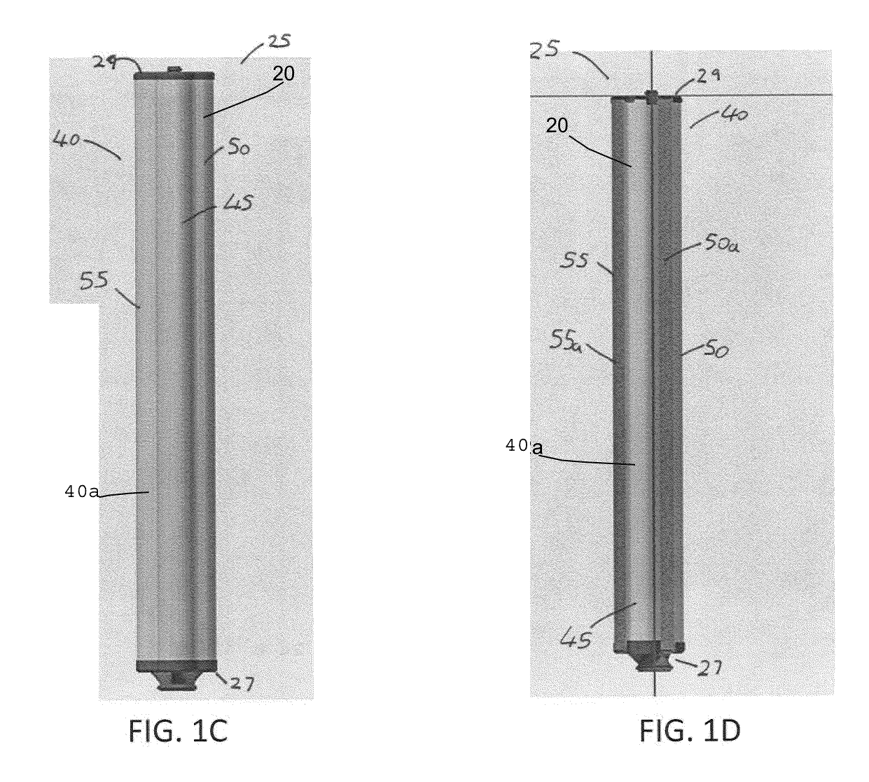

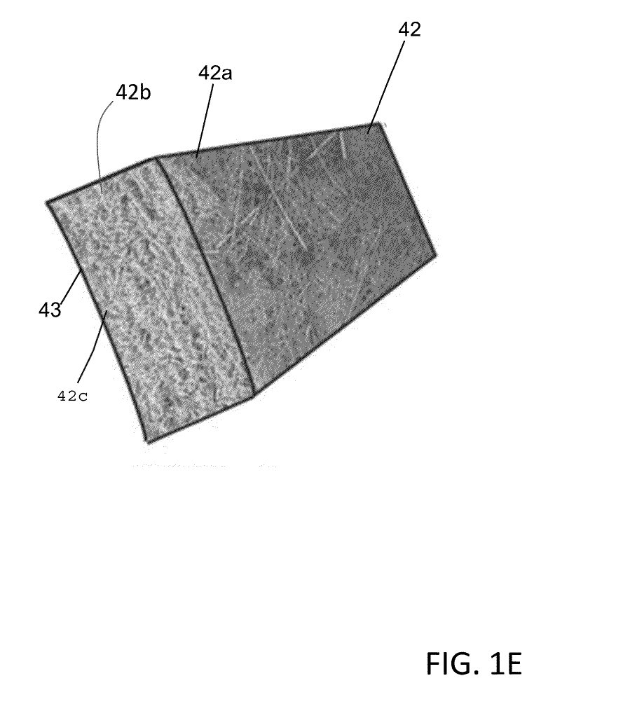

Some embodiments shown in FIGS. 1A-1D, 2A-2B, 3A-3J, 7A-7E, 8-9, and 11A-11C, and 12A-12E provide a compact, flexible, and modular separation and filtration technology that can be used to process a variety of process streams including solids, liquids, and gases, and mixtures thereof. Some embodiments can separate, filter, process, and recover hydrocarbons and other chemical products from a wide variety of raw material process streams, and offer process flexibility to enable customization to one or more processes depending on the input stream and output stream specification and desired efficiency.

FIGS. 1A and 1B illustrate perspective views of a coalescing filter assembly 25, and FIG. 1C illustrates a side view of a coalescing filter assembly 25 according to at least one embodiment of the invention. As illustrated, some embodiments of the invention can include a coalescing filter assembly 25 comprising at least one filter element 20 that comprises a plurality of lobes 40 extending between a first end 27 and a second end 29. In the example embodiment shown in FIGS. 1A-1C, the coalescing filter assembly 25 can comprise three lobes. For example, in some embodiments, the plurality of lobes 40 can comprise a first lobe 45, a second lobe 50, and a third lobe 55, each extending between the first end 27 and the second end 29.

In some embodiments, the coalescing filter assembly 25 can comprise at least one filter element 20 comprising a plurality of lobes 40 that can comprise at least one side wall 40a. Further, some embodiments of the invention include at least one side wall 40a that is common or shared. For example, in some embodiments, the first lobe 45, the second lobe 50, and the third lobe 55 can comprise at least one side wall 40a that is commonly shared between all the three lobes 45, 50, 55.

In some embodiments, coalescing filter assembly 25 can include a filter element 20 that can comprise at least one side wall 40a that comprises and/or forms at least one concave region 41 in the filter element 20. For example, some embodiments include at least one concave region 41 extending substantially between two of the plurality of lobes 40. In some embodiments, the coalescing filter assembly 25 can comprise a filter element 20 comprising a plurality of lobes 40 and at least one concave region 41 extending at least partially along the longitudinal length of the filter element 20 within the coalescing filter assembly 25. The at least one concave region can comprise a first concave region 41a, a second concave region 41b, and a third concave region 41c. Further, in some embodiments, each of the first lobe 45, the second lobe 50, and the third lobe 55 can be directly coupled to each other along a portion of or substantially their entire longitudinal lengths. For example, in some embodiments, the first lobe 45 can be immediately adjacent to and coupled to both the second lobe 50 and the third lobe 55. As a consequence, in some embodiments, a lateral cross-section of the coalescing filter assembly 25 can comprise a substantially trefoil shape comprising three lobes formed by the coupling of the first lobe 45, the second lobe 50, and the third lobe 55, and with a first concave region 41a extending at least partially along the longitudinal length of the filter element 20 between the first lobe 45 and the second lobe 50, and a second concave region 41b between the second lobe 50 and the third lobe 55, and a third concave region 41c extending between the first lobe 45 and the third lobe 55.

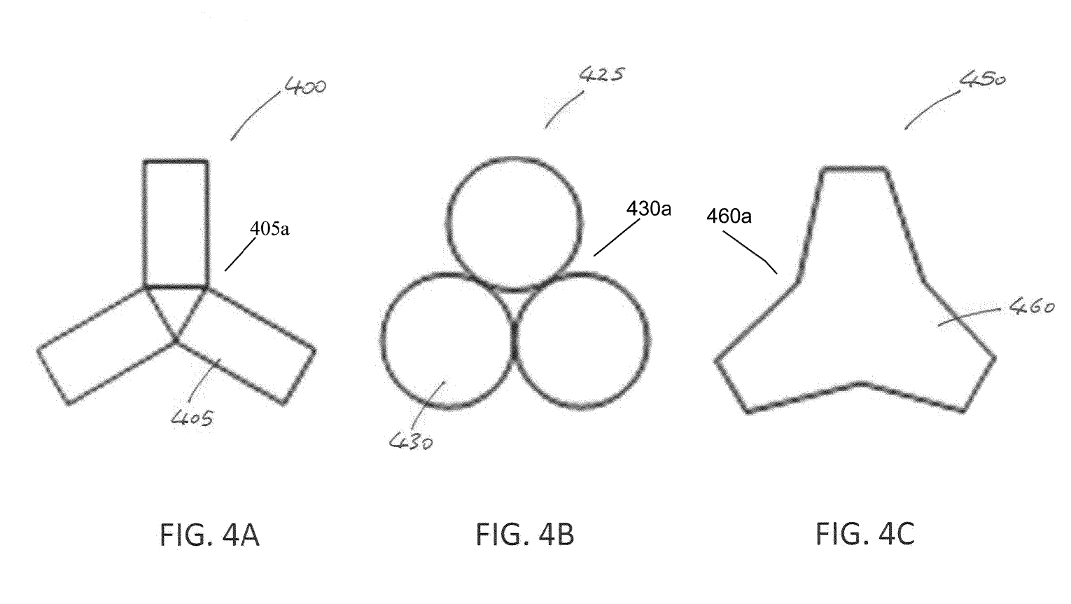

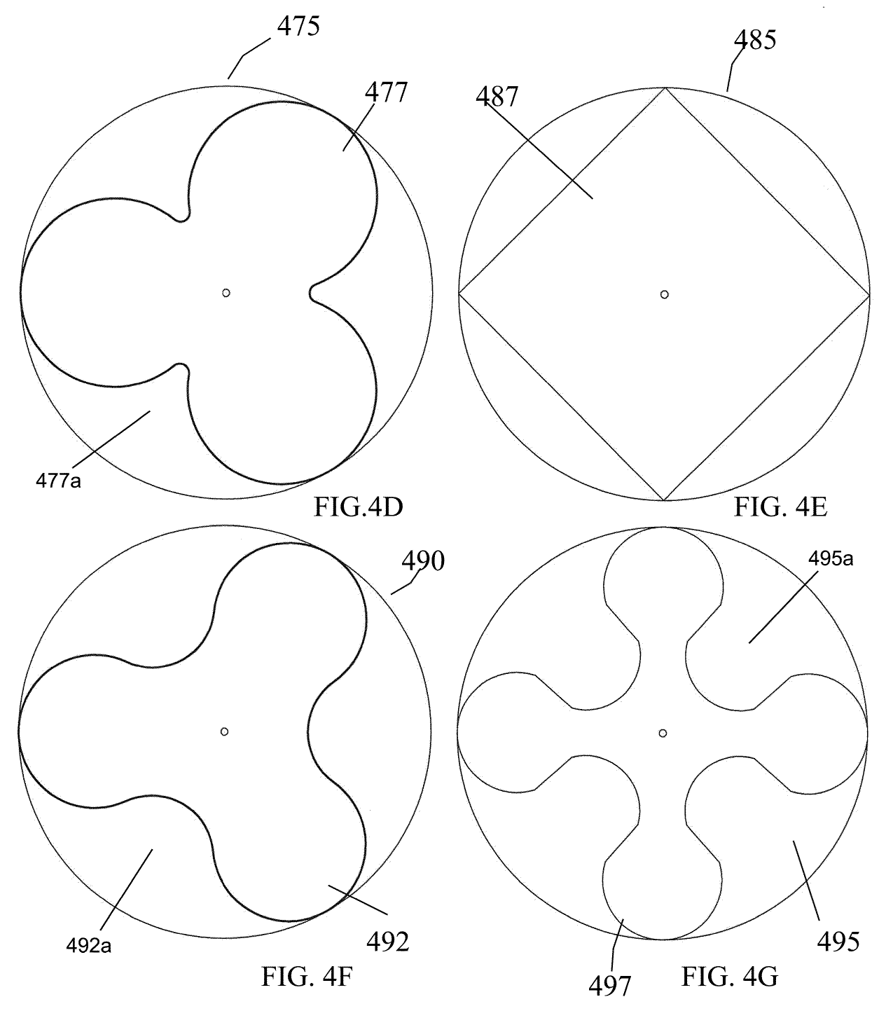

In some other embodiments, the coalescing filter assembly 25 can include a plurality of filter lobes with separate side walls. For example, in some embodiments, the coalescing filter assembly 25 can comprise discrete filter lobes, each of which can comprise a side wall (see for example, the cross-sectional representation of FIG. 4B showing the coalescing filter assembly 425 with circular lobes 430, each of which comprise their own side wall not shared with any other filter.) In this instance, when considering the lateral cross-section, the arrangement provides an example of circle packing, where each of the lobes 430 are positioned inside a given boundary such that no two overlap, and are mutually tangent (i.e., each pair of them touch at a single point).

In some embodiments of the invention, the coalescing filter assembly 25 can include one or more structures for providing support and fluid coupling to the at least one filter element 20. For example, as illustrated at least in FIGS. 1A-1D, 2A-2B, and 3A-3B, in some embodiments of the invention, the coalescing filter assembly 25 can include a first end 27 that can comprise an open end cap 35. Further, in some embodiments, the second end 29 of the coalescing filter assembly 25 can comprise a closed end cap 32. In some embodiments, the open end cap 35 can be partially closed and/or the closed end cap 32 can include one or more apertures.

In some embodiments, the filter element 20 can be coupled to the open end cap 35 and/or the closed end cap 32 using a variety of conventional coupling techniques. For example, in some embodiments, the filter element 20 can be coupled to the open end cap 35 and/or the closed end cap 32 using a conventional adhesive. In some embodiments, the filter element 20 can be coupled to the open end cap 35 and/or the closed end cap 32 using a push-fit, a snap-fit, or a crimp-fit either alone, or in combination with a conventional adhesive. Therefore, in some embodiments, the coalescing filter assembly 25 can include a filter element 20 comprising a first lobe 45, the second lobe 50, and the third lobe 55 that can couple to and extend between the open end cap 35 at the first end 27, and a closed end cap 32 at a second end 29, and generally forming a three-lobed shaped first end 27 (shown in the perspective view of FIG. 1B), and a lobed shaped second end 29 (shown in the perspective view of FIG. 1A.)

FIG. 1D illustrates a side cross-section view of a coalescing filter assembly 25 according to at least one embodiment of the invention. In this example, a cross-section has been taken through a pair of filter lobes 50, 55 of a filter element 20 of an assembly 25, illustrating internal surface 50a of the second lobe 50, and internal surface 55a of the third lobe 55. FIG. 1E shows a section 42 of a coalescing filter element (i.e., a portion of any one of the plurality of lobes 40) in accordance with some embodiments of the invention. In some embodiments, any one of the plurality of lobes 40 (including for example the first lobe 45, the second lobe 50, and/or the third lobe 55) can comprise a section 42. As illustrated, in some embodiments, at least a portion of the plurality of lobes 40 can comprise a section 42 that can comprise a wall 42a comprising a filtration media 42b. For example, in some embodiments, the side wall 40a can comprise the wall 42a of the section 42.

In some embodiments, the filtration media 42b can include portions that can enable passage of fluids. For example, in some embodiments, the filtration media 42b can include continuous and/or discontinuous porosity, at least a portion of which can enable the movement of fluid. In some embodiments, fluid can enter the section 42 through the wall 42a, and can travel through at least a portion of the section 42. Some embodiments include a section 42 comprising fluid inlets 43. In some embodiments, at least a portion of the wall 42a and at least a portion of the filtration media 42b can comprise fluid passages 42c. In some embodiments, the fluid inlets 43 can be formed from and/or coupled to fluid passages 42c. Therefore, in some embodiments, the filtration media 42b can comprise a plurality of fluid passages 42c through which fluid can travel by entering the fluid inlets 43, and passing into one or more fluid passages 42c within the wall 42a.

Some embodiments of the invention can include materials and surfaces configured to improve aerosol rejection (such as inner surfaces 50a, 50b). For example, some embodiments of the invention can be manufactured so that at least a portion of the wall 40a of any of the filter lobes 45, 50, 55 can include hydrophobic, super-hydrophobic, and/or super-oleophobic materials, coatings, and surfaces to improve aerosol rejection. Further, in some embodiments, a hydrophobic, super-hydrophobic, and/or super-oleophobic surfaces can improve drainage of coalesced liquids from the element. In some embodiments, hydrophobic, super-hydrophobic and/or super-oleophobic surface modifications can enable at least a portion of the coalescing filter assembly 25 (such as any of the lobes 45, 50, 55) to operate at more than four times the flow velocity, while still achieving aerosol carryover of almost two orders of magnitude less than an identical element without the surface modification. For example, in some embodiments, any one of the plurality of lobes 40 can comprise a section 42 comprising a hydrophobic, super-hydrophobic, and/or super-oleophobic surface. Further, in some embodiments, any portion of the filtration media 42b can comprise a hydrophobic, super-hydrophobic, and/or super-oleophobic surface, where the filtration media 42b can form at least a portion of the first lobe 45, the second lobe 50, and/or the third lobe 55.

In some embodiments, a hydrophobic, super-hydrophobic, and/or super-oleophobic surface modification can be accomplished using a plasma treatment of any portion of the section 42, including the wall 42a (including the filtration media 42b) that can form at least a portion of any of the plurality of lobes 40. In some embodiments, the plasma treatment can include the presence of a fluorinated material creating a covalent attachment of the fluorinated material to one or more surfaces of the filter element 20, including for example at least some portion of the interior of the plurality of lobes 40. In some embodiments, at least some portion of at least one of the plurality of lobes 40 can be modified, including any portion of the first lobe 45, second lobe 50, and third lobe 55. In some embodiments, a plasma coating process can be performed on individual layers within a filter element, including any portion of the filtration media 42b, any portion of the wall 42a, and/or any portion of the fluid passages 42c.

In some further embodiments, hydrophobic, super-hydrophobic and/or super-oleophobic materials, coatings, and surfaces forming any portion of the filter element 20 can be achieved by applying other coatings to the elements, either covalently attached or non-covalently attached. For example, in some embodiments, at least some portion of the interior of the plurality of lobes 40 can be modified using a silation treatment (e.g., using organosilanes such as methylchorosilane, ethylchorosilane, and/or other alkyl-chlorosilanes). In some other embodiments, at least some portion of the interior of the plurality of lobes 40 (including any portion of the filtration media 42b) can be modified with appropriate surfactants (such as with a fluorosurfactant.) In some embodiments, fluorinated polymer coatings can be used in various embodiments of the invention. For example, coatings such as fluorochemical urethane polymer or oligomer coatings such as those described in U.S. patent application Ser. No. 11/498,508, the content of which is incorporated herein by reference. Further, other useful fluorinated stain repellents and release agents such as those described in U.S. patent application Ser. No. 11/279,272, the content of which is incorporated herein by reference.

In some embodiments, the filter element 20 can be manufactured in similar ways as the coalescing filters of the prior art. Such coalescing filters may have one or more support cores, support layers, end caps and elastomeric seals. For example, some embodiments of the invention can comprise multiple layers of filtration media, a steel core, a retainer, and drain layers. In some embodiments, the filtration media 42b can be manufactured into a seamless tube of non-woven fibers by applying a vacuum to the inside of a porous mandrel and submersing the mandrel in a slurry of fibers of various compositions as seen in U.S. Pat. No. 4,836,931 to Spearman and U.S. Pat. No. 4,052,316 to Berger. It is also possible that the filtration media 42b may be manufactured from non-woven media in a flat sheet form and rolled several times around a center core like devices seen in U.S. Pat. No. 3,802,160 to Foltz, U.S. Pat. No. 4,157,968 to Kronsbein, or U.S. Pat. No. 3,708,965 to Dominik. The non-woven media may be manufactured in flat sheet form and rolled several times around a cylindrical mandrel, impregnated with a resin binder to offer rigidity, and the mandrel removed as seen in U.S. Pat. No. 4,006,054, and U.S. Pat. No. 4,102,785 to Head, and U.S. Pat. No. 4,376,675 to Perotta. In some embodiments, the filtration media 42b can comprise randomly oriented fibers comprising borosilicate glass, polypropylene, polyethylene, polyester, nylon, polytetrafloroethylene, ceramic, cellulose, steel, stainless steel, inconel, monel or copper. Further, some details the materials and processes useful for making filtration media 42b, including methods of manufacture and other coalescing filter embodiments useful in designing and manufacturing some embodiments of the invention described herein can be found U.S. Pat. No. 5,750,024, the content of which is incorporated herein by reference.

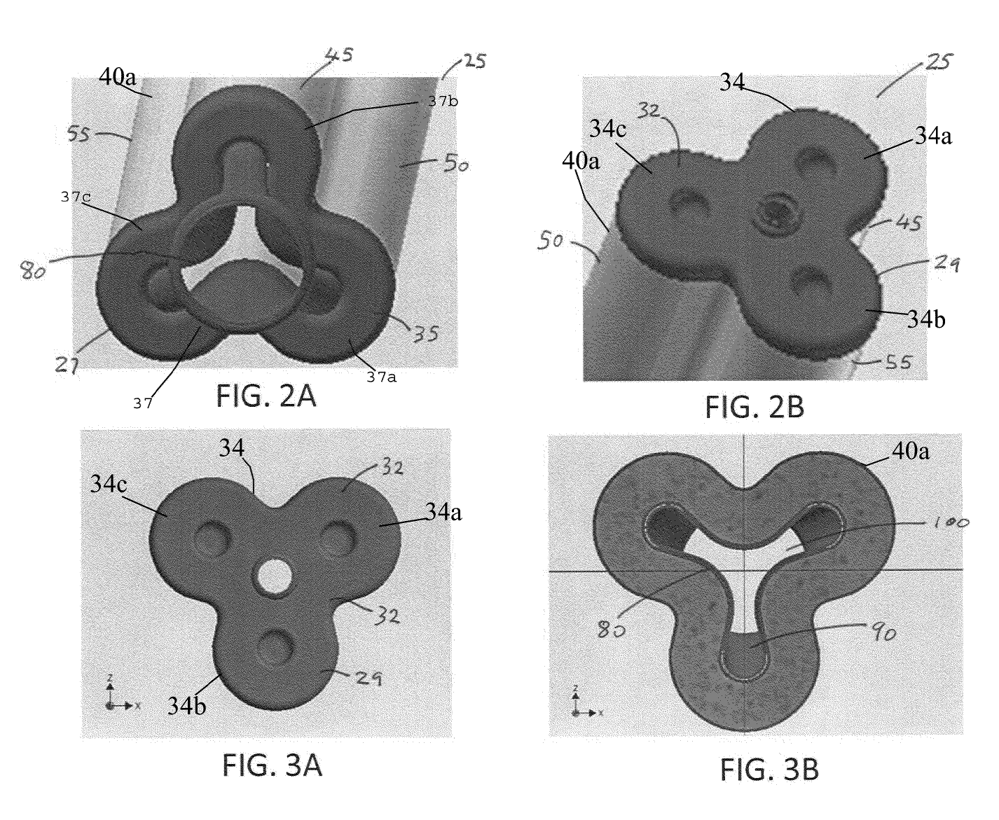

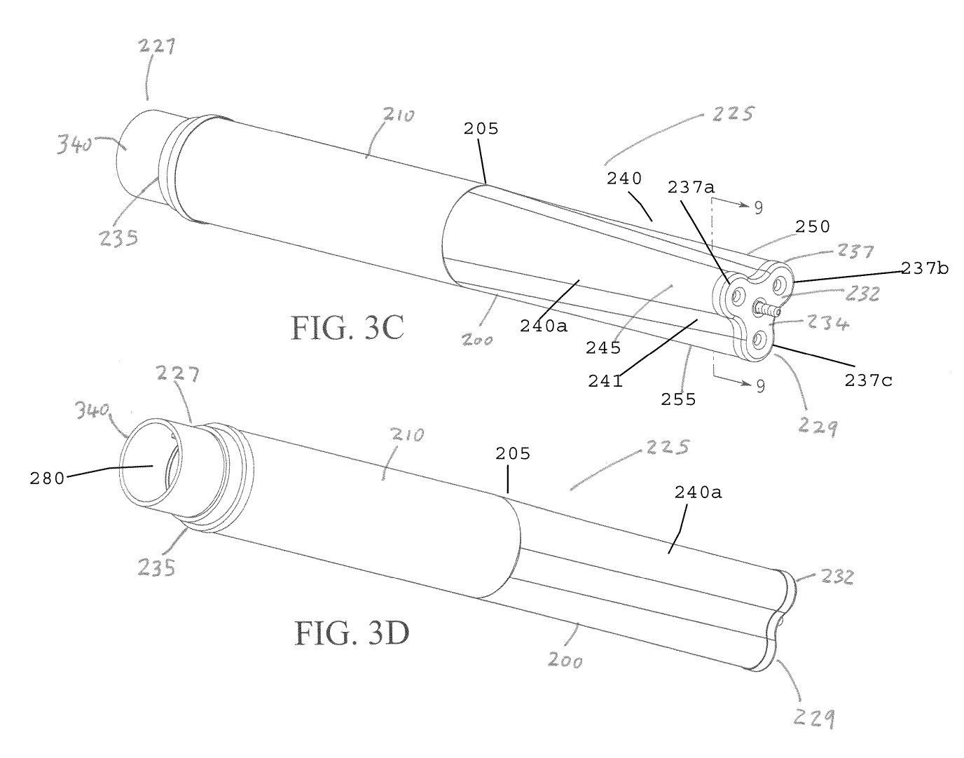

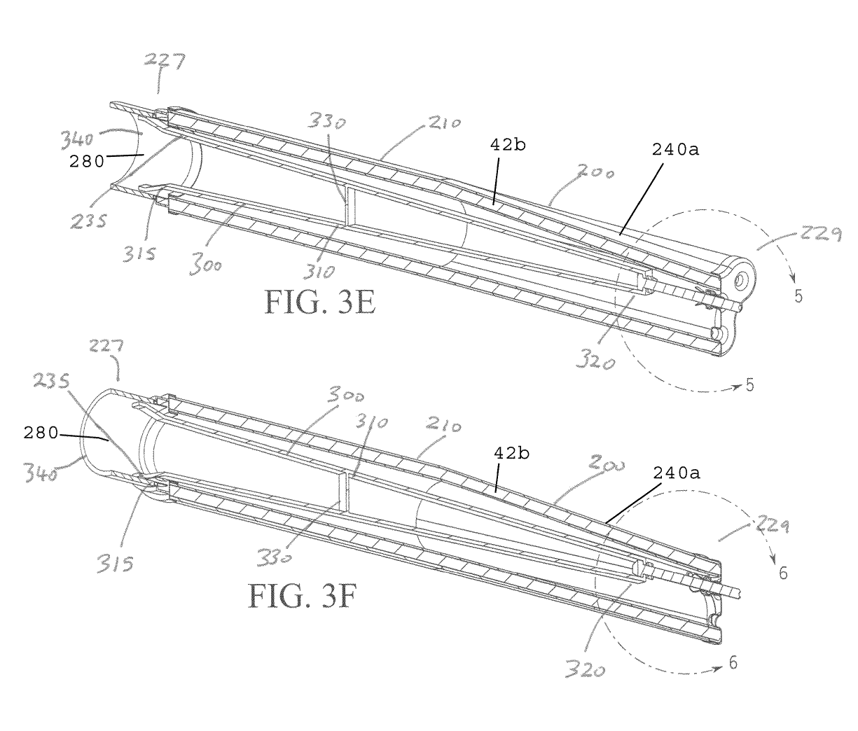

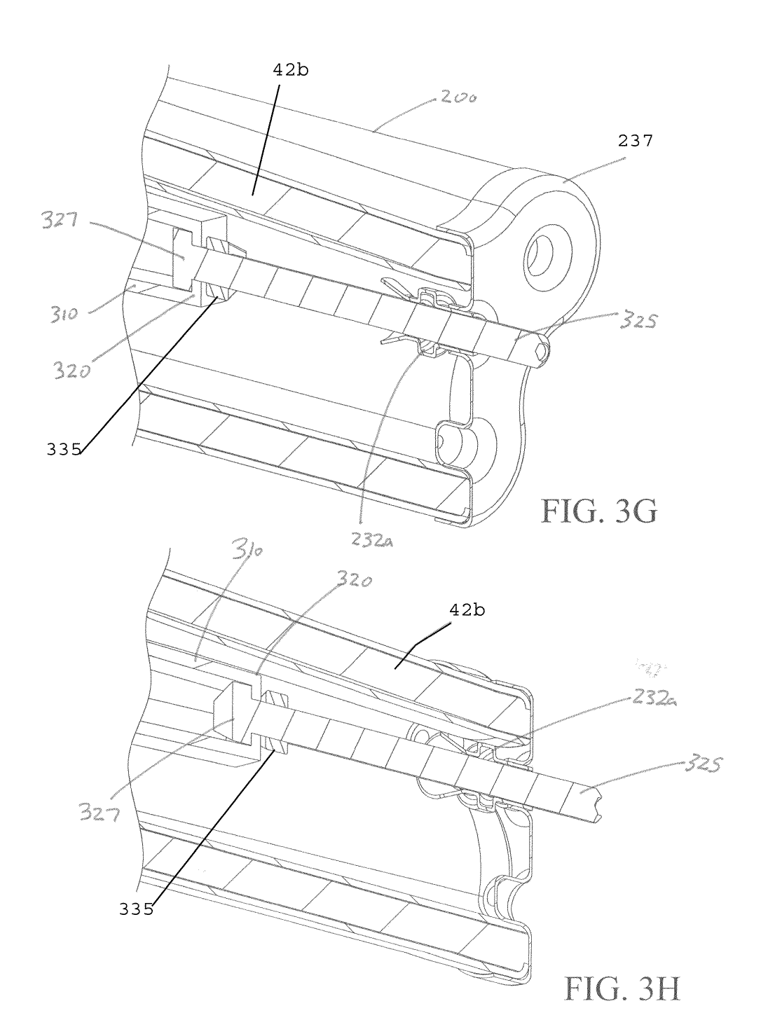

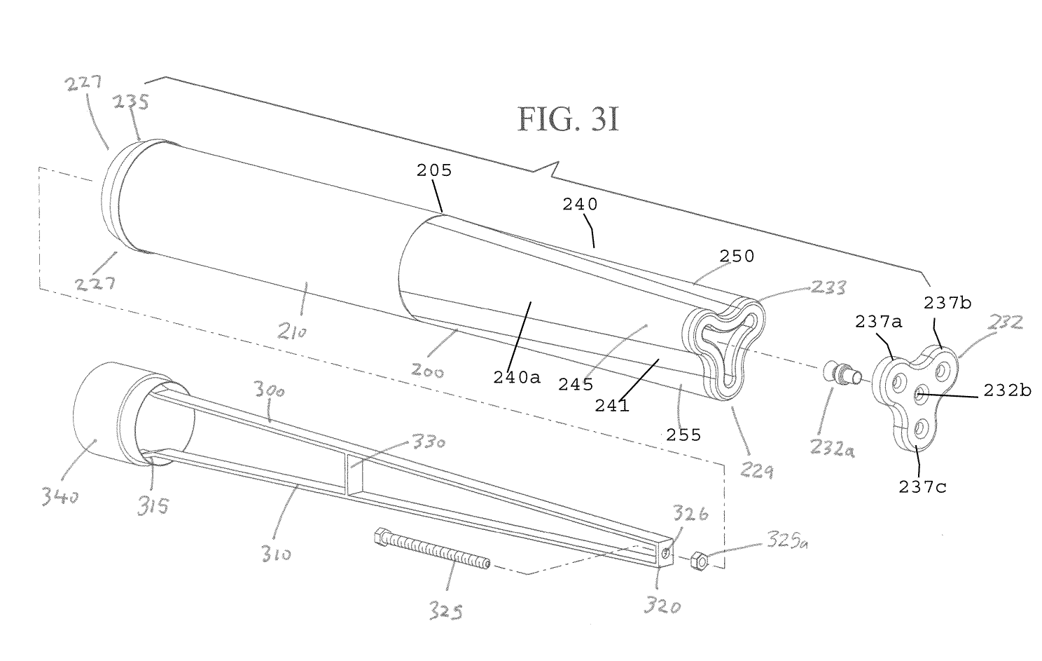

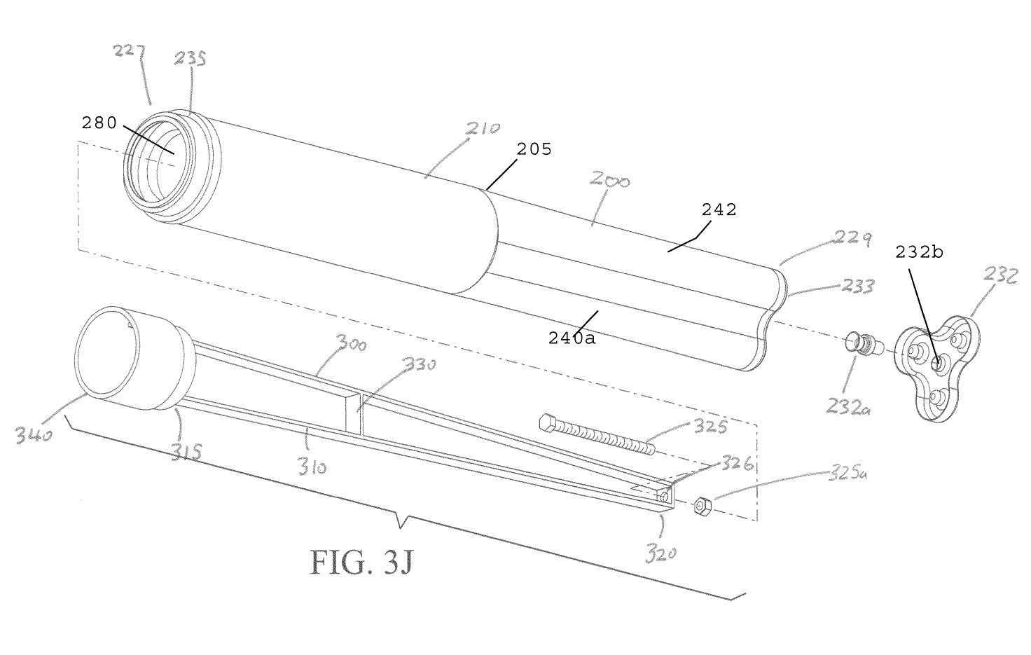

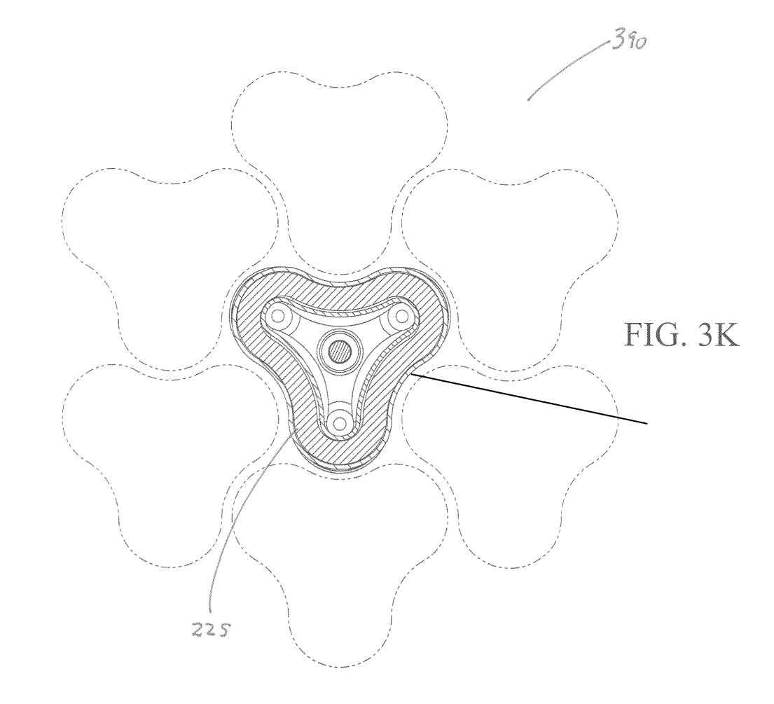

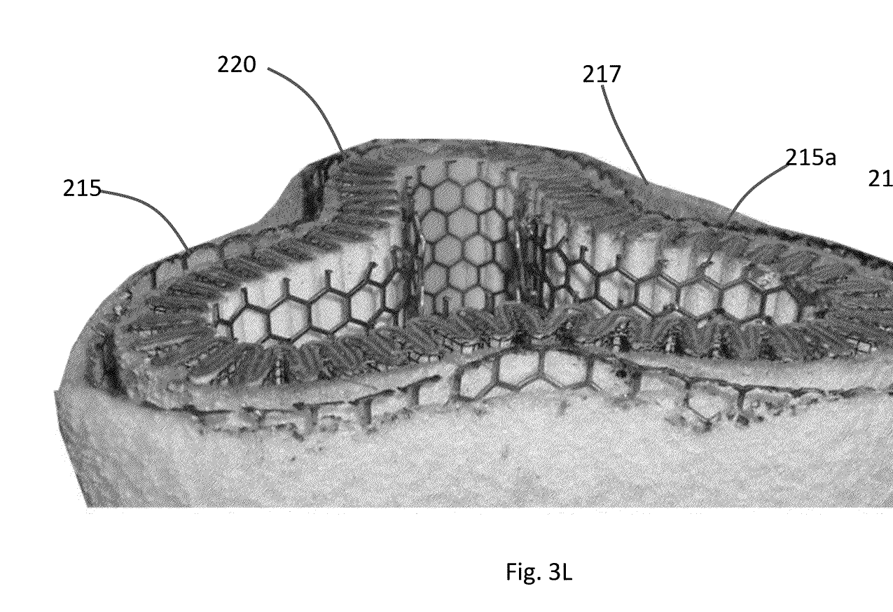

FIG. 2A illustrates a partial perspective view of a coalescing filter assembly 25 showing a generally lobed shaped first end 27 comprising an open end cap 35, and FIG. 2B illustrates a partial perspective view of a coalescing filter assembly 25 showing a generally lobed shaped second end 29 comprising a closed end cap 32 in accordance with some embodiments of the invention. In some embodiments, the lobes 37 can comprise a three-lobed shaped first end 27 comprising a first lobe 37a, a second lobe 37b, and a third lobe 37c. FIG. 3A illustrates a perspective view of a coalescing filter assembly 25 showing a closed end cap 32, and FIG. 3B illustrates a perspective view of a coalescing filter assembly 25 showing a cross-sectional end view of an open end cap 35 in accordance with some embodiments of the invention. As shown, in some embodiments, at the first end 27, the coalescing filter assembly 25 can comprise at least one main opening 80 through a portion of the open end cap 35. In some embodiments, the main opening 80 can provide an entry point for fluid to enter the coalescing filter assembly 25. For example, in some embodiments, fluid to be filtered can enter the coalescing filter assembly 25 through the main opening 80, and can move into at least a portion of the coalescing filter assembly 25, and into the filter element 20 including one or more of the plurality of lobes 40. In some embodiments, fluid can enter through the main opening 80, and can pass into a plurality of lobe channels 90 defined by the inner region 100 of the open end cap 35.

In some embodiments, at least some fraction of any fluid entering the coalescing filter assembly 25 can exit the coalescing filter assembly 25 through a portion of the coalescing filter assembly 25 other than the main opening 80. For example, in some embodiments, at least some fraction of any fluid entering the coalescing filter assembly 25 can exit the coalescing filter assembly 25 through a portion of any one of the plurality of lobes 40. In some embodiments, some fraction of the fluid can penetrate one or more of the plurality of lobes 40 through an inner surface (e.g., through an internal surface 50a of filter 50 and/or an internal surface 55a of filter 55 depicted in FIG. 1D.) Further, in some embodiments, some fraction of the fluid can pass through the wall 40a by passing through filtration media 42b through the plurality of fluid passages 42c (depicted in FIG. 1E.) As described earlier, in some embodiments, the filtration media 42b can include portions that can enable passage of fluids, and at least some portions of the plurality of lobes 40 can comprise the section 42. Therefore, in some embodiments, fluid can enter a portion of the filter element 200 through a portion comprising a section 42 through fluid inlets 43 into the wall 42a (i.e., the wall 40a), and can travel through at least a portion of the filter element 200 by moving through fluid passages (comprising fluid passages 42c.)

In some further embodiments, the coalescing filter assembly 25 can comprise other shapes (e.g., three smaller cylinders, truncated triangular lobes, three squares, etc.) and/or can include more or fewer numbers of lobes 40. For example, in some embodiments, a lateral cross-section of the coalescing filter assembly 25 can comprise at a substantially regular polygon, a substantially irregular polygon, a tetrafoil, a cinquefoil, a hexafoil, a heptafoil, an octofoil, a nonofoil, a decafoil, a multifoil, or various combinations thereof.

In some embodiments, the cross-section of the coalescing filter assembly 25 can be symmetric, asymmetric, or various combinations thereof. Moreover, some embodiments can include multi-lobed shapes (e.g., three, four, five or more lobes). In some embodiments, a multi-lobed element can create a greater surface area than achievable with a circular element of the same outside diameter. In some further embodiments, lobed elements can include pleated media, formed media, wound media, helically wound media, or extruded media. In some other embodiments, tapered, lobed elements can be used. Some embodiments can include groups of non-rounded filter elements 40 that can be arranged to form a substantially square or rectangular cross-section.

FIGS. 3C and 1D illustrate perspective views of a coalescing filter assembly 225 according to at least one further embodiment of the invention. As illustrated, some embodiments of the invention can include a coalescing filter assembly 225 with at least one filter element 200 that comprises a plurality of lobes 240 extending between a first end 227 and a second end 290. In the example embodiment shown in FIGS. 3C-3D, the coalescing filter assembly 225 can comprise three lobes. For example, in some embodiments, the plurality of lobes 240 can comprise a first lobe 245, a second lobe 250, and a third lobe 255, each extending between the first end 27 and the second end 29. In some embodiments, the coalescing filter assembly 225 can comprise at least one filter element 200 comprising a plurality of lobes 420 that can comprise at least one side wall 240a. Further, some embodiments of the invention include at least one side wall 240a that is common or shared. For example, in some embodiments, the first lobe 245, the second lobe 250, and the third lobe 255 can comprise at least one side wall 240a that is commonly shared between all the three lobes 245, 250, 255.

In some embodiments, coalescing filter assembly 225 can include a filter element 200 that can comprise at least one side wall 240a that comprises at least one concave region 41 extending substantially between two of the plurality of lobes 240. For example, in some embodiments, the coalescing filter assembly 225 can comprise a filter element 200 comprising a plurality of lobes 240 and at least one concave region 241 extending at least partially along the longitudinal length of the filter element 200 of the coalescing filter assembly 225. Further, in some embodiments, each of the first lobe 245, the second lobe 250, and the third lobe 255 can be directly coupled to each other along a portion or substantially their entire longitudinal lengths. For example, in some embodiments, the first lobe 245 can be immediately adjacent to and coupled to both the second lobe 250, and the third lobe 255. As a consequence, in some embodiments, a lateral cross-section of the coalescing filter assembly 225 can comprise a substantially trefoil shape comprising three lobes formed by the coupling of the first lobe 245, the second lobe 250, and the third lobe 255, and with a concave region 241 extending at least partially along the longitudinal length of the filter element 200 between the first lobe 245 and the second lobe 250, and between the second lobe 250 and the third lobe 255, and between the first lobe 245 and the third lobe 255.

In some further embodiments, the coalescing filter assembly 225 can comprise other shapes (e.g., three smaller cylinders, truncated triangular lobes, three squares, etc.) and/or can include more or less numbers of lobes 240. For example, in some embodiments, a lateral cross-section of the coalescing filter assembly 225 can comprise at a substantially regular polygon, a substantially irregular polygon, a tetrafoil, a cinquefoil, a hexafoil, a heptafoil, an octofoil, a nonofoil, a decafoil, a multifoil, or various combinations thereof. In some embodiments, the cross-section of the coalescing filter assembly 225 can be symmetric, asymmetric, or various combinations thereof. Moreover, some embodiments can include multi-lobed shapes (e.g., three, four, five or more lobes).

In some embodiments, a hyper multi-lobed element can create a greater surface area than achievable with a circular element of the same outside diameter. In some further embodiments, lobed elements can include pleated media, formed media, wound media, helically wound media, or extruded media. In some other embodiments, tapered, lobed elements can be used. Some embodiments can include groups of non-rounded lobes 240 that can be arranged to form a substantially square or rectangular cross-section.

In some embodiments of the invention, the filter element 200 can comprise at least one section that can enable the filter element 200 to be coupled to a wide variety of the filtration systems. In some embodiments, the section can be shaped substantially identically to the adjoining portions of the filter element 200. In some other embodiments, the section 210 can comprise a shape that varies from the adjoining portions of the filter element 200. For example, as shown at least in FIGS. 3C and 3D, in some embodiments, the filter element 200 can comprise a section 210 that comprises a substantially cylindrical shape extending from plurality of lobes 240. Further, in some embodiments, the plurality of lobes 240 can be coupled to the section 210 at a transition region 205. In some embodiments, any of the lobes 240, including, but not limited to the first lobe 245, second lobe 250, and third lobe 255 can be contoured and/or tapered to form the transition region 205 to form a substantially continuous transition to the section 210. Further, in some embodiments, any of the lobes 240, including, but not limited to the first lobe 245, second lobe 250, and third lobe 255 can be contoured to form the transition region 205 by forming a substantially seamless transition to the section 210 from any one of the lobes 245, 250, 255. Further, by tapering any of the lobes 245, 250, 255 to the transition region 205, any concave region 241 positioned between any of the lobes 240 can gradually decrease in depth extending from the second end 229 towards the first end 227, so that the concave region 241 gradually diminishes and ends within the transition region 205 and does not extend into the section 210.

In some embodiments of the invention, the coalescing filter assembly 225 can include one or more structures for providing support and fluid coupling to the at least one filter element 200. In some embodiments of the invention, the coalescing filter assembly 225 can include a first end 227 and a second end 229. In some embodiments, the first end 227 can comprise an open end cap 235. Further, in some embodiments, the second end 229 of the coalescing filter assembly 225 can comprise a closed end cap 232.

In some embodiments, the filter element 200 can be coupled to the open end cap 235 and/or the closed end cap 232 using a variety of conventional coupling techniques. For example, in some embodiments, the filter element 200 can be coupled to the open end cap 235 and/or the closed end cap 232 using a conventional adhesive. In some other embodiments, the filter element 200 can be coupled to the open end cap 235 and/or the closed end cap 232 using a push-fit, a snap-fit, or a crimp-fit either alone, or in combination with a conventional adhesive. As illustrated in at least FIG. 3C, in some embodiments, the coalescing filter assembly 225 can include a filter element 200 comprising the first lobe 245, second lobe 250, and the third lobe 255 that can couple to and extend between the open end cap 235 at the first end 227, and a closed end cap 232 at a second end 229. In this example, the lobes 245, 250, 255 can generally form a three-lobed shaped second end 229.

FIG. 3E illustrates a perspective view of a cross-section of a coalescing filter assembly in accordance with some further embodiments of the invention. In this example, a cross-section has been taken through the assembly 225, illustrating various internal surfaces of the assembly 225. In some embodiments, the filter element 200 including any portion of any one of the plurality of lobes 240 (for example the first lobe 45, the second lobe 50, and/or the third lobe 55) can comprise a section 42 (shown in FIG. 1E). As illustrated, in some embodiments, the section 42 can comprise a wall 42a comprising a filtration media 42b, that in some embodiments, can form at least a portion of the filter element 200 of the assembly 225. For example, in some embodiments, the side wall 240a can comprise the wall 42a of the section 42 in some embodiments. Further, in some embodiments, at least some portion of the filter element 200 can comprise the filtration media 42b of section 42. Consequently, in some embodiments, the filter element 200 can include portions that can enable passage of fluids through continuous and/or discontinuous porosity, at least a portion of which can enable the movement of fluid through portions of the filter element 200. In some embodiments, fluid can enter at least a portion of the filter element 200 by passing into a portion that comprises a section 42 through the wall 42a. In some embodiments, at least a portion of the filtration media 42b can comprise fluid passages 42c, and fluid inlets 43 can be formed from and/or coupled to fluid passages 42c within the filter element 200. Therefore, in some embodiments, the filtration media 42b can comprise a plurality of fluid passages 42c through which fluid can travel by entering the fluid inlets 43 within the filter element 200, passing into one or more fluid passages 42c within the wall 42a, and passing through and out of the filter element 200 by passing out of the wall 240a (comprising wall 42a) and comprising a plurality of fluid outlets (formed by fluid passages 42c).

In some embodiments, any portion of the wall 240a forming any portion of the filter element 200 including any of the filter lobes 245, 520, 255 can include hydrophobic, super-hydrophobic, and/or super-oleophobic materials, coatings, and surfaces. In some embodiments, hydrophobic, super-hydrophobic and/or super-oleophobic surface modifications can enable at least a portion of the coalescing filter assembly 225 (such as any of the lobes 245, 250, 255) to operate at more than four times the flow velocity, while still achieving aerosol carryover of almost two orders of magnitude less than an identical element without the surface modification. In some embodiments, surfaces of the filter element 200 comprising hydrophobic, super-hydrophobic and/or super-oleophobic surface modifications can improve aerosol rejection and/or drainage of coalesced liquids from the element. In some embodiments, a hydrophobic, super-hydrophobic, and/or super-oleophobic surface modification of the filter element 200 can be accomplished using a plasma treatment of any portion of any portion of the filter element 200. In some embodiments, hydrophobic, and/or super-oleophobic materials, coatings, and surfaces forming any part of the filter element 200 can comprise covalent attachment of a fluorinated material to one or more surfaces of the filter element 200 including any portion of the first lobe 245, second lobe 250, and third lobe 255. In some embodiments, a plasma coating process can be performed on individual layers within a filter element, including any portion of the filtration media 42b forming any portion of the filter element 200.

As further illustrated in FIG. 3C, and in FIG. 3I, illustrating a perspective assembly view of a portion of a coalescing filter assembly 225, in some embodiments, the generally lobed shaped second end 229 comprising a closed end cap 232 can comprise one or more lobes 237. For example, in some embodiments, the second end 227 can comprise a first lobe 237a coupled to a second lobe 237b, and a third lobe 237c coupled to the first lobe 237a and the second lobe 237b. Furthermore, in some embodiments, each of the lobes 237a, 237b, 237c can be shaped to couple with a corresponding lobe of the filter element 200. For example, in some embodiments, the first lobe 245 of the filter element 200 can couple to the first lobe 237a of the closed end cap 232. Further, the second lobe 250 of the filter element 200 can couple to the second lobe 237b of the closed end cap 232. Furthermore, the third lobe 255 of the filter element 200 can couple to the third lobe 237c of the closed end cap 232.

In some embodiments of the invention, the first end 227 of the coalescing filter assembly 225 can comprise at least one main opening 280 through a portion of the open end cap 235. In some embodiments, the main opening 280 can provide an entry point for fluid to enter the coalescing filter assembly 225. In some embodiments, fluid to be filtered can enter the coalescing filter assembly 225 through the main opening 280, and can move into at least a portion of the coalescing filter assembly 225, and into the filter element 200 including one or more of the plurality of lobes 240. In some embodiments of the invention, at least some fraction of any fluid entering the coalescing filter assembly 225 can exit the coalescing filter assembly 25 through a portion of the coalescing filter assembly 225 other than the main opening 280. For example, in some embodiments, at least some fraction of any fluid entering the coalescing filter assembly 225 can exit the coalescing filter assembly 25 through a portion any one of the filter element 200. In some embodiments, at least some fraction of any fluid entering the coalescing filter assembly 225 can exit the assembly 225 through a portion of any one of the plurality of lobes 240. In some embodiments, some fraction of the fluid can penetrate one or more of the plurality of lobes 240 through an inner surface of the filter element 200. Further, in some embodiments, some fraction of the fluid can pass through the through the filtration media 42b through the plurality of fluid passages 42c (shown in FIG. 1E) and out of the aforementioned plurality of fluid outlets of the wall 42a (by passing through and out of the wall 240a).

FIG. 3L illustrates a perspective assembly view of a portion of an internal cross-section of coalescing filter assembly 225 in accordance with some further embodiments of the invention. In some embodiments of the invention, the filter element 200 can comprise a metal core and retainer 215 including an inner wall 215a and an outer wall 215b, and a pleat block 220 positioned between the inner wall 215a and the outer wall 215b. Further, in some embodiments, the filter element 200 can comprise an outer filter 217 adjacent the outer wall 215b. In some embodiments, the pleat block 220 can comprise filter media 42b. Further, in some embodiments, the outer filter 217 can comprise the filter media 42b.

In some embodiments of the invention, fluid entering the first end 227 of the coalescing filter assembly 225 can pass through the main opening 280 through a portion of the open end cap 235. For example, in some embodiments, fluid to be filtered can enter through the main opening 280, and can move into at least a portion of the coalescing filter assembly 225, and into the filter element 200 including one or more of the plurality of lobes 240. In some embodiments, the fluid can move past the inner wall 215a, and into at least a portion of the pleat block 220. Further, in some embodiments, fluid can pass through the outer wall 215b and the outer filter 217. In some embodiments of the invention, at least some fraction of any fluid entering the coalescing filter assembly 225 through the main opening 280 can exit the coalescing filter assembly 225 through a portion of the coalescing filter assembly 225 comprising the pleat block 220. For example, in some embodiments, at least some fraction of any fluid entering the coalescing filter assembly 225 can exit the coalescing filter assembly 225 by passing through the inner wall 215a, the pleat block 220, the outer wall 215b, and the outer filter 217. In some embodiments, at least some fraction of any fluid entering the coalescing filter assembly 225 can exit the assembly 225 through a portion any one of the plurality of lobes 240 by penetrating a plurality of fluid passages 42c within the filter media 42b, and passing through an inner surface of the filter element 200 including the inner wall 215a, the pleat block 220, the outer wall 215b, and the outer filter 217.

Some embodiments of the invention include one or more frame or supports configured to support the filter element 200. For example, FIGS. 3E-3F illustrate perspective views of a cross-section of a coalescing filter assembly 225, FIG. 3I, and FIG. 3J, illustrating a perspective assembly view of a portion of a coalescing filter assembly 225 showing a riser 300 configured to support at least a portion of the filter element 200. In some embodiments, the riser 300 can comprise an A-frame 310 comprising a first end 315 and a second end 320, and a cross member 330. In some embodiments, the A-frame 310 can be positioned substantially centrally within the filter element 200, and can extend from the first end 227 to the second end 229 of the filter element 200. In some embodiments, the first end 315 is positioned adjacent the first end 227 of the filter element 200.

In some embodiments of the invention, one or more coupling components can be integrated with and/or coupled to the section 210 to enable the assembly 225 to be positioned within a filtration system. For example, in some embodiments, riser inlet hardware 340 can be coupled to the filter element 200, positioned at the first end 227. In some embodiments, first end 315 is positioned within and/or coupled to riser inlet hardware 340. For example, in some embodiments, the first end 315 can extend into the riser inlet hardware 340 and into the main opening 280.

In some embodiments, the second end 320 can be coupled to the filter element 200 at the second end 229 of the assembly 225. In some embodiments, the second end 320 can be coupled to the second end 229 using a threaded lockdown 325. FIGS. 3G and 3H illustrate perspective views of a portion of a cross-section of a coalescing filter assembly 225 in accordance with some further embodiments of the invention. As illustrated, in some embodiments, the threaded lockdown 325 can extend through the closed end cap 232. Moreover, in some embodiments, the threaded lockdown 325 can be coupled to and extend through a coupler 232a that can at least partially extend through an aperture in the closed end cap 232.

In some embodiments, the closed end cap 232 can couple to the filter element 200 by coupling to an end coupler 233 coupled to the second end 229 of the filter element 200. As represented in FIG. 3I, in some embodiments, the closed end cap 232 can be coupled and decoupled from the filter element 200. In some embodiments, the closed end cap 232 can be integrally molded to the filter element 200. In other embodiments, the closed end cap 232 can be coupled to the filter element 200 by coupling to the end coupler 233 by a variety of means, including, but not limited to, adhesion, snap-fitting, press-fitting, joining, screwing, and bolting.

In some embodiments, the closed end cap 232 can include an aperture 232b through which the coupler 232a can be positioned. In some embodiments, the aperture 232b can be positioned substantially centrally within the closed end cap 232. Further, as illustrated in FIGS. 3G-3J, when the closed end cap 232 is coupled to the end coupler 233, the threaded lockdown 325 can secure the second end 320 of the A-frame 310 of the riser 300 to the filter element 200 by passing through an aperture 326 located at the second end of the A-frame 310, through the end coupler 233, and through the aperture 232b of the closed end cap 232, secured by the coupler 232a. Further, in some embodiments, a coupler 325a can be threaded to the threaded lockdown 325 to enable the A-frame 310 to be secured to closed end cap 232. As shown in FIGS. 3G and 3H, in some embodiments, the threaded lockdown 325 can comprise a T-bar coupler 327 that can act as a stop by coupling to the second end 320 of the A-frame 310. Further, some embodiments include an insert 335 coupled to the threaded lockdown 325 and the second end 320 outside of the A-frame 310. In some embodiments, the insert 335 can comprise a conventional washer, nut or bolt, or other component to aid in securing the threaded lockdown 325 to the A-frame 310.

FIG. 3K illustrates a packing arrangement of a plurality of coalescing filter assemblies 225 in accordance with some further embodiments of the invention. In some embodiments, the packing of filter assemblies 390 can comprise a centrally positioned assembly 225, surrounded by six substantially evenly spaced adjacent assemblies 225. In some embodiments, the six substantially evenly spaced adjacent assemblies 225 can be positioned proximate the centrally located assembly 225 by positioning a lobe of the filter element 200 within a concave inner region 241 between two adjacent lobes of the centrally located assembly 225.

Some embodiments of the various example embodiment cross-sections of a plurality of lobes 40 are shown in FIGS. 4A-4G. For example, FIG. 4A illustrates a cross-sectional representation of a coalescing filter assembly 400 in accordance with some embodiments of the invention. In this example, the coalescing filter assembly 400 comprises a rectangular lobe 405 (i.e., the rectangular lobe 405 represents a cross-sectional view of a portion of a rectangular filter element).

FIG. 4B illustrates a cross-sectional representation of a design of a coalescing filter assembly 425 in accordance with some embodiments of the invention. In this example embodiment, the coalescing filter assembly 425 comprises a circular lobe architecture comprising substantially circular lobes 430. In a further example embodiment, FIG. 4C illustrates a cross-sectional representation of a design of a coalescing filter assembly 450 in accordance with some embodiments of the invention. In this example, the pyramidal lobe architecture of the coalescing filter assembly 450 can comprise pyramidal lobes 460.

FIG. 4D illustrates a cross-sectional representation of a coalescing filter assembly 475 in accordance with some embodiments of the invention. In this example, the coalescing filter assembly 475 can comprise lobes 477. Further, FIG. 4E illustrates a cross-sectional representation of a coalescing filter assembly 485 in accordance with some embodiments of the invention. In this example, the coalescing filter assembly 485 can comprise a substantially square cross-section 487.

FIG. 4F illustrates a cross-sectional representation of a coalescing filter assembly 490 in accordance with some embodiments of the invention. In this example, the coalescing filter assembly 490 can comprises lobes 492. FIG. 4G illustrates a cross-sectional representation of a design of a coalescing filter assembly 495 in accordance with some embodiments of the invention. This example includes a plurality of half-dumb-bell shaped lobes 497.

In some embodiments, the shape of any assembled group of filter elements (e.g., the plurality of lobes 40, or other shaped filter elements) can form a plurality of open spaces or regions between the filter elements that in some embodiments can be utilized to closely pack or “nest” groups of assemblies. For example, some embodiments as shown in FIGS. 4A-4D, and FIGS. 4F-4G can include a plurality of inner spaces or regions formed between the lobe portions of the assemblies. FIG. 4A, for example, illustrates a coalescing filter assembly 400 comprising a rectangular lobes 405, and includes open regions 405a formed between two adjacent lobes 405. Similarly, the coalescing filter assembly 425 (shown in FIG. 4B) can comprise open regions 430a formed between lobes 430, and the coalescing filter assembly 450 can comprise open regions 460a between pyramidal lobes 460. Further, the coalescing filter assembly 475 can comprise open regions 477a between lobes 477, and the coalescing filter assembly 490 can comprise open regions 492a between lobes 492. Moreover, the coalescing filter assembly 495 can comprise open regions 495a between lobes 497.

As described earlier, it is common to use coalescing elements secured within a pressure-containing vessel or housing to form a coalescing filter assembly. The coalescing filter assembly are typically arranged to maximize the available space, and positioned to improve fluid flow. Because any filter element has a fixed (maximum) flow rate, increasing the number of filter elements and increasing the packing density can enable more filter elements to be placed within any fixed space, which in turn can allow for greater flow through a single vessel. The packing density can be greatly increased by using elements with non-circular cross sections, like those described herein above.

In some embodiments, the open spaces between the filter lobes can be used to facility dense packing of groups of coalescing filter assemblies. For example, when assembling a plurality of coalescing filter assemblies 400, rectangular lobes 405 of neighboring assemblies 400 can be positioned in open regions 405a formed between two lobes 405 of a neighboring assembly 400. This close arrangement of assemblies can also be used in any of the aforementioned assemblies, 425, 450, 475, 485, 490, 495. For example, at least one filter 430 of the assembly 425 at least partially positioned within an open region 430a of a neighboring assembly 425, at least one lobe 460 of the assembly 450 at least partially positioned within an open region 460a of a neighboring assembly 460, and so on. Moreover, in some further embodiments, any grouping of assemblies 400, 425, 450, 475, 485, 490, 495 can comprise various levels of spacing between individual assemblies. Furthermore, any group of assemblies can comprise a substantially uniform or a substantially non-uniform arrangement of spacing between individual assemblies.

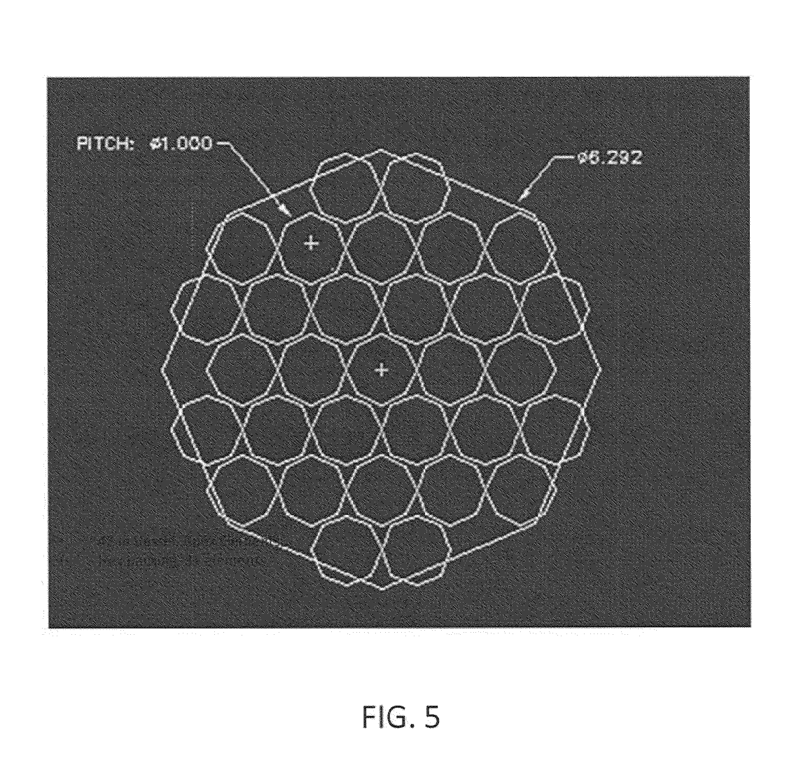

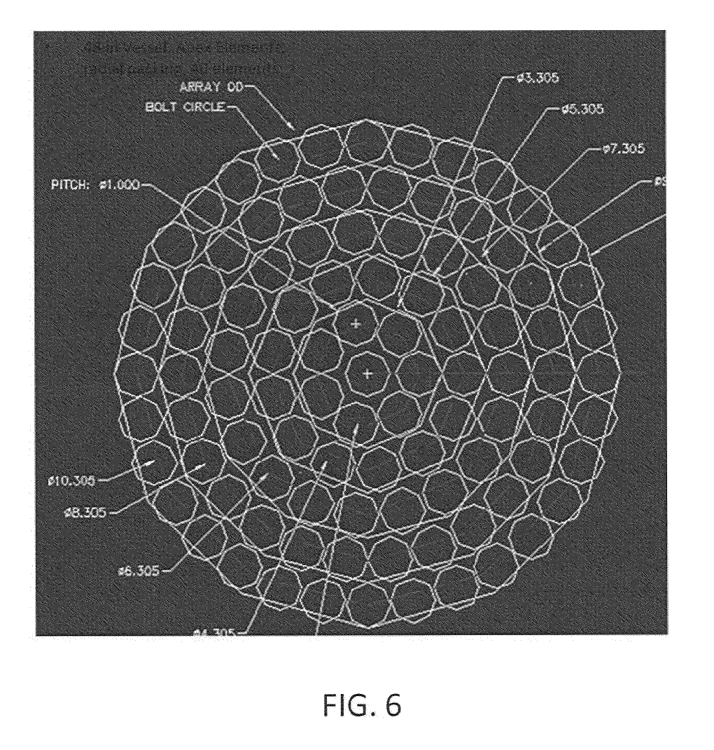

FIG. 5 illustrates a representation of a packing arrangement of a prior art coalescing filter assembly, and FIG. 6 illustrates a representation of a packing arrangement of a prior art coalescing filter assembly with a greater number of filters assembly than shown in the prior art in FIG. 5. As shown, one or more filter assemblies can be positioned within a filtration vessel using various packing arrangements based on the number of filter elements and the size and geometry of the vessel. In some embodiments, a lobed filter element can be placed within a lobed vessel (or a cylindrical vessel with a lobed interior, or dimpled, ribbed, and/or baffled interior) to again create the preferred alignment of the element or control flow dynamics around the filter element. Further, in some embodiments, variable height media pleats can be used within the lobed filter element to further enhance geometries.

Extending this concept to the use of embodiments of the coalescing filter assembly 25 described herein, in some embodiments, a plurality of coalescing filter assemblies 25 can be arranged within a filtration vessel. Moreover, in some embodiments, one or more of the plurality of coalescing filter assemblies 25 can be positioned relative to at least one other coalescing filter assembly 25 so as to maximize the number of coalescing filter assembly 25 that can be positioned within any specific volume. In some other embodiments, the plurality of coalescing filter assemblies 25 can be positioned relative to each other to provide for a specific fluid flow within a filtration vessel. For example, in some embodiments, the packing density of the plurality of coalescing filter assemblies 25 can be varied across a diameter of a filtration vessel. For example, in some embodiments, the packing density of the plurality of coalescing filter assemblies 25 can be greater towards the outer perimeter of a filtration vessel than the packing density towards the center of a filtration vessel. In some embodiments, the packing density of the plurality of coalescing filter assemblies 25 can be graded across any specific volume of a filtration vessel (i.e., can form a density gradient).

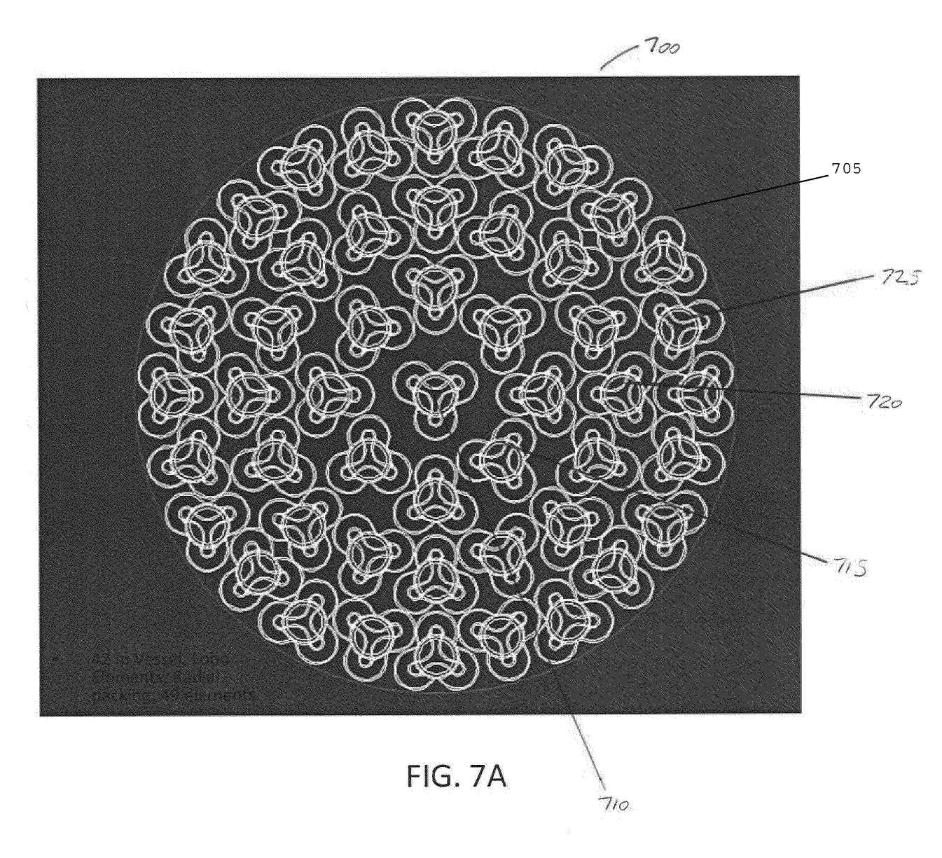

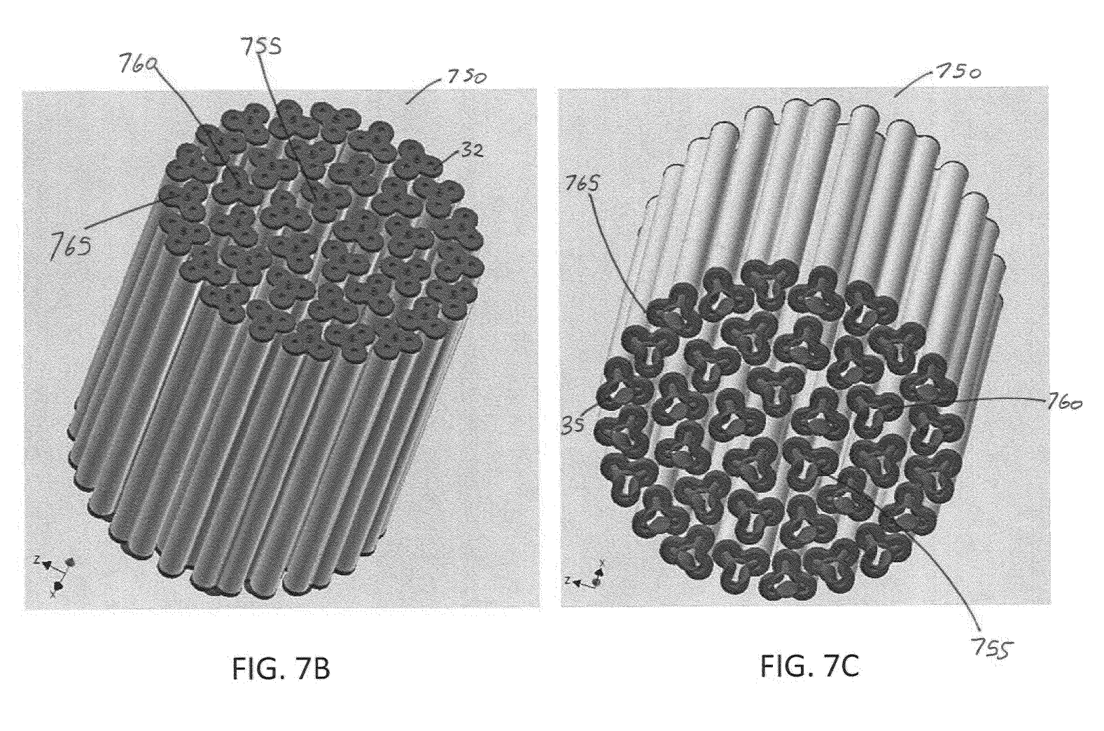

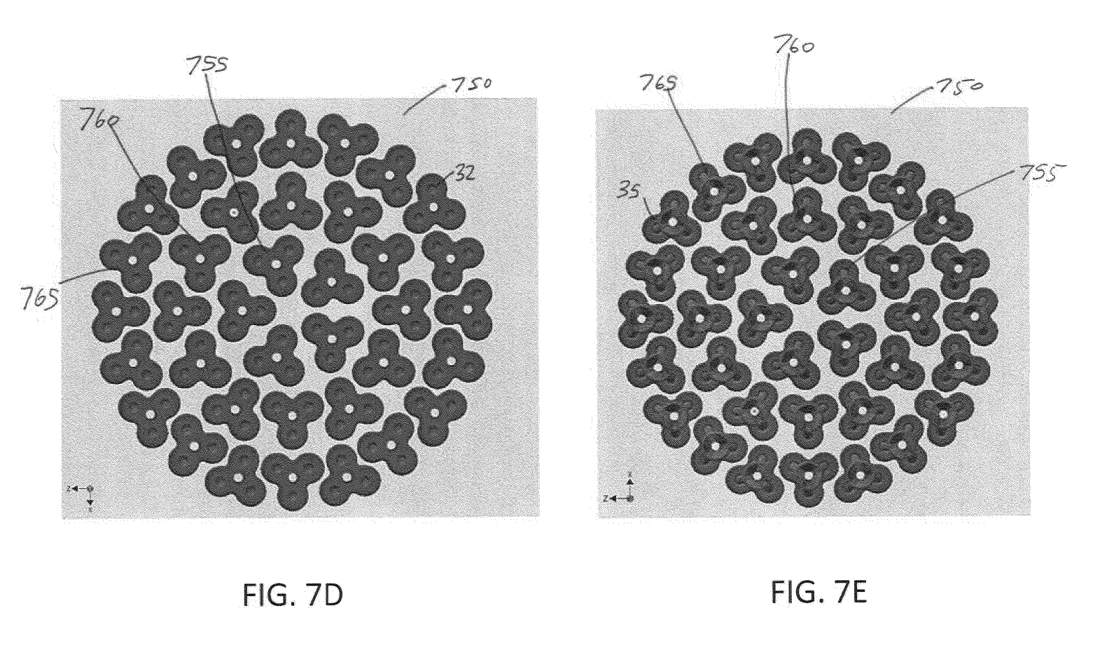

FIG. 7A illustrates a representation of a packing arrangement 700 of a coalescing filter assembly 25 in accordance with some embodiments of the invention. Arranged within a vessel 705, packing arrangement 700 can comprise a central assembly 710 positioned substantially at the center of the vessel 705. In some embodiments, a plurality of coalescing filter assemblies 25 can be arranged substantially circularly around the central assembly 710. For example, a first outer ring 715 comprising eight substantially equally spaced coalescing filter assembly 25 can be positioned generally circularly around the central assembly 710. In some embodiments, the eight substantially equally spaced coalescing filter assembly 25 can be positioned from the central assembly 710 at substantially the same distance. Further, in some embodiments, each coalescing filter assembly 25 can be rotated relative to its neighboring coalescing filter assembly 25. For example, in the example embodiments shown in FIG. 7A, each of the coalescing filter assembly 25 can be rotated about 120° relative to its immediate neighbor within the first outer ring 715. In some other embodiments, the first outer ring 715 can comprise coalescing filter assembly 25 rotated relative to its immediate neighbor by angles greater than or less than about 120°. Further, in some other embodiments, the first outer ring 715 can comprise less than eight coalescing filter assembly 25.

In some further embodiments, a plurality of coalescing filter assemblies 25 can be arranged generally circularly around the central assembly 710 and the first outer ring 715. For example, a second outer ring 720 comprising sixteen substantially equally spaced coalescing filter assembly 25 can be positioned generally circularly around the central assembly 710 and the first outer ring 715. In some embodiments, the sixteen substantially equally spaced coalescing filter assembly 25 can be positioned from the central assembly 710 at substantially the same distance. Further, in some embodiments, each coalescing filter assembly 25 can be rotated relative to its neighboring coalescing filter assembly 25. For example, in the example embodiment shown in FIG. 7A, each of the coalescing filter assembly 25 in the second outer ring 720 can be rotated about 120° relative to its immediate neighbor within the second outer ring 720. In some other embodiments, the second outer ring 720 can comprise coalescing filter assembly 25 rotated relative to its immediate neighbor by angles greater than, or less than about 120°. Further, in some other embodiments, the second outer ring 720 can comprise less than sixteen coalescing filter assembly 25.

In some further embodiments, a plurality of coalescing filter assemblies 25 can be arranged generally circularly around the central assembly 710, the first outer ring 715, and the second outer ring 720. For example, a third outer ring 725 comprising twenty four substantially equally spaced coalescing filter assembly 25 can be positioned generally circularly around the central assembly 710, the first outer ring 715, and the second outer ring 720. In some embodiments, the twenty four substantially equally spaced coalescing filter assembly 25 can be positioned from the central assembly 710 at substantially the same distance. Further, in some embodiments, each coalescing filter assembly 25 in the third outer ring 725 can be rotated relative to its neighboring coalescing filter assembly 25 in the third outer ring 725. For example, in the example embodiments shown in FIG. 7A, each of the coalescing filter assembly 25 in the third outer ring 725 can be rotated about 120° relative to its immediate neighbor within the third outer ring 725. In some other embodiments, the third outer ring 725 can comprise coalescing filter assembly 25 rotated relative to its immediate neighbor by angles greater than or less than about 120°. Further, in some other embodiments, the third outer ring 725 can comprise less than twenty four coalescing filter assembly 25. In some other embodiments, using coalescing filter assembly 25 that are smaller than those that are illustrated, one or more of the rings 715, 720, 725 can comprise additional coalescing filter assembly 25. Further, in some embodiments, the packing arrangement 700 can comprise additional rings of coalescing filter assembly 25, and/or additional coalescing filter assembly 25 positioned within or outside of ring-like arrangements.

In some embodiments, at least one of the plurality of coalescing filter assemblies 25 comprising the first outer ring 715 can be positioned angled relative to at least one of the plurality of coalescing filter assemblies 25 comprising the second outer ring 720, so that the one or more of the lobes 45, 50, 55 of the second outer ring 720 can be positioned adjacent to and substantially between at least two adjacent coupled lobes 45, 50, 55 of the first outer ring 715. Further, in some embodiments, at least one of the plurality of coalescing filter assemblies 25 comprising the second outer ring 720 can be positioned angled relative to at least one of the plurality of coalescing filter assemblies 25 comprising the third outer ring 725 so that the one or more of the lobes 45, 50, 55 of the third outer ring 725 can be positioned adjacent to and substantially between at least two adjacent coupled lobes 45, 50, 55 of the second outer ring 720.

In some embodiments, a plurality of coalescing filter assemblies 25 can be arranged generally within a series of rings without a central assembly (e.g., without a central assembly 710 shown in FIG. 7A). For example, FIGS. 7B and 7C illustrate perspective views of a representation of a packing arrangement 750 of a coalescing filter assembly 25 in accordance with some embodiments of the invention. Further, FIG. 7D illustrates an end view of a representation of a packing arrangement 750 of a coalescing filter assembly 25 showing closed end caps 32, and FIG. 7E illustrates an end view of a representation of a packing arrangement 750 of a coalescing filter assembly 25 showing open end caps 35 in accordance with some embodiments of the invention.

In some embodiments, a plurality of coalescing filter assemblies 25 can be arranged generally circularly with respect to the substantial center of an arrangement of coalescing filter assembly 25. For example, in some embodiments, a plurality of coalescing filter assemblies 25 can be arranged generally circularly with respect to the substantial center of a packing of filter elements 750 comprising an arrangement of coalescing filter assembly 25. As illustrated by the example embodiments shown in FIGS. 7B-7E, in some embodiments, a packing of filter elements 750 can comprise a first ring 755, a second outer ring 760 positioned generally circularly around the first ring 755, and a third outer ring 765 comprising a plurality of coalescing filter assemblies 25 positioned generally circularly around the first ring 755 and the second outer ring 760. In this instance, the first ring 755 can be positioned generally centrally within the packing of filter elements 750. Further, in some embodiments, the first ring 755 can comprise four substantially equally spaced coalescing filter assembly 25, positioned generally circularly around the substantial center of the packing of filter elements 750. In some embodiments, the four substantially equally spaced coalescing filter assembly 25 can be positioned from the substantial center of the packing of filter elements 750 at substantially the same distance. Further, in some embodiments, each coalescing filter assembly 25 can be rotated relative to its neighboring coalescing filter assembly 25. For example, each of the coalescing filter assembly 25 can be rotated about 120° relative to its immediate neighbor within the first ring 755. In some other embodiments, the first ring 755 can comprise coalescing filter assembly 25 rotated relative to its immediate neighbor by angles greater than or less than about 120°. Further, in some other embodiments, the first ring 755 can comprise less than four coalescing filter assembly 25.

In some further embodiments, a plurality of coalescing filter assemblies 25 can be arranged generally circularly around the first ring 755. For example, a second outer ring 760 comprising twelve substantially equally spaced coalescing filter assembly 25 can be positioned generally circularly around the first ring 755. In some embodiments, the twelve substantially equally spaced coalescing filter assembly 25 can be positioned from the first ring 755 at substantially the same distance. Further, in some embodiments, each coalescing filter assembly 25 can be rotated relative to its neighboring coalescing filter assembly 25. For example, in some embodiments, each of the coalescing filter assembly 25 in the second outer ring 760 can be rotated about 120° relative to its immediate neighbor within the second outer ring 760. In some other embodiments, the second outer ring 760 can comprise coalescing filter assembly 25 rotated relative to its immediate neighbor by angles greater than or less than about 120°. Further, in some other embodiments, the second outer ring 760 can comprise less than twelve coalescing filter assembly 25.

In some further embodiments, a plurality of coalescing filter assemblies 25 can be arranged generally circularly around the first ring 755, and the second outer ring 760. For example, a third outer ring 765 comprising twenty substantially equally spaced coalescing filter assembly 25 can be positioned generally circularly around the first ring 755 and the second outer ring 760. In some embodiments, the twenty substantially equally spaced coalescing filter assembly 25 can be positioned from the first ring 755, and the second outer ring 760 at substantially the same distance. Further, in some embodiments, each coalescing filter assembly 25 can be rotated relative to its neighboring coalescing filter assembly 25. For example, in some embodiments, each of the coalescing filter assembly 25 in the third outer ring 765 can be rotated about 120° relative to its immediate neighbor within the third outer ring 765. In some other embodiments, the third outer ring 765 can comprise coalescing filter assembly 25 rotated relative to its immediate neighbor by angles greater than or less than about 120°. Further, in some other embodiments, the third outer ring 765 can comprise less than twenty coalescing filter assemblies 25.

In some further embodiments, a plurality of coalescing filter assemblies 25 can be arranged within a filtration vessel in groups comprising generally linear rows. Further, in some embodiments, generally linear rows of coalescing filter assembly 25 can be arranged generally perpendicular to other generally linear rows of coalescing filter assembly 25. In some embodiments, one or more generally linear rows of coalescing filter assembly 25 can be arranged generally perpendicular to other generally linear rows of coalescing filter assembly 25 within a filtration vessel comprising a generally circular cross-section. In some other embodiments, one or more generally linear rows of coalescing filter assemblies 25 can be arranged generally perpendicular to other generally linear rows of coalescing filter assemblies 25 within a filtration vessel comprising a generally square or rectangular filtration vessel.

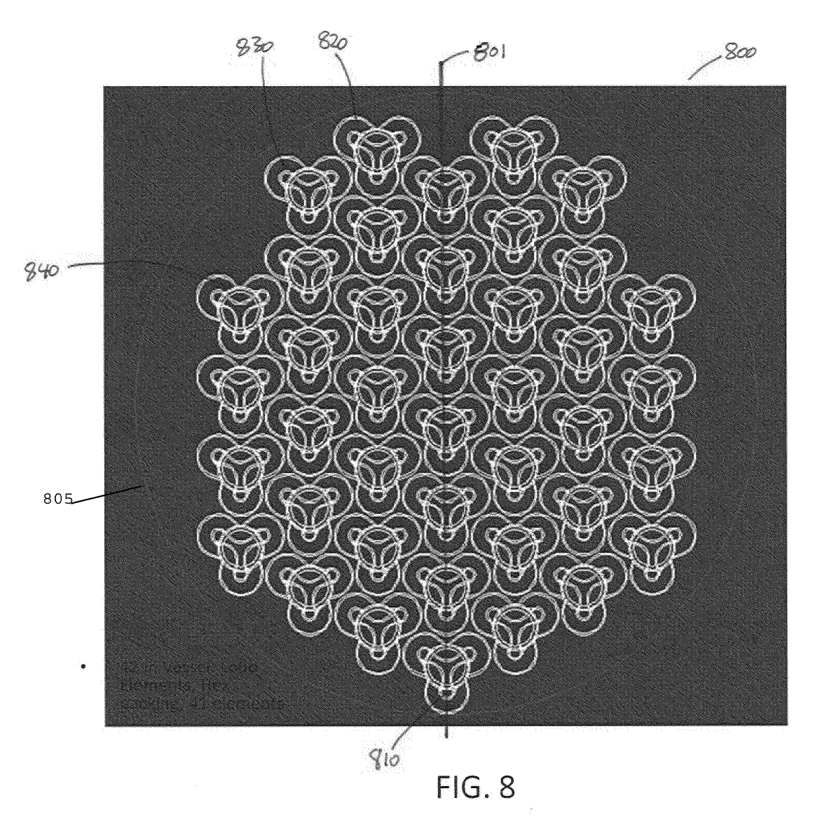

FIG. 8 illustrates a representation of a packing arrangement 800 of a coalescing filter assembly 25 in accordance with some embodiments of the invention. In some embodiments, the packing arrangement 800 can comprise a plurality of coalescing filter assemblies 25 arranged in a plurality of generally linear rows, and assembled within a vessel 805. Further, as illustrated, in some embodiments, the packing arrangement 800 can comprise symmetry about a central axis 801. In some embodiments, the packing arrangement 800 can comprise a central line 810 comprising a plurality of coalescing filter assemblies 25 positioned substantially equally spaced along the central axis 801. Further, on one side of the central axis 801, in some embodiments, the packing arrangement 800 can comprise a first row 820 comprising a plurality of coalescing filter assemblies 25 positioned substantially equally spaced adjacent to the central axis 801, substantially parallel to the central line 810. Further, in some embodiments, the packing arrangement 800 can comprise a second row 830 comprising a plurality of coalescing filter assemblies 25 positioned substantially equally spaced adjacent to the first row 820, and substantially parallel to the first row 820 and the central line 810. Further, in some embodiments, the packing arrangement 800 can comprise a third row 840 comprising a plurality of coalescing filter assemblies 25 positioned substantially equally spaced adjacent to the second row 830, and substantially parallel to the first row 820, second row 830, and the central line 810. Further, in some embodiments, the packing arrangement 800 can be substantially symmetrical so that the arrangement of the first row 820, second row 830, and third row 840 can be substantially mirrored on the opposite side of the central axis 801. In some embodiments, the central line 810 and the first row 820 can each comprise a substantially linear arrangement of seven coalescing filter assembly 25. Further, the second row 830 can comprise a substantially linear arrangement of six coalescing filter assemblies 25, and the third row 840 can comprise a substantially linear arrangement of four coalescing filter assemblies 25. In some other embodiments, any one of the central line 810, the first row 820, the second row 830, and third row 840 can comprise fewer numbers of coalescing filter assembly 25. In some further embodiments, if the coalescing filter assembly 25 are smaller than those that are shown, and/or the vessel 805 is larger than shown, then any one of the central line 810, the first row 820, the second row 830, and third row 840 can comprise greater numbers of coalescing filter assemblies 25.

In some embodiments, at least one of the plurality of coalescing filter assemblies 25 comprising the first row 820 can be positioned angled relative to at least one of the plurality of coalescing filter assemblies 25 comprising the central line 810 so that the one or more of the lobes 45, 50, 55 of the central line 810 can be positioned adjacent to and substantially between at least two adjacent lobes 45, 50, 55 of the first row 820. Further, in some embodiments, at least one of the plurality of coalescing filter assemblies 25 comprising the second row 830 can be angled relative to at least one of the plurality of coalescing filter assemblies 25 comprising the first row 820 so that the one or more of the lobes 45, 50, 55 of the first row 820 can be positioned adjacent to and substantially between at least two adjacent coupled lobes 45, 50, 55 of the second row 820. Further, in some embodiments, at least one of the plurality of coalescing filter assemblies 25 comprising the third row 840 can be positioned angled relative to at least one of the plurality of coalescing filter assemblies 25 comprising the second row 830 so that the one or more of the lobes 45, 50, 55 of the second row 830 can be positioned adjacent to and substantially between at least two adjacent coupled lobes 45, 50, 55 of the third row 840.

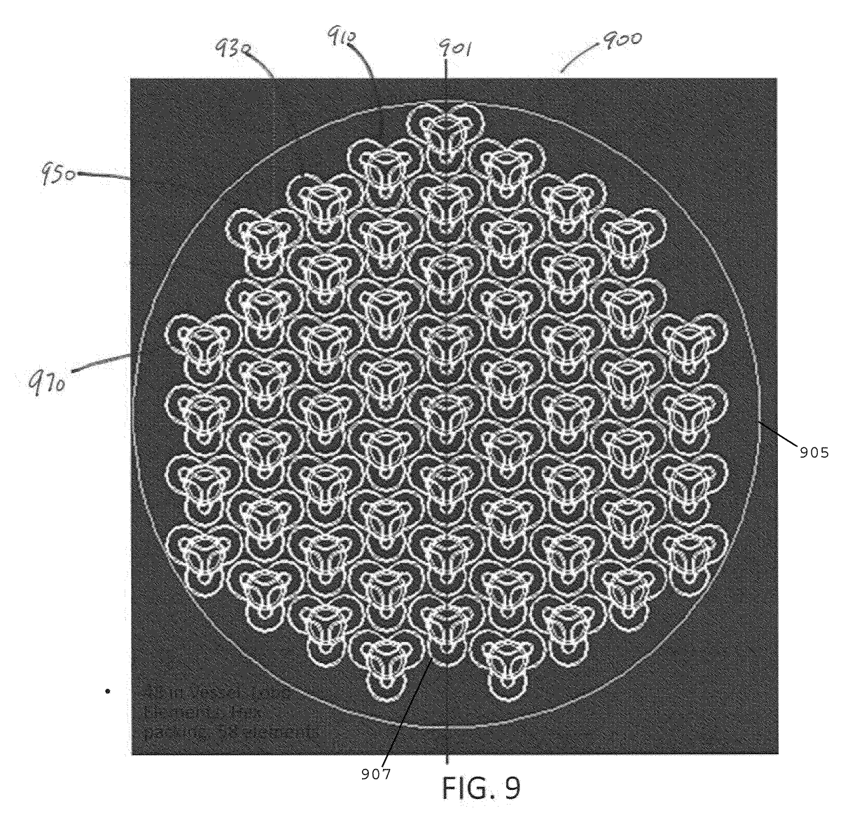

FIG. 9 illustrates a representation of a packing arrangement 900 of a coalescing filter assembly 25 in accordance with some embodiments of the invention. Similar to the aforementioned packing arrangement 800, in some embodiments, the packing arrangement 900 can comprise a plurality of coalescing filter assemblies 25 arranged in a plurality of generally linear rows. In some embodiments, the packing arrangement 900 can comprise symmetry about a central axis 901, comprising a plurality of generally linear rows of coalescing filter assembly 25 positioned within the vessel 905. In some embodiments, the packing arrangement 900 can comprise a central line 907 comprising a plurality of coalescing filter assemblies 25 positioned substantially equally spaced along the central axis 901. Further, on one side of the central axis 901, in some embodiments, the packing arrangement 900 can comprise a first row 910 comprising a plurality of coalescing filter assemblies 25 positioned substantially equally spaced adjacent to the central axis 901, substantially parallel to the central line 907. Further, in some embodiments, the packing arrangement 900 can comprise a second row 930 comprising a plurality of coalescing filter assemblies 25 positioned substantially equally spaced adjacent to the first row 910, and substantially parallel to the first row 910 and the central line 907. Further, in some embodiments, the packing arrangement 900 can comprise a third row 950 comprising a plurality of coalescing filter assemblies 25 positioned substantially equally spaced adjacent to the second row 930, and substantially parallel to the first row 910, second row 930, and the central line 907. Further, in some embodiments, the packing arrangement 900 can comprise a fourth row 970 comprising a plurality of coalescing filter assemblies 25 positioned substantially equally spaced adjacent to the third row 950, and substantially parallel to the first row 910, second row 930, third row 950, and the central line 907.

In some embodiments, the central line 907 and the first row 910 can each comprise a substantially linear arrangement of eight coalescing filter assemblies 25. Further, the second row 930 can comprise a substantially linear arrangement of seven coalescing filter assemblies 25, the third row 950 can comprise a substantially linear arrangement of six coalescing filter assemblies 25, and the fourth row 970 can comprise a substantially linear arrangement of four coalescing filter assemblies 25. In some other embodiments, any one of the central line 910, the first row 910, the second row 930, the third row 950, and the fourth row 970 can comprise fewer numbers of coalescing filter assemblies 25. In some further embodiments, if the coalescing filter assembly 25 are smaller than those that are shown, and/or the vessel 905 is larger than shown, then any one of the central line 907, the first row 910, the second row 930, the third row 950, and the fourth row 970 can comprise greater numbers of coalescing filter assemblies 25.

Further, the packing arrangement 900 can be substantially symmetrical so that the arrangement of the first row 910, second row 930, third row 950, and fourth row 970 can be substantially mirrored on the opposite side of the central axis 901. In some other embodiments of the invention, the packing arrangement 900 can comprise a different number of rows of coalescing filter assembly 25 than those depicted. For example, in some embodiments, the packing arrangement 900 can include three rather than four rows of coalescing filter assemblies 25 positioned substantially on each side of the central axis 901. In some other embodiments, the packing arrangement 900 can comprise fewer rows. Alternatively, in some other embodiments, the packing arrangement 900 can comprise additional rows than those depicted in FIG. 9. For example, in some embodiments, the packing arrangement 900 can comprise additional rows and/or additional coalescing filter assemblies 25 within a vessel 905 that is larger than illustrated. In some further embodiments, the coalescing filter assembly 25 can be smaller than illustrated, and the vessel 905 can be about the same size as illustrated, smaller, or larger than illustrated.

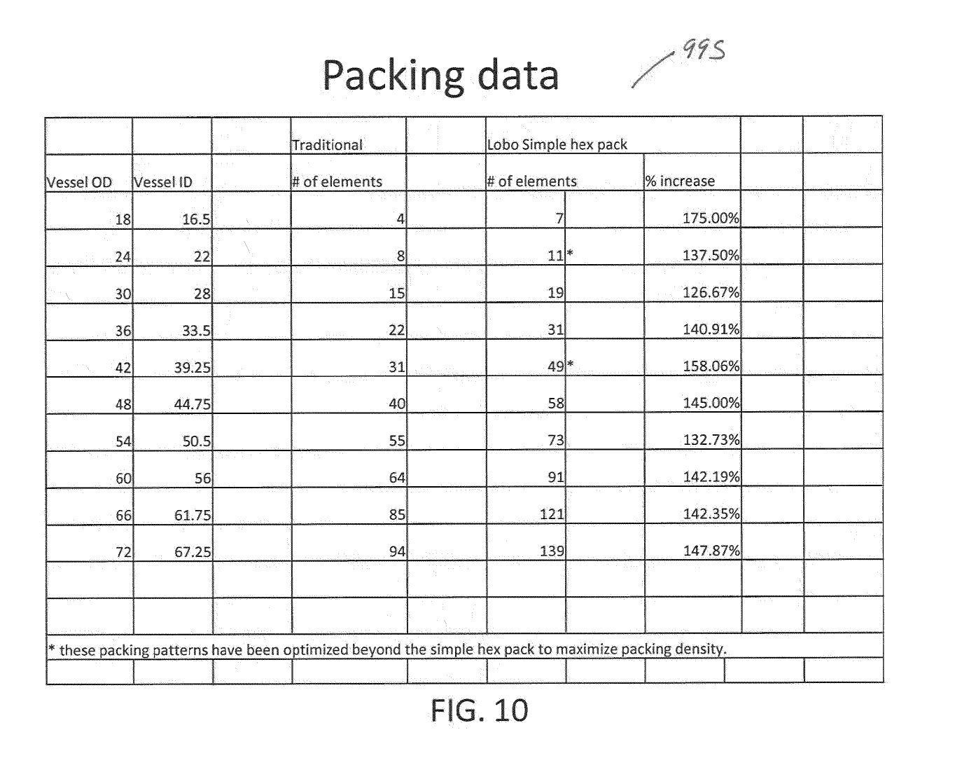

FIG. 10 illustrates coalescing filter packing data 995 comparing conventional and coalescing filter assembly 25 in accordance with some embodiments of the invention. As illustrated, for any given filtration vessel comprises a vessel OD and ID, a greater number of coalescing filter assemblies 25 can be packed into the vessel when compared with traditional filter element assemblies. In this example, a filtration vessel with an OD of 18 and an ID of 16.5 can accommodate four filtration elements, whereas up to seven coalescing filter assembly 25 can be accommodated (providing for a 175% increase). Further, in this example, a filtration vessel with an OD of 72 and an ID of 67.25 can accommodate ninety four filtration elements, whereas up to one hundred and thirty nine coalescing filter assemblies 25 can be accommodated (providing for about a 147% increase).

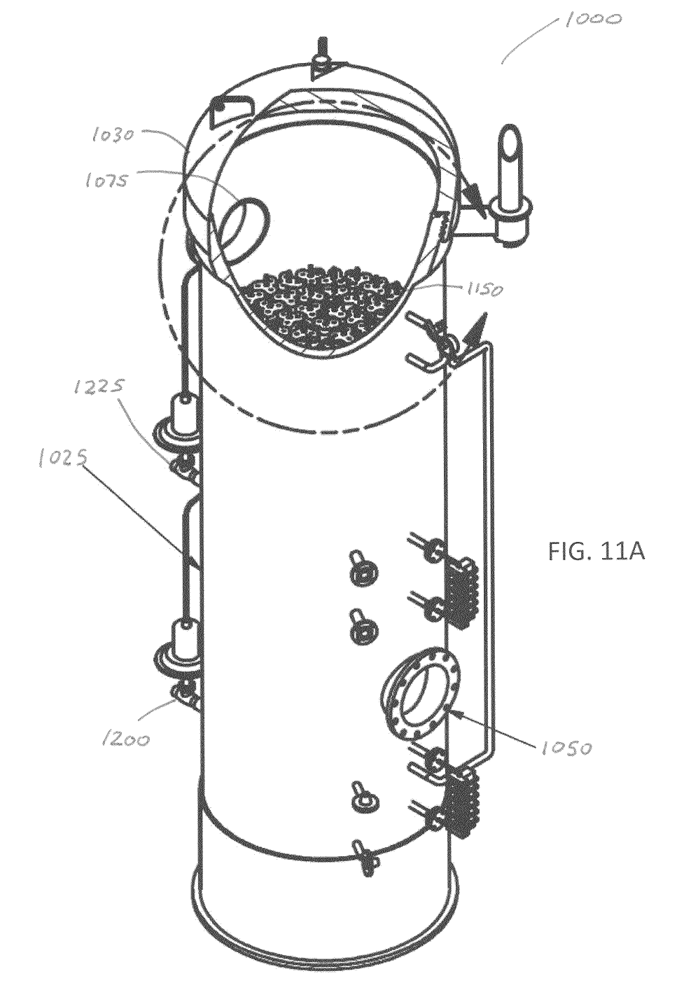

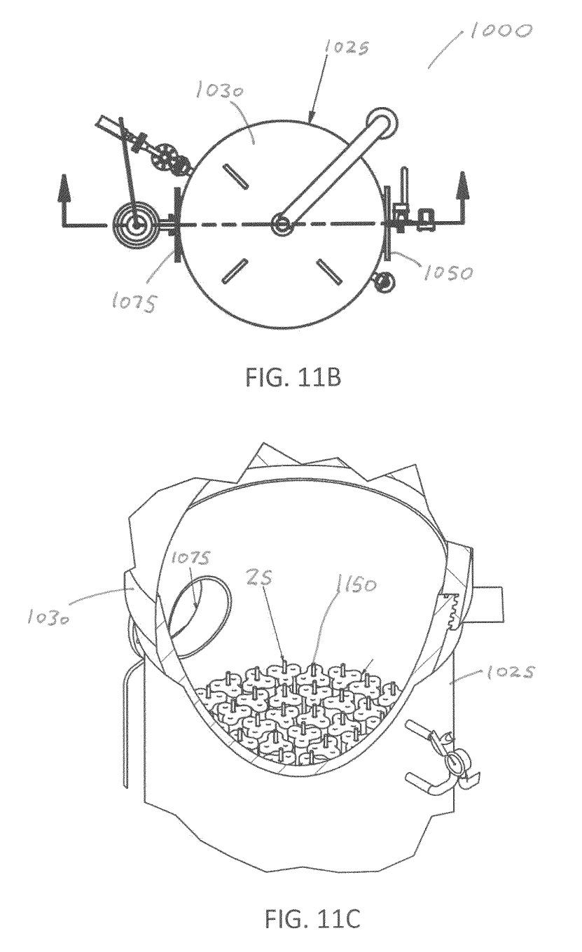

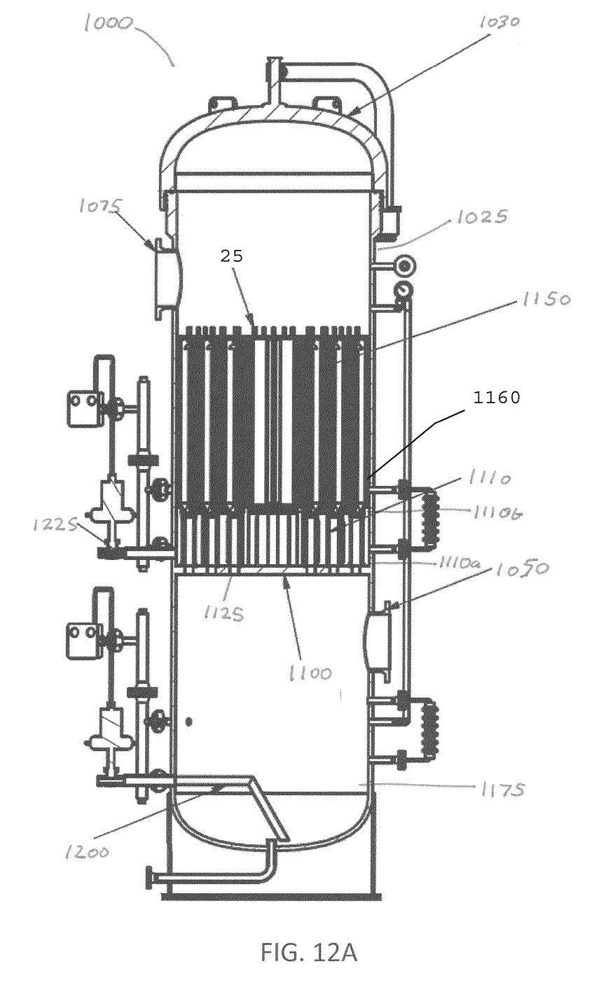

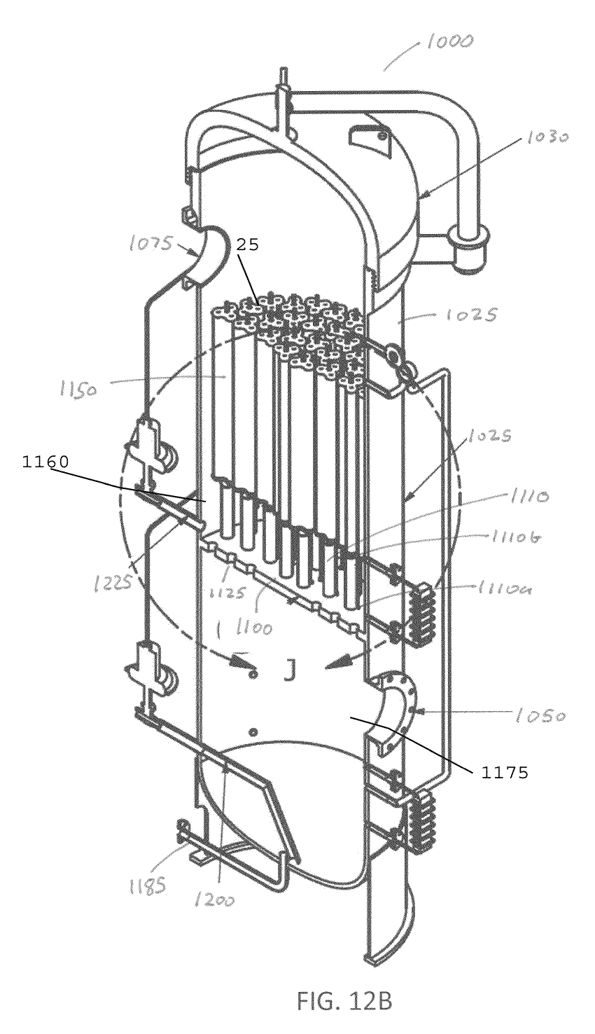

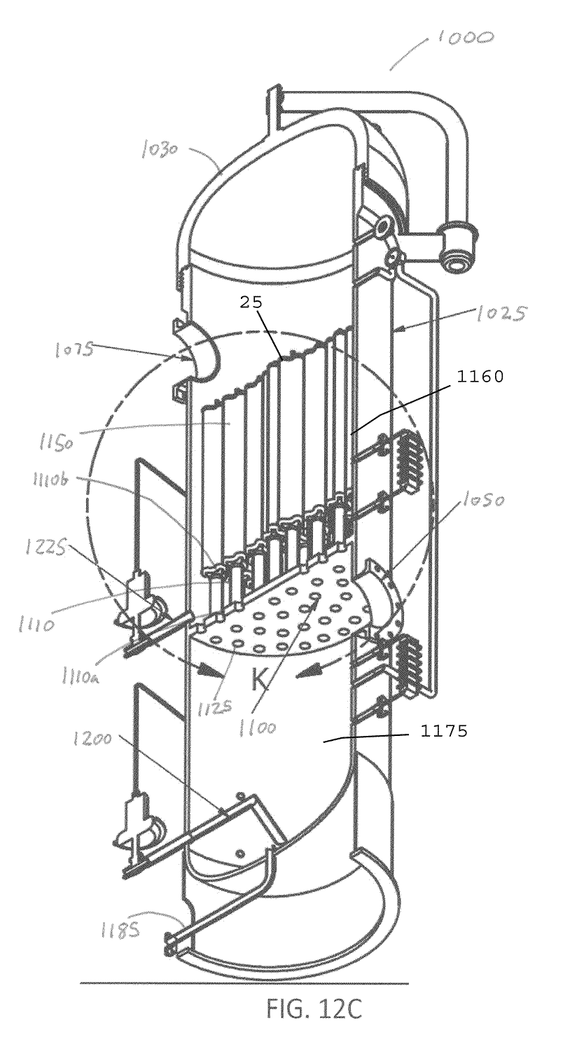

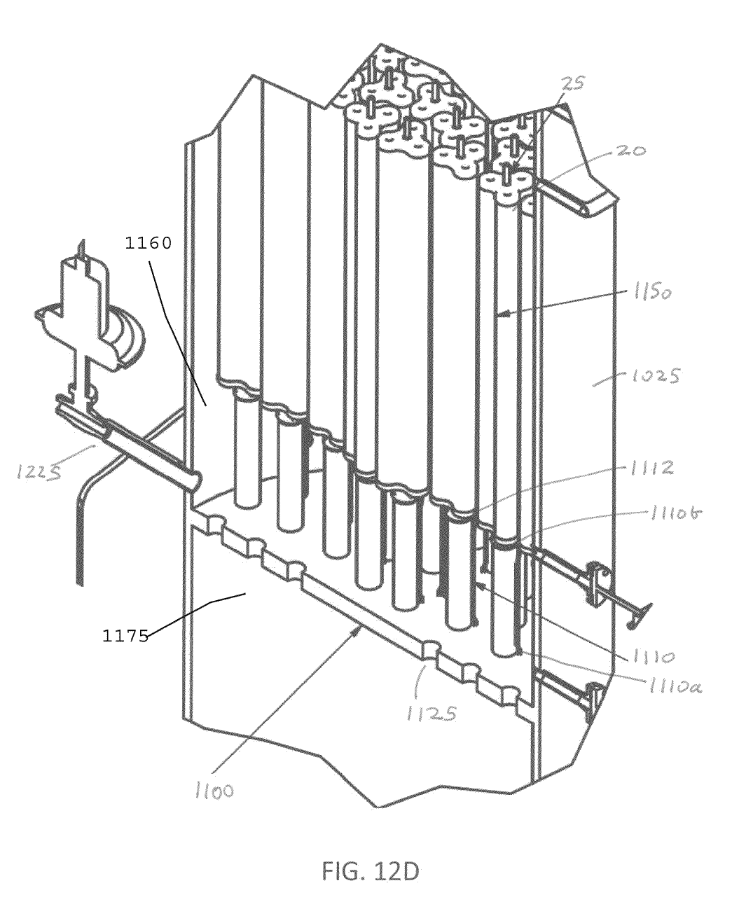

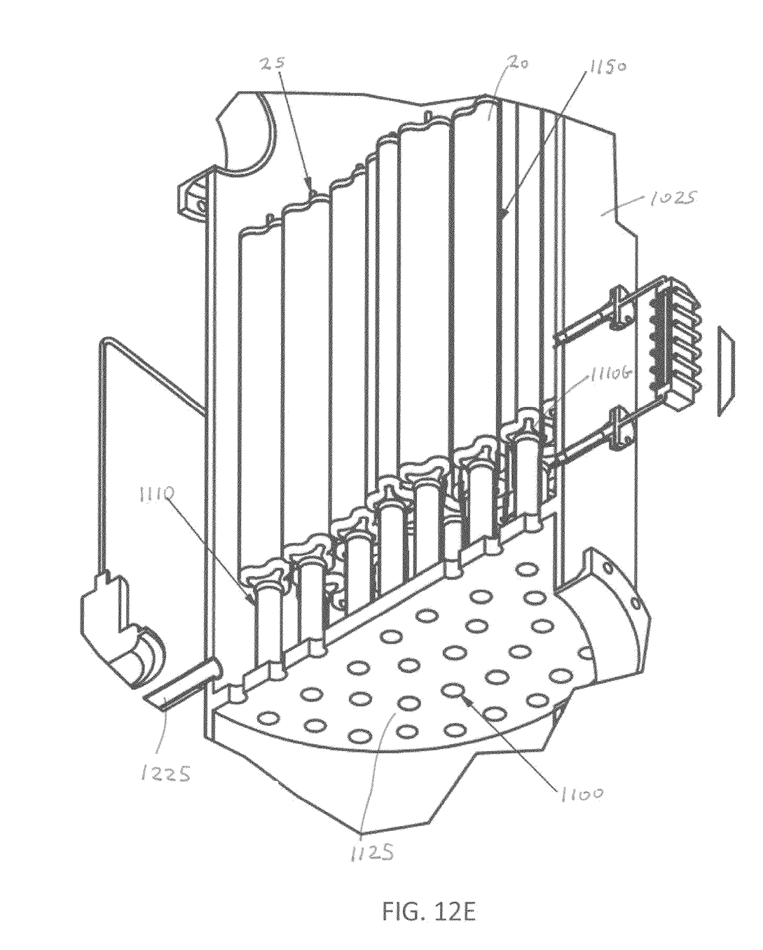

In some embodiments, one or more coalescing filter assemblies 25 can be coupled to a coalescing filter assembly system 1000. In some embodiments, any of the coalescing filter assembly 25 packing arrangements described earlier and shown in FIGS. 7A-7E, 8-9, and/or any of the number of coalescing filter assemblies 25 described by the coalescing filter packing data 995 illustrated in FIG. 10 can be integrated into the coalescing filter assembly system 1000. For example, FIG. 11A illustrates a perspective view with a partial cross-section view of a gas coalescence filtration and process system 1000, FIG. 11B illustrates a top view of a gas coalescence filtration and process system 1000, and FIG. 11C illustrates a partial perspective view with a partial cross-section view of a gas coalescence filtration and process system 1000 in accordance with some embodiments of the invention. Further, FIG. 12A illustrates a side cross-sectional view of a gas coalescence filtration and process system 1000 in accordance with some embodiments of the invention. In some embodiments, the gas coalescence filtration and process system 1000 can comprise a vessel body 1025 including a vessel lid 1030, at least one vessel inlet 1050, and at least one vessel outlet 1075. In some embodiments, the gas coalescence filtration and process system 1000 can comprise a plurality of fluid manifolds, pressure relief valves, and other fluid control assemblies including, but not limited to, a bulk liquid drain 1200 and a captured liquid drain 1225. Some embodiments can include a mechanism for interfacing a filter assembly (such as a coalescing filter assembly 25 or coalescing filter assembly 225) with a cylindrical riser pipe assembly and sealing surface. Further, some embodiments can deploy the use of centering or alignment nodes or fins, which will orient all of the filter elements into their correct packing alignment on the cylindrical riser pipe. In some embodiments, this can help prevent installing an unsuitable cylindrical element on the riser.

In some embodiments, the coalescence filtration and process system 1000 can comprise a tube sheet 1100 positioned within the vessel body 1025. For example, FIG. 12B-12C illustrate a perspective cross-sectional view of a gas coalescence filtration and process system 1000, and FIG. 12C illustrates a perspective cross-sectional view of a gas coalescence filtration and process system 1000 in accordance with some embodiments of the invention. In some embodiments, the tube sheet 1100 can comprise a plurality of openings 1125 coupled to a plurality of risers 1110 at a first rise end 1110a. FIG. 12D illustrates a perspective cross-sectional view of a portion of a gas coalescence filtration and process system 1000, and FIG. 12E illustrates a perspective cross-sectional view of a portion of a gas coalescence filtration and process system 1000 in accordance with some embodiments of the invention. In some embodiments, the plurality of risers 1110 can comprise integral end cap portions 1112 at a second riser end 1110b. In some further embodiments, a plurality of coalescing filter assemblies 1150 (e.g., comprising one or more coalescing filter assemblies 25, 225) can be mounted atop the plurality of risers 1110 by coupling the integral end cap portions 1112 to the open end caps 35 at the first end 27 of the one or more coalescing filter assemblies 25, or to the open end caps 235 at the first end 227 of the one or more coalescing filter assemblies 225.

In some embodiments, fluid can be at least partially processed, filtered, and/or coalesced by the gas coalescence filtration and process system 1000. For example, in some embodiments, fluid can enter the gas coalescence filtration and process system 1000 through the inlet 1050, and can proceed through the tube sheet 1100 by passing through at least one of the plurality of openings 1125 coupled to a plurality of risers 1110. In some embodiments, fluid can then pass through at least one of the plurality of risers 1110, and into at least one of the plurality of coalescing filter assemblies 1150 by passing through integral end cap portions 1112 into at least one coalescing filter assembly. As illustrated in the example embodiments, the filter assembly can comprise a coalescing filter assembly 25, and in other embodiments, the filter assembly can include coalescing filter assembly 225 (not shown).

In some embodiments, at least a portion of the fluid can coalesce and remain within at least a portion of at least one of the coalescing filter assemblies 25 within the gas coalescence filtration and process system 1000. Further, in some embodiments, at least a portion of the fluid can travel out of at least one of the coalescing filter assemblies 25 through the plurality of fluid passages (e.g., through fluid passages 42c within the filtration media 42b). In some embodiments, various contaminants, including liquids and/or particles entering through the inlet 1050 can collect in the lower sump 1175, and optionally pass out of the gas coalescence filtration and process system 1000 through the drain 1185. In some embodiments, other contaminants including liquids, and/or particles, and/or aerosols that are coalesced from the fluid can drain into the upper sump 1160, and can be optionally drained using one or more drain ports.

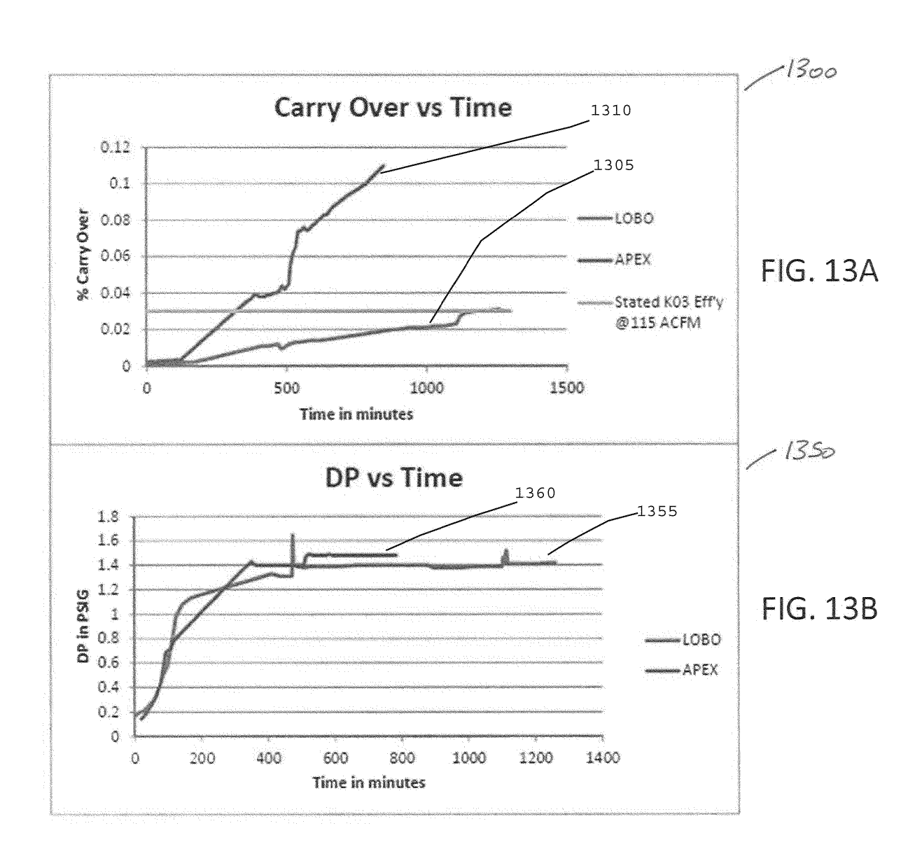

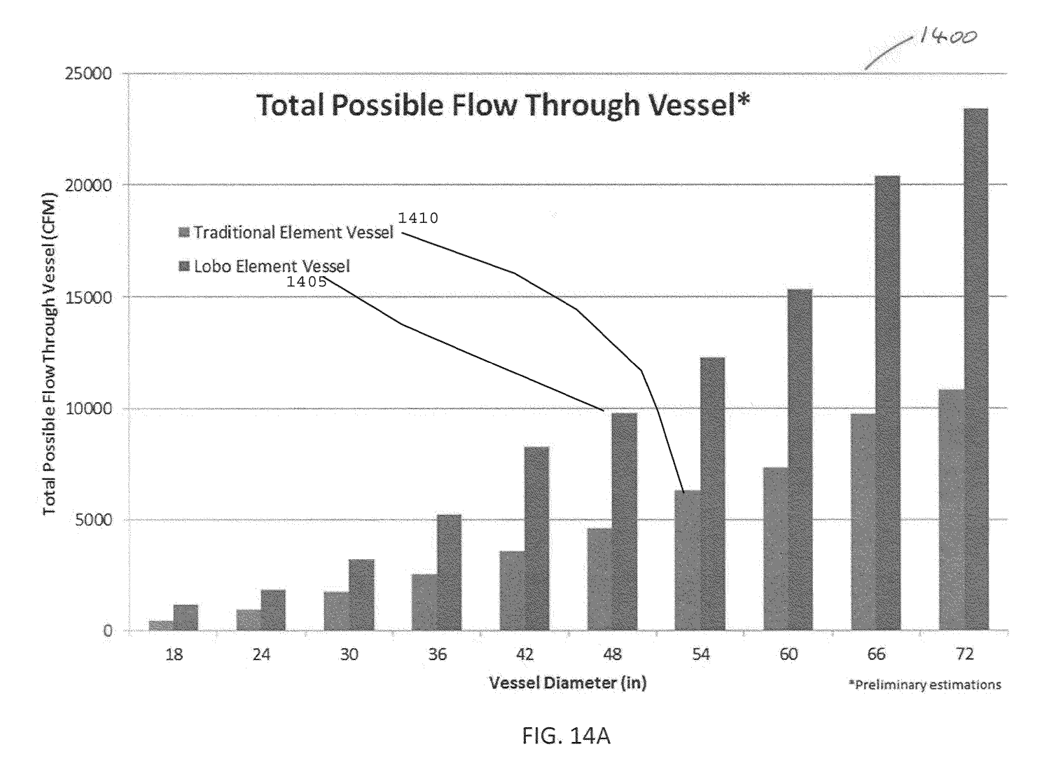

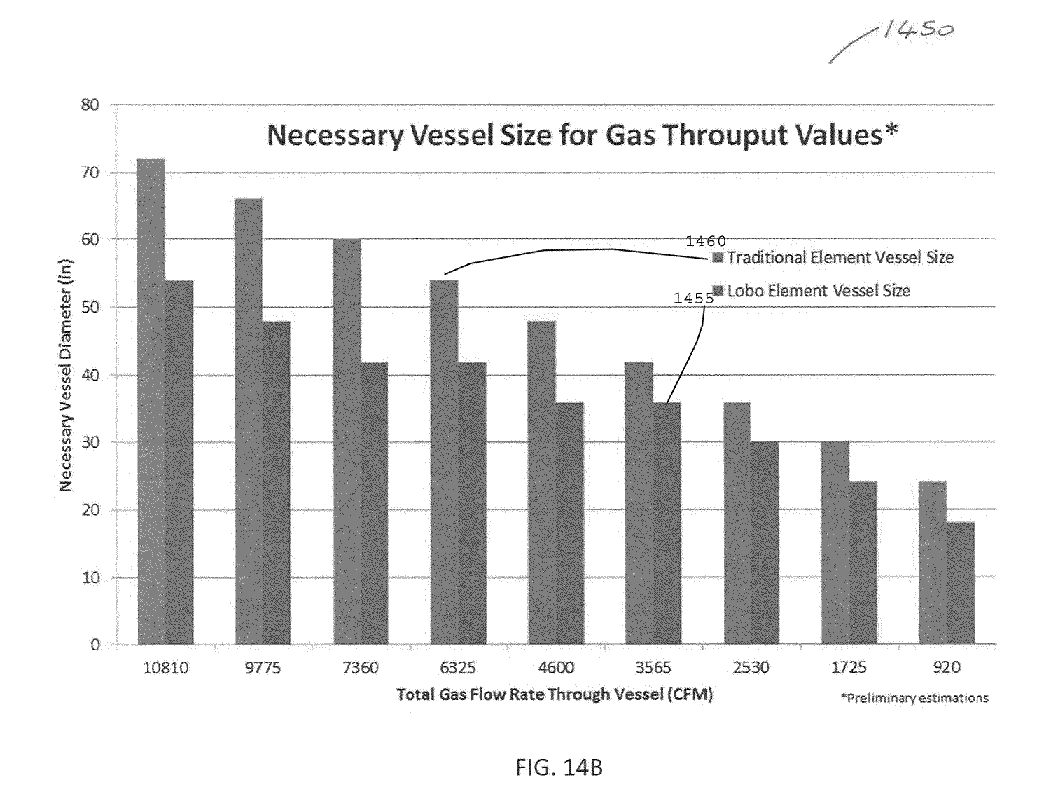

FIG. 13A illustrates a plot 1300 of carry over as a function of time comparing conventional (curve 1310) and a gas coalescence filtration and process system 1000 (curve 1305) in accordance with some embodiments of the invention. As illustrated, in some embodiments, the gas coalescence filtration and process system 1000 can provide a higher performance by providing a higher percentage carry over versus time compared with a conventional gas coalescence filtration and process system. Further, FIG. 13B illustrates a plot 1350 of differential pressure as a function of time comparing conventional and a gas coalescence filtration and process system in accordance with some embodiments of the invention. Curve 1355 shows the data provided by at least one embodiment of the gas coalescence filtration and process system 1000, and curve 1360 shows data for a conventional gas coalescence filtration and process system. Furthermore, in some embodiments, using one or more coalescing filter assemblies 25, configured and arranged according to at least one embodiment of the invention as described herein, the gas coalescence filtration and process system 1000 can provide improved performance by enabling improved fluid flow. For example, FIG. 14A illustrates a graph 1400 showing total possible flow through comparing conventional (data 1410), and a gas coalescence filtration and process system 1000 (data 1405) in accordance with some embodiments of the invention. Further, FIG. 14B illustrates a graph 1450 showing necessary vessel size for gas throughput through comparing conventional (data 1460) and a gas coalescence filtration and process system 1000 (data 1455) in accordance with some embodiments of the invention. FIG. 14A illustrates the total possible flow through a vessel is greater for a gas coalescence filtration and process system 1000 (represented by data 1405) than in a conventional system (represented by data 1410). Moreover, FIG. 14B illustrates that vessel size can be lower for any given gas throughput when using a gas coalescence filtration and process system 1000 as compared to a conventional system.

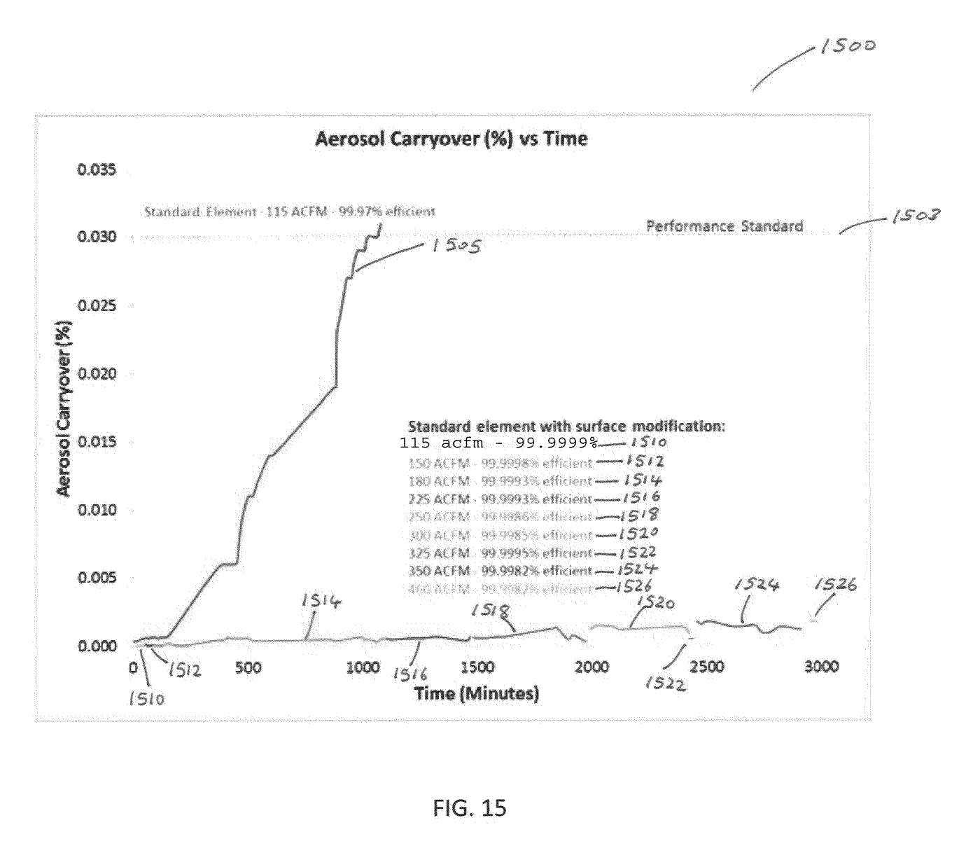

As described earlier, some embodiments of the invention can include treated and/or modified materials that can improve aerosol rejection. For example, some embodiments of the invention can be manufactured so that at least a portion any of the lobes 45, 50, 55 coalescing filter assemblies 25, and/or any of the lobes 245, 250, 255 of the coalescing filter assemblies 225 can include hydrophobic, super-hydrophobic, and/or super-oleophobic materials, coatings, and surfaces to alter aerosol rejection, and drainage of coalesced liquids from the filter. The effects of including one or more coalescing filter assemblies 25 including at least one filter element 20 or one or more coalescing filter assemblies 225 including at least one filter element 200 comprising hydrophobic, super-hydrophobic, and/or super-oleophobic filtration media 42b can be observed by measuring the aerosol carryover and comparing with untreated filtration media 42b. For example, FIG. 15 illustrates a graph 1500 of aerosol carryover as a function of time and a variety of flow rates comparing a standard filter element (data curve), and a standard filter element (data curve portions 1510, 1512, 1514, 1516, 1518, 1520, 1522, 1524, 1526) with surface modification in accordance with some embodiments of the invention. The plot 1500 shows a performance level 1503 (which is breached by an untreated filter element, curve 1505), compared to aerosol carryover for a series of flow rates including 115 acfm 1510 showing a 99.9999% efficiency, 150 acfm 1512 showing a 99.9998% efficiency, 180 acfm 1514 showing a 99.9993% efficiency, and 225 acfm 1516 showing a 99.9993% efficiency. Further, plot 1500 shows aerosol carryover for a series of flow rates for a filter element comprising a treated filtration media 42b also includes 250 acfm 1518 showing a 99.9986% efficiency, 300 acfm 1520 showing a 99.9985% efficiency, 325 acfm 1522 showing a 99.9995% efficiency, 350 acfm 1524 showing a 99.9982% efficiency, and 460 acfm 1526 showing a 99.9982% efficiency.

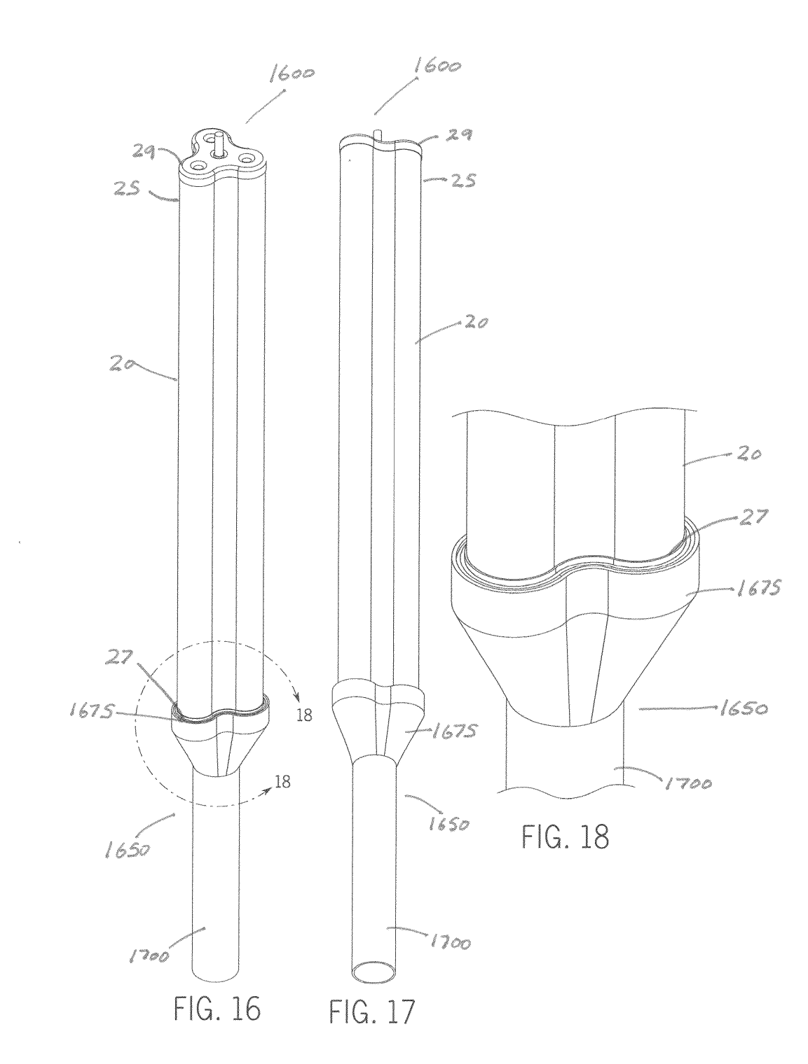

Some embodiments of the invention include systems and methods to assemble one or more seal coalescing filter assemblies 25. For example, FIGS. 16-27, 27A, and 28-31 illustrate various views of assemblies that comprise coalescing filter assemblies 25 that include sealing assemblies. For example, FIGS. 16 and 17 illustrate perspective views of a coalescing filter assembly 1600 in accordance with some embodiments of the invention.

In some embodiments, the coalescing filter assembly 1600 can comprise a coalescing filter assembly 25 coupled to a sealing assembly 1650 at the first end 27 of the coalescing filter assembly 25. FIG. 18 illustrates a close up view of a region of the coalescing filter assembly shown in FIG. 16 in accordance with some embodiments of the invention. In some embodiments, the sealing assembly 1650 can comprise a filter coupler 1675 coupled to the first end 27 of the coalescing filter assembly 25. Further, in some embodiments, the sealing assembly 1650 can comprise an extension 1700 coupled to the filter coupler 1675 at an opposite end to the coalescing filter assembly 25, and can extend away from the filter coupler 1675 and the coalescing filter assembly 25. In some embodiments, a region or section of the filter coupler 1675 portion of the sealing assembly 1650 can be generally trefoil shaped. For example, in some embodiments, the cross-section of at least a portion of the filter coupler 1675 can comprises a substantially trefoil shape. The trefoil shape can be substantially matched to the trefoil shape of the coalescing filter assembly 25 in some embodiments. In this instance, the filter coupler 1675 can be shaped to couple and accept the coalescing filter assembly 25 that can comprise a first end 27 that is substantially trefoil shaped. In some other embodiments, the filter coupler 1675 can comprise other shapes to substantially match a shape of the first end 27 of the coalescing filter assembly 25. For example, in some other embodiments, a lateral cross-section of the filter coupler 1675 can comprise at a substantially regular polygon, a substantially irregular polygon, a tetrafoil, a cinquefoil, a hexafoil, a heptafoil, an octofoil, a nonofoil, a decafoil, a multifoil, or various combinations thereof. In some embodiments, the cross-section of the filter coupler 1675 can be symmetric, asymmetric, or various combinations thereof. Moreover, some embodiments can include multi-lobed shapes (e.g., three, four, five or more lobes).

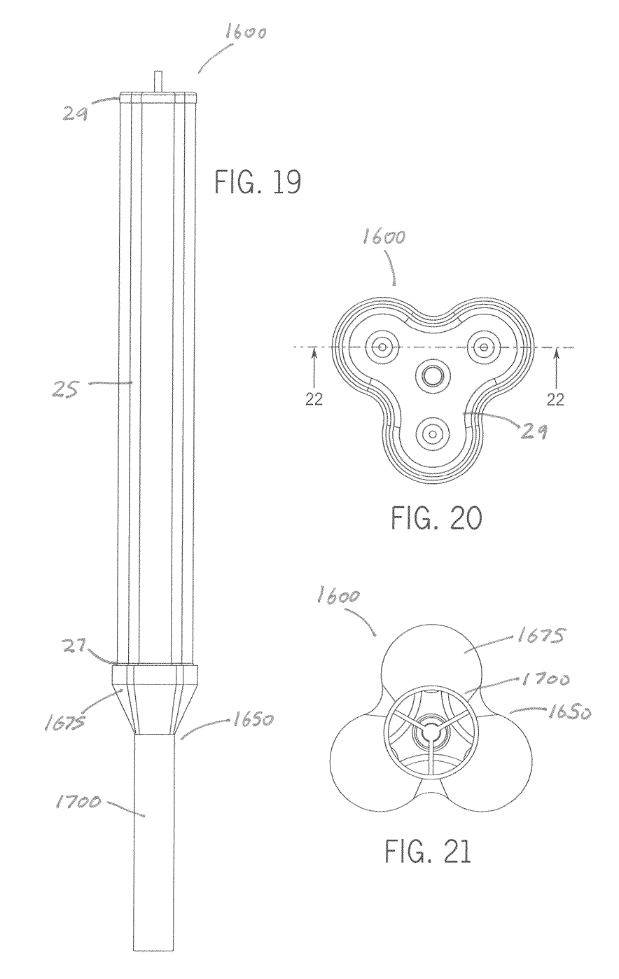

FIG. 19 illustrates a side view of a coalescing filter assembly 1600, FIG. 20 illustrates a top view of a coalescing filter assembly 1600, and FIG. 21 illustrates bottom view of a coalescing filter assembly 1600 in accordance with some embodiments of the invention. In the embodiment shown in FIGS. 16 and 17, the extension 1700 can be substantially parallel with the coalescing filter assembly 25. In other embodiments, the extension 1700 can extend away from the coalescing filter assembly 25 forming an angle with the coalescing filter assembly 25 that is greater than or less than 180°.

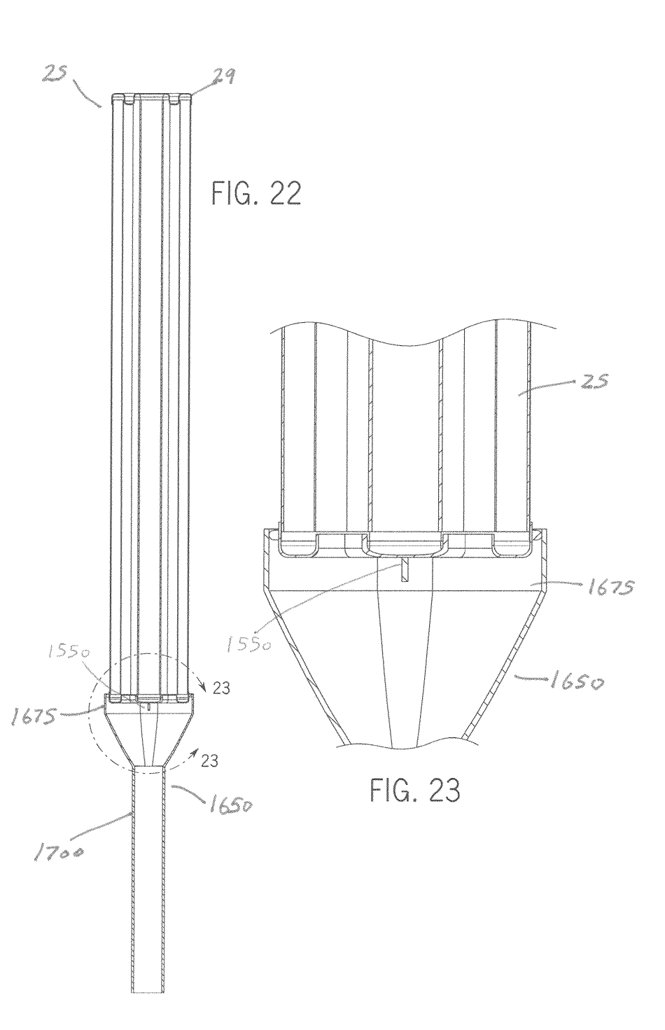

FIG. 22 illustrates a side sectional view of a coalescing filter assembly 1600 in accordance with some embodiments of the invention. As shown, in some embodiments, the coalescing filter assembly 25 can be positioned extending at least partially into the sealing assembly 1650. Further, in some embodiments, at least a portion of the sealing assembly 1650 can extend around at least one outer surface of the coalescing filter assembly 25.

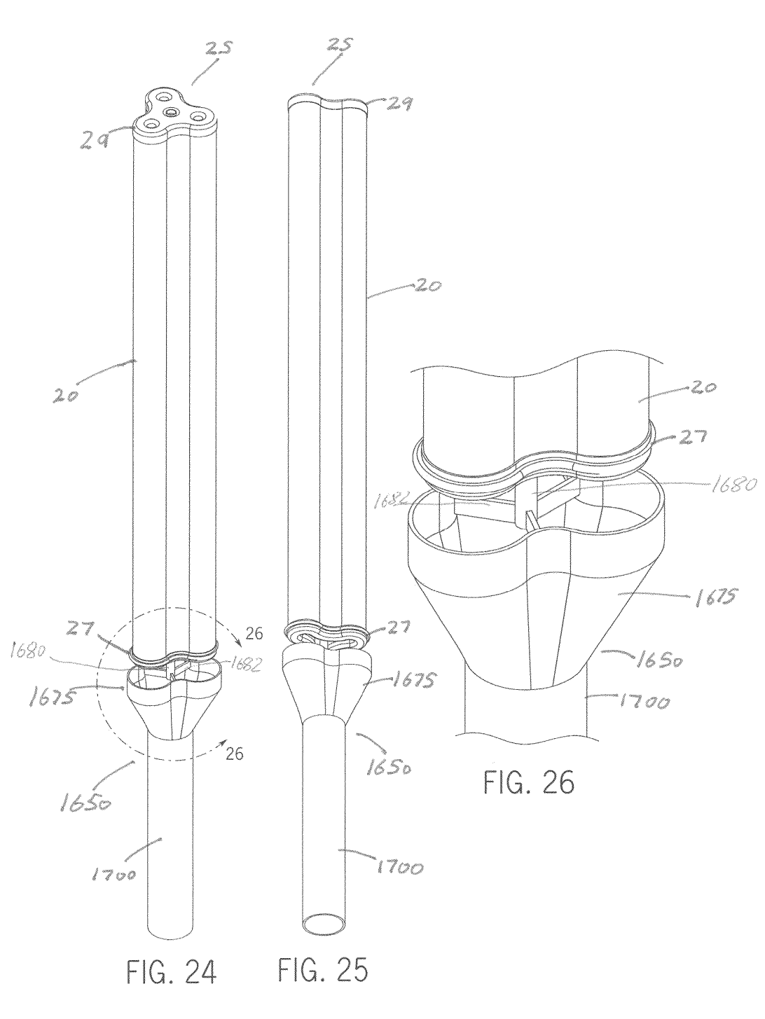

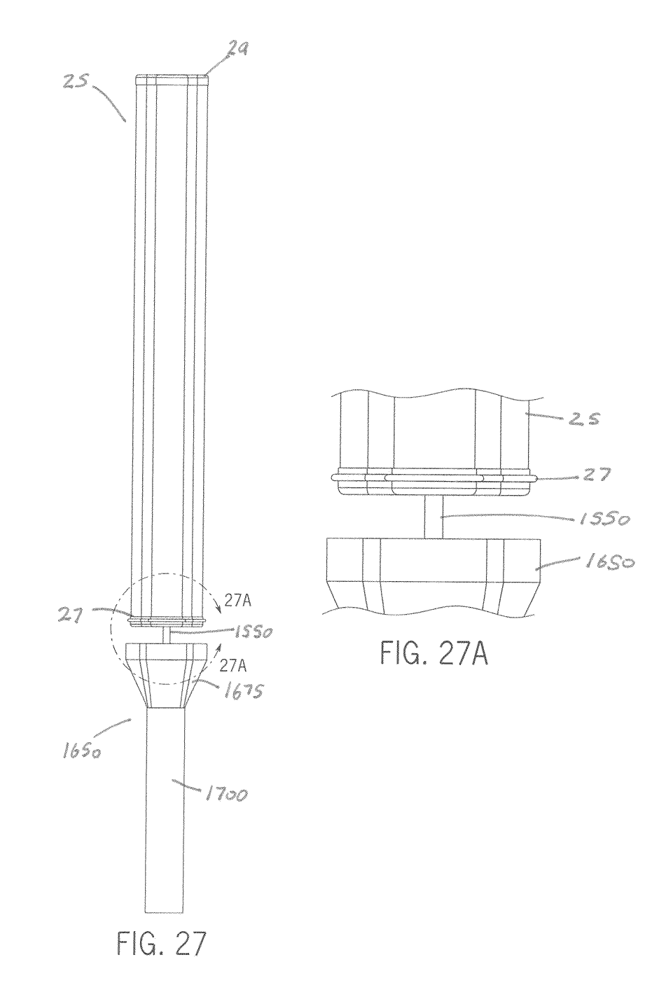

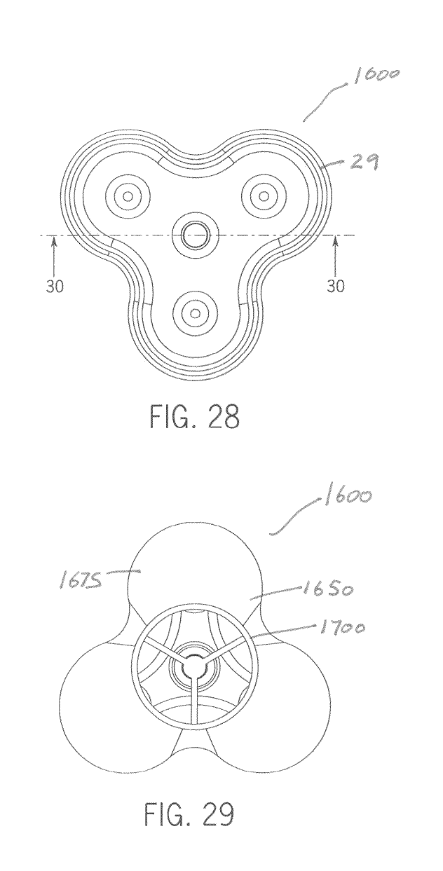

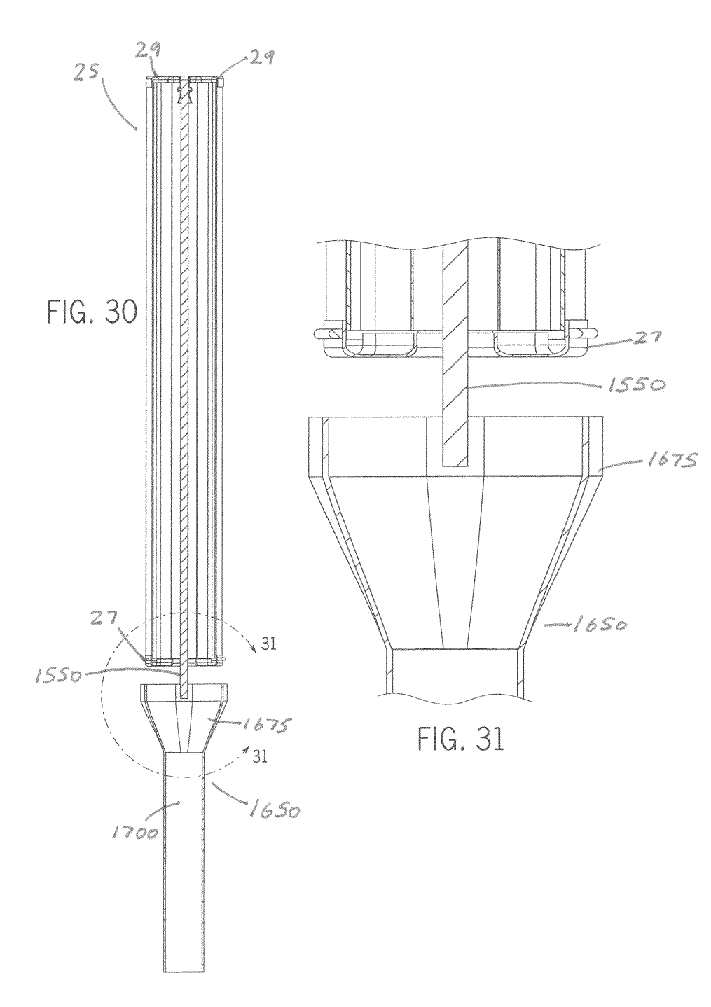

In some embodiments, the coalescing filter assembly 1600 can include one or more coupling and/or joining apparatus to aid in aligning and/or coupling portions of the coalescing filter assembly 1600 including the coalescing filter assembly 25 and the sealing assembly 1650. FIG. 23 illustrates a close up view of a region of the coalescing filter assembly 1600 shown in FIG. 22. Further, FIG. 27 illustrates an assembly side view of the coalescing filter assembly 1600 shown in FIG. 19 in accordance with some embodiments of the invention, and FIG. 27A shows a close-up view of the region in FIG. 27 in accordance with some embodiments of the invention. FIGS. 28 and 29 illustrate top and bottom views of the coalescing filter assembly 1600, FIG. 30 illustrates a side cross sectional view of the coalescing filter assembly 1600 of FIG. 27, and FIG. 31 illustrates a close-up of a region of the side cross sectional view of the coalescing filter assembly 1600 of FIG. 30 in accordance with some embodiments of the invention. As shown at least in FIGS. 22-23, 27, and 27A, in some embodiments, the coalescing filter assembly 1600 can comprise a coalescing filter assembly 25 that includes at least one mating rod 1550 at the first end 27 of the coalescing filter assembly 25 extending away from the first end 27 and the second end 29 of the coalescing filter assembly 25. In some embodiments, the mating rod 1550 can couple with a portion of the sealing assembly 1650. FIGS. 24 and 25 illustrate assembly perspective views of the coalescing filter assembly 1600 shown in FIGS. 16 and 17, and FIG. 26 illustrates an assembly close-up view of a region of the coalescing filter assembly 1600 shown in FIG. 24 in accordance with some embodiments of the invention. In some embodiments, the sealing assembly 1650 can comprise at least one mating coupler 1680. In some embodiments, the at least one mating coupler 1680 can be coupled to the filter coupler 1675 portion of the sealing assembly using a plurality of ribs 1682. In some embodiments, the mating rod 1550 can couple with the at least one mating coupler 1680. For example, in some embodiments, the mating rod 1550 can be inserted into the at least one mating coupler 1680 to align and/or couple and/or seal the coalescing filter assembly 25 to the sealing assembly 1650.

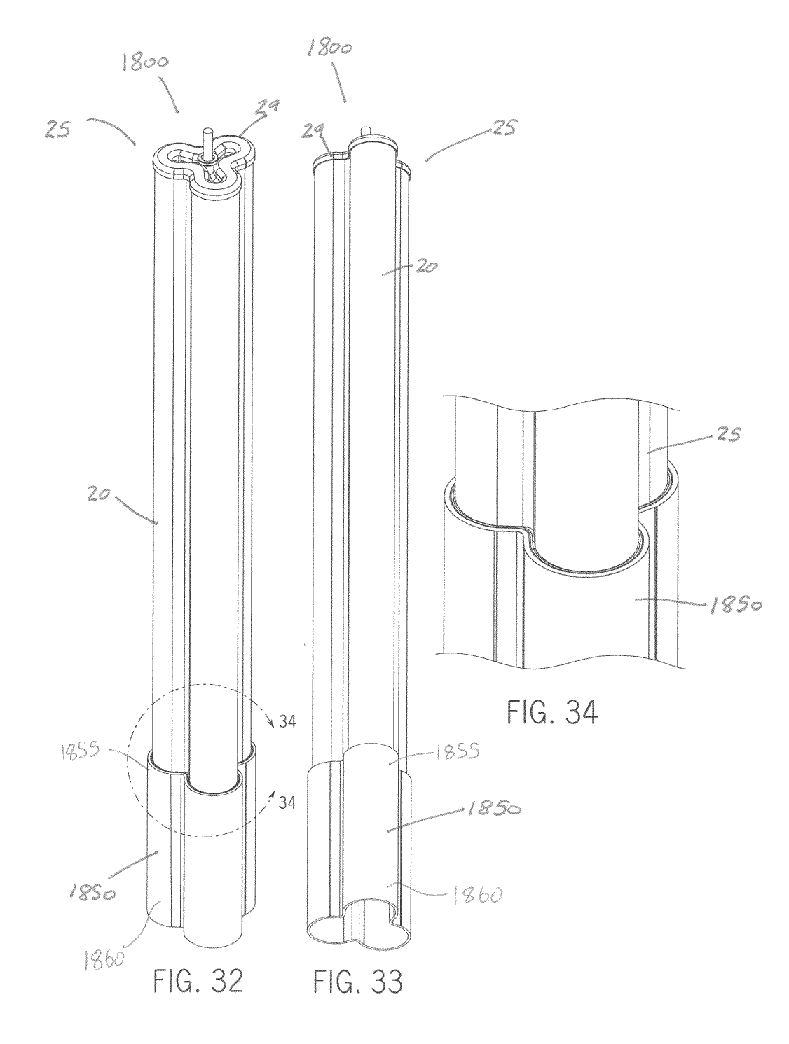

Some embodiments of the invention include systems and methods to assembly and one or more seal coalescing filter assemblies 25. For example, FIGS. 32-43, 43A, and 44-47 illustrate various views of assemblies that comprise coalescing filter assemblies 25 that include sealing assemblies 1850. For example, FIGS. 32 and 33 illustrate perspective views of a coalescing filter assembly 1800 in accordance with some embodiments of the invention. In some embodiments, the coalescing filter assembly 1800 can comprise a coalescing filter assembly 25 coupled to a sealing assembly 1850 at the first end 27 of the coalescing filter assembly 25. FIG. 34 illustrates a close up view of a region of the coalescing filter assembly 1800 shown in FIG. 32 in accordance with some embodiments of the invention. In some embodiments, the sealing assembly 1850 can comprise a first end 1855 coupled to the first end 27 of the coalescing filter assembly 25. Further, in some embodiments, the sealing assembly 1850 can comprise a second end 1860 coupled to the first end 1855 at an opposite end to the coalescing filter assembly 25, and can extend away from the first end 1855 and the coalescing filter assembly 25.

In some embodiments, a region or section of the first end 1855 portion of the sealing assembly 1850 can be generally trefoil shaped. For example, in some embodiments, the cross-section of at least a portion of the first end 1855 can comprises a substantially trefoil shape. In some embodiments, the trefoil shape can be matched to the trefoil shape of the coalescing filter assembly 25. In this instance, the first end 1855 can be shaped to couple to and accept the coalescing filter assembly 25 that can comprise a first end 27 that is substantially trefoil shaped. In some other embodiments, the first end 1855 can comprise other shapes to match a shape of the first end 27 of the coalescing filter assembly 25. For example, in some other embodiments, a lateral cross-section of the first end 1855 can comprise at a substantially regular polygon, a substantially irregular polygon, a tetrafoil, a cinquefoil, a hexafoil, a heptafoil, an octofoil, a nonofoil, a decafoil, a multifoil, or various combinations thereof. In some embodiments, the cross-section of the first end 1855 can be symmetric, asymmetric, or various combinations thereof. Moreover, some embodiments can include multi-lobed shapes (e.g., three, four, five or more lobes).

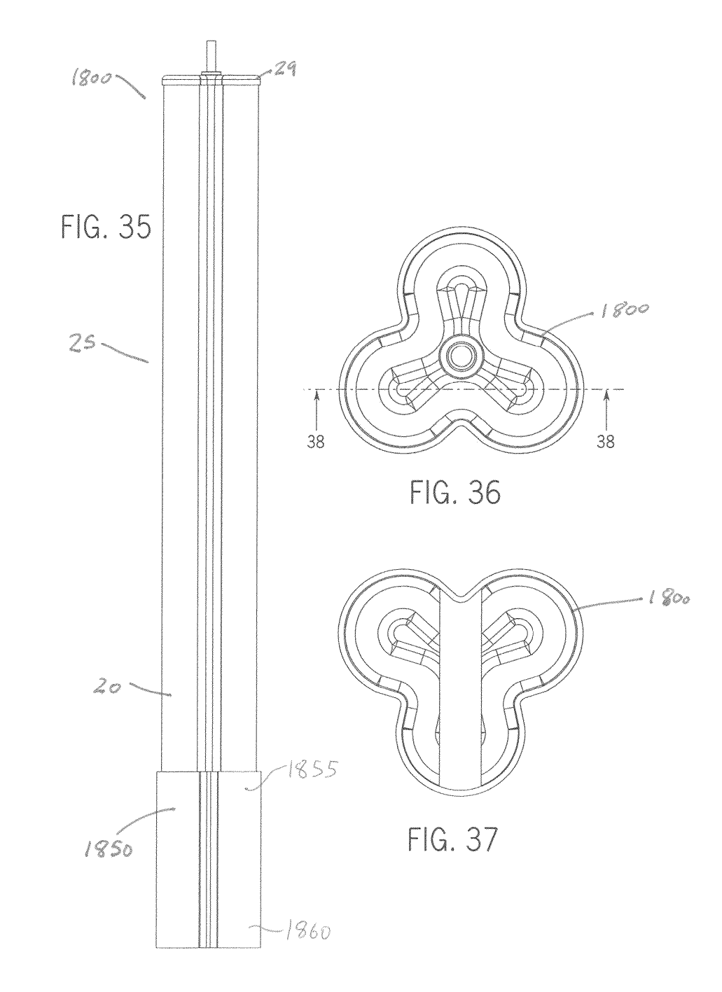

FIG. 35 illustrates a side view of a coalescing filter assembly 1800, FIG. 36 illustrates a top view of a coalescing filter assembly 1800, and FIG. 37 illustrates a bottom view of a coalescing filter assembly 1800 in accordance with some embodiments of the invention. In the embodiment shown in FIGS. 32 and 33, the second end 1860 can be substantially parallel with the coalescing filter assembly 25. In other embodiments, the second end 1860 can extend away from the coalescing filter assembly 25 forming an angle with the coalescing filter assembly 25 that is greater than or less than 180°.

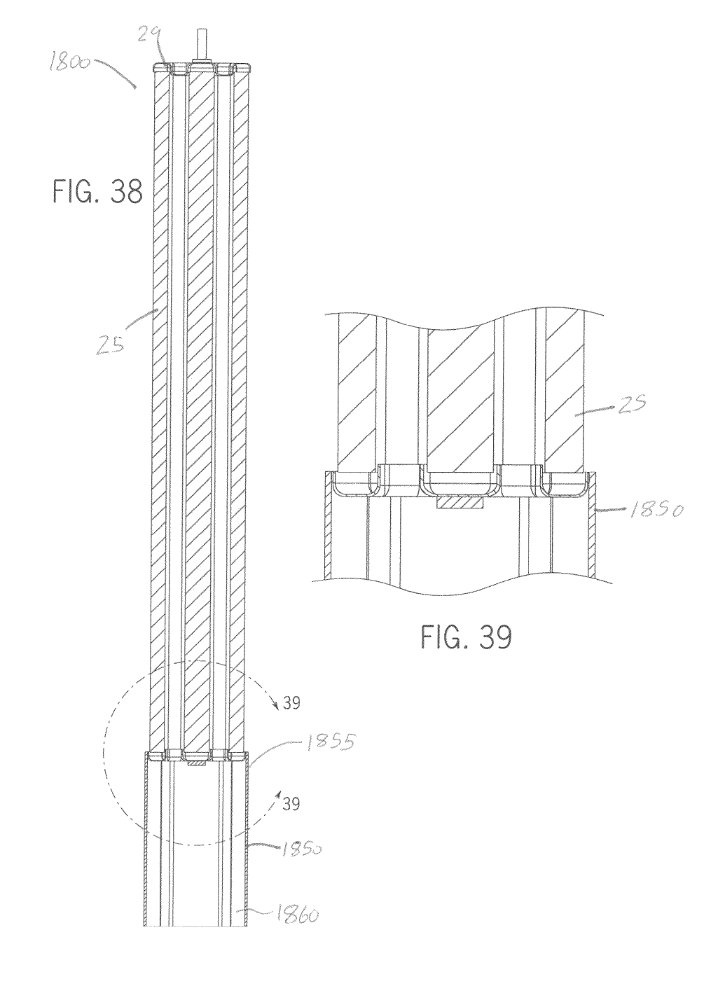

FIG. 38 illustrates a side sectional view of a coalescing filter assembly 1800 in accordance with some embodiments of the invention. As shown, in some embodiments, the coalescing filter assembly 25 can be positioned extending at least partially into the sealing assembly 1850. Further, in some embodiments, at least a portion of the sealing assembly 1850 can extend around at least one outer surface of the coalescing filter assembly 25.

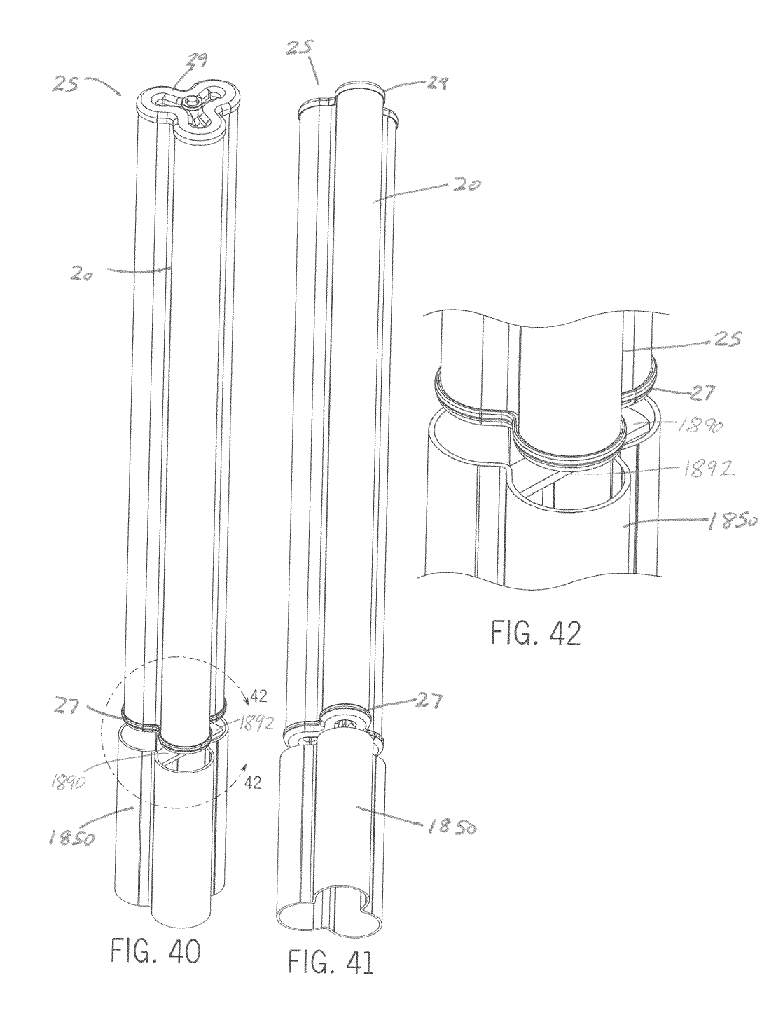

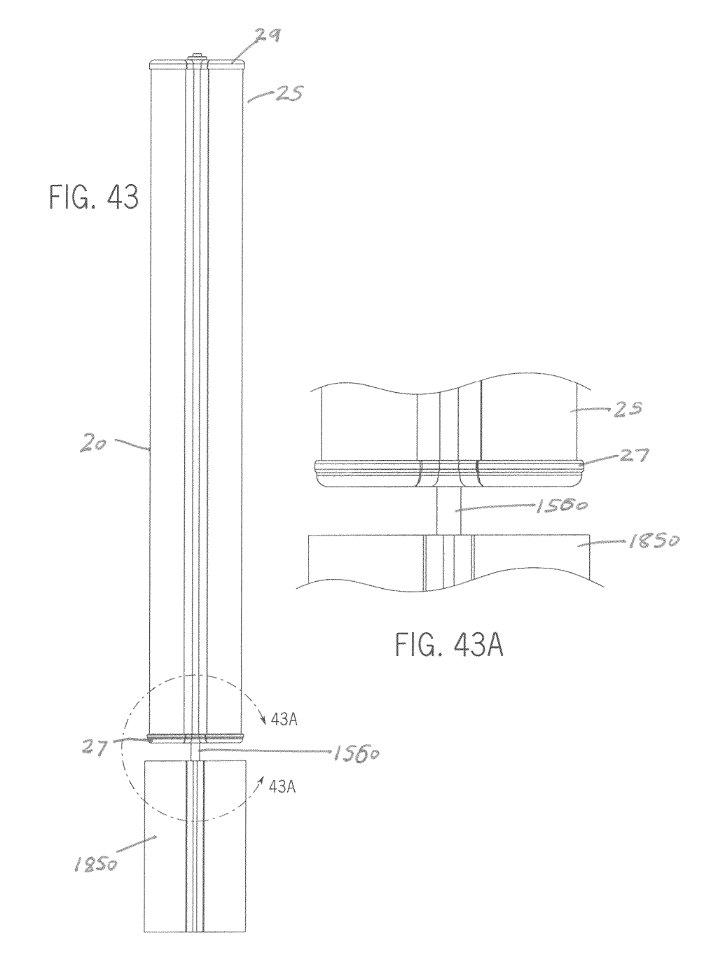

In some embodiments, the coalescing filter assembly 1800 can include one or more coupling and/or joining apparatus to aid in aligning and/or coupling portions of the coalescing filter assembly 1800 including the coalescing filter assembly 25 and the sealing assembly 1850. FIG. 39 illustrates a close up view of a region of the coalescing filter assembly 1800 shown in FIG. 38. Further, FIG. 43 illustrates an assembly side view of the coalescing filter assembly 1800 shown in FIG. 35 in accordance with some embodiments of the invention, and FIG. 43A shows a close-up view of the region in FIG. 43 in accordance with some embodiments of the invention.

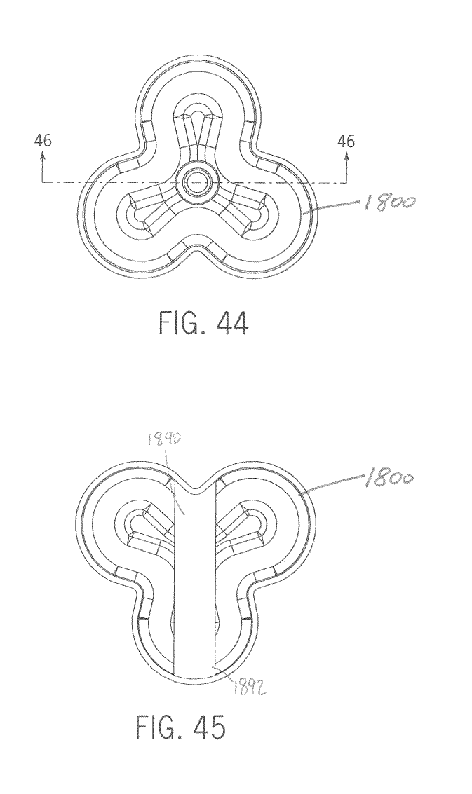

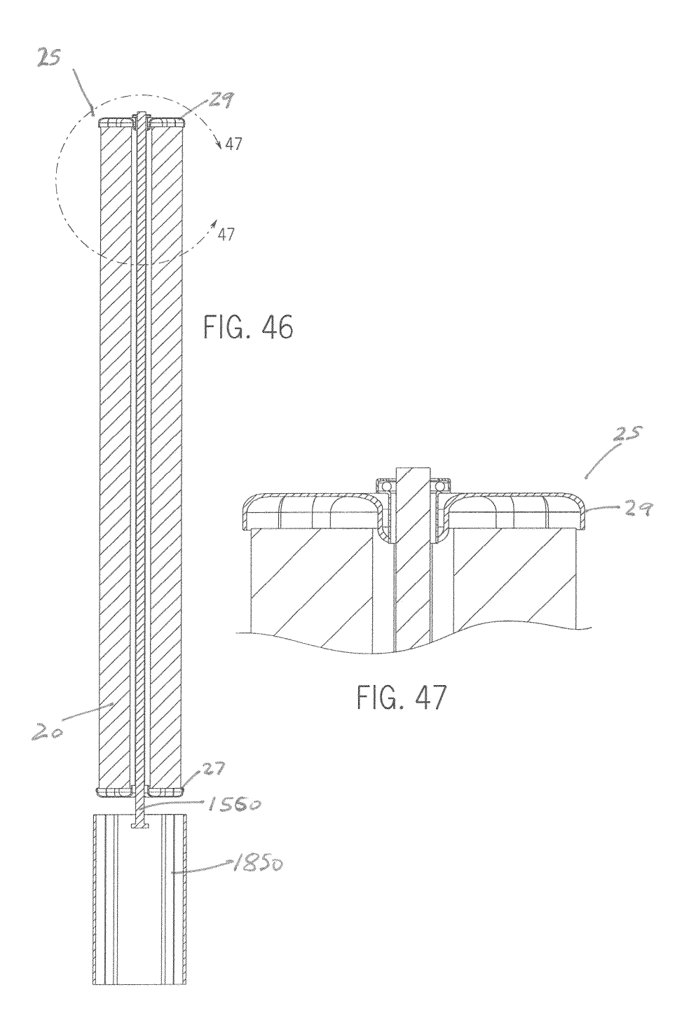

FIGS. 44 and 45 illustrate top and bottom views of the coalescing filter assembly 1800, FIG. 46 illustrates a side cross sectional view of the coalescing filter assembly 1800 of FIG. 43, and FIG. 47 illustrates a close-up of a region of the side cross sectional view of the coalescing filter assembly 1800 of FIG. 46 in accordance with some embodiments of the invention. As shown at least in FIGS. 43-43A, in some embodiments, the coalescing filter assembly 1800 can comprise a coalescing filter assembly 25 that includes at least one mating rod 1560 at the first end 27 of the coalescing filter assembly 25 extending away from the first end 27 and the second end 29 of the coalescing filter assembly 25.

In some embodiments, the mating rod 1560 can couple with a portion of the sealing assembly 1850. FIGS. 40 and 41 illustrate assembly perspective views of the coalescing filter assembly 1800 shown in FIGS. 32 and 33, and FIG. 42 illustrates an assembly close-up view of a region of the coalescing filter assembly 1800 shown in FIG. 40 in accordance with some embodiments of the invention. In some embodiments, the sealing assembly 1850 can comprise at least one mating coupler 1890. In some embodiments, the at least one mating coupler 1890 can be coupled to the first end 1855 portion of the sealing assembly using at least one rib 1892. In some embodiments, the mating rod 1560 can couple with the at least one mating coupler 1890. For example, in some embodiments, the mating rod 1560 can be coupled with and/or into the sealing assembly 1850 (showing in FIG. 46). Further, in some embodiments, the mating rod 1560 can be coupled with and/or into the at least one mating coupler 1890 to align and/or couple and/or seal the coalescing filter assembly 25 to the sealing assembly 1850.

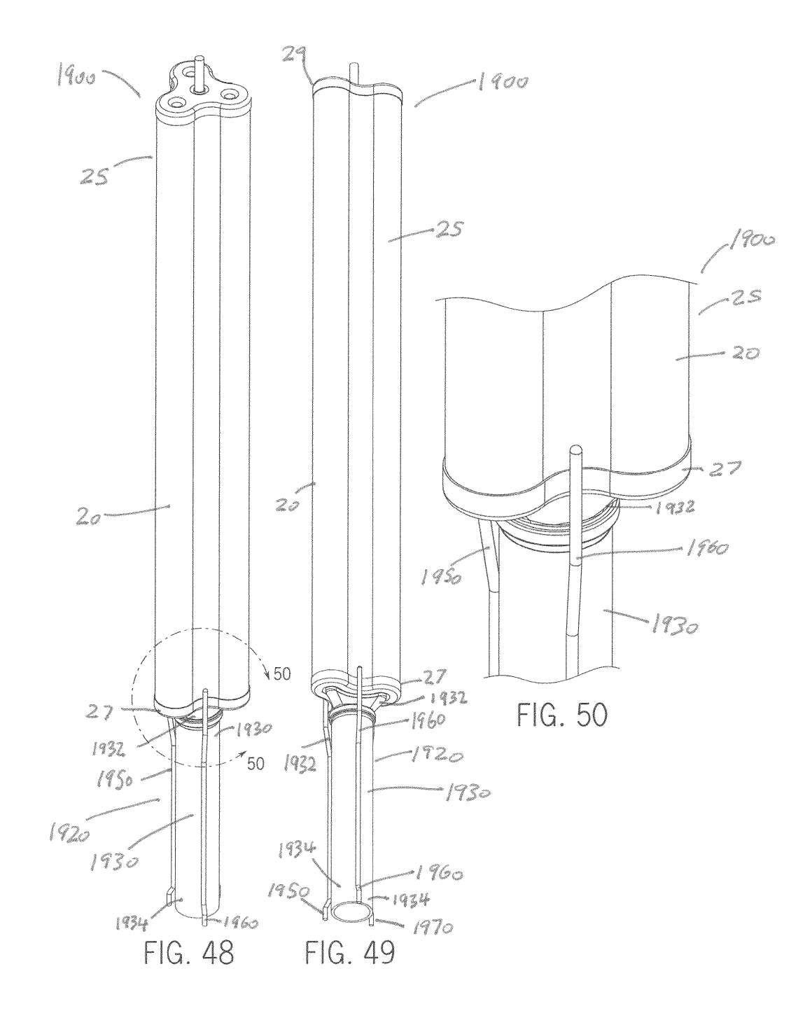

Some embodiments of the invention include systems and methods to assembly and one or more seal coalescing filter assemblies 25. For example, FIGS. 48-43, 43A, and 44-47 illustrate various views of assemblies that comprise coalescing filter assemblies 25 that include sealing assemblies 1920. For example, FIGS. 48 and 49 illustrate perspective views of a coalescing filter assembly 1900 in accordance with some embodiments of the invention. In some embodiments, the coalescing filter assembly 1900 can comprise a coalescing filter assembly 25 coupled to a sealing assembly 1920 comprising a main body 1930 and positioned and coupled to the first end 27 of the coalescing filter assembly 25. FIG. 50 illustrates a close up view of a region of the coalescing filter assembly 1900 shown in FIG. 48 in accordance with some embodiments of the invention. In some embodiments, the sealing assembly 1920 can comprise a first end 1932 coupled to the first end 27 of the coalescing filter assembly 25. Further, in some embodiments, the sealing assembly 1920 can comprise a second end 1934 coupled to the first end 1932 at an opposite end to the coalescing filter assembly 25, and can extend away from the first end 1932 and the coalescing filter assembly 25.

In some embodiments, a region or section of the first end 1932 portion of the sealing assembly 1920 can be generally trefoil shaped. For example, in some embodiments, the cross-section of at least a portion of the first end 1932 can comprises a substantially trefoil shape. In some embodiments, the trefoil shape can be matched at least a portion of the trefoil shape of the coalescing filter assembly 25. In this instance, the first end 1932 can be shaped to couple to the coalescing filter assembly 25 that can comprise a first end 27 that is substantially trefoil shaped. In some other embodiments, the first end 1932 can comprise other shapes to match a shape of the first end 27 of the coalescing filter assembly 25. For example, in some other embodiments, a lateral cross-section of the first end 1932 can comprise at a substantially regular polygon, a substantially irregular polygon, a tetrafoil, a cinquefoil, a hexafoil, a heptafoil, an octofoil, a nonofoil, a decafoil, a multifoil, or various combinations thereof. In some embodiments, the cross-section of the first end 1932 can be symmetric, asymmetric, or various combinations thereof. Moreover, some embodiments can include multi-lobed shapes (e.g., three, four, five or more lobes).

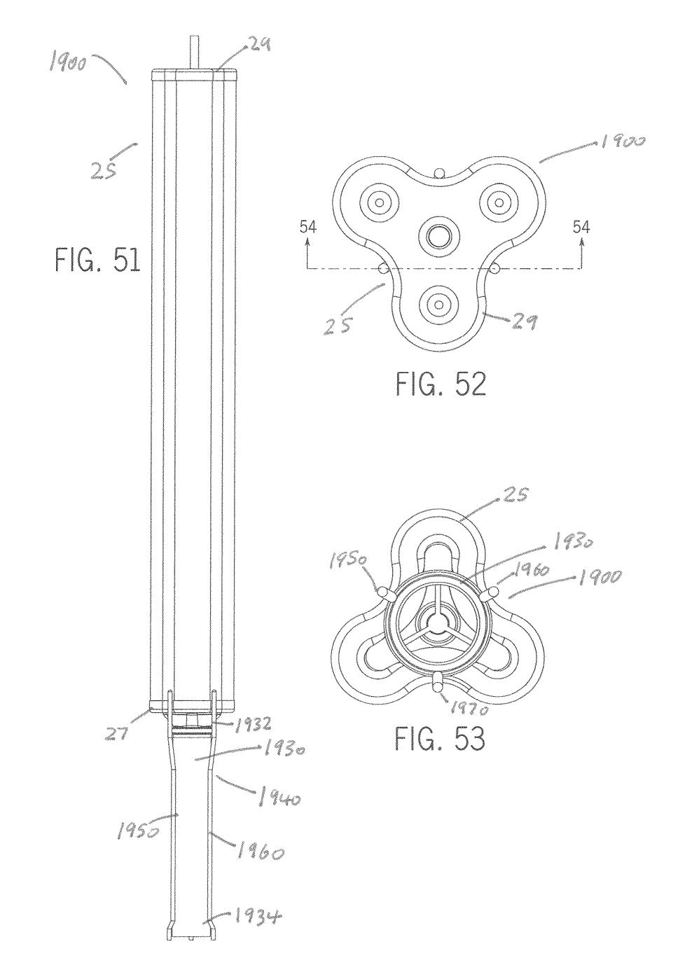

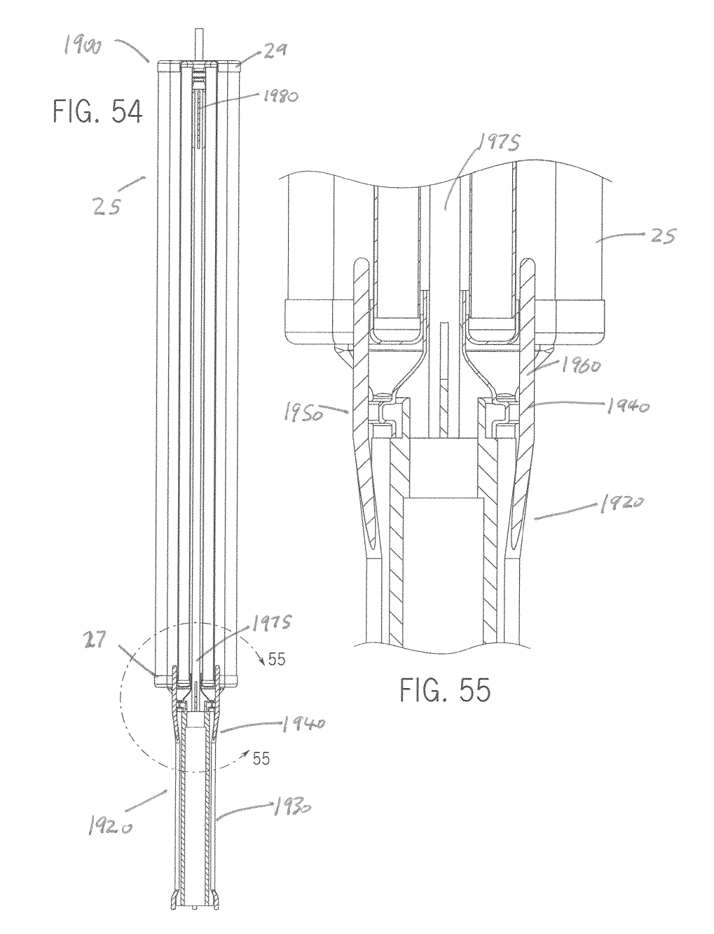

FIG. 51 illustrates a side view of a coalescing filter assembly 1900, FIG. 52 illustrates a top view of a coalescing filter assembly 1900, and FIG. 53 illustrates a bottom view of a coalescing filter assembly 1900 in accordance with some embodiments of the invention. In the embodiment shown in FIGS. 48 and 49, the second end 1934 can be substantially parallel with the coalescing filter assembly 25. In other embodiments, the second end 1934 can extend away from the coalescing filter assembly 25 forming an angle with the coalescing filter assembly 25 that is greater than or less than 180°. FIG. 54 illustrates a side sectional view of a coalescing filter assembly 1900 in accordance with some embodiments of the invention. As shown, in some embodiments, at least a portion of the sealing assembly 1920 can extend into the coalescing filter assembly 25.

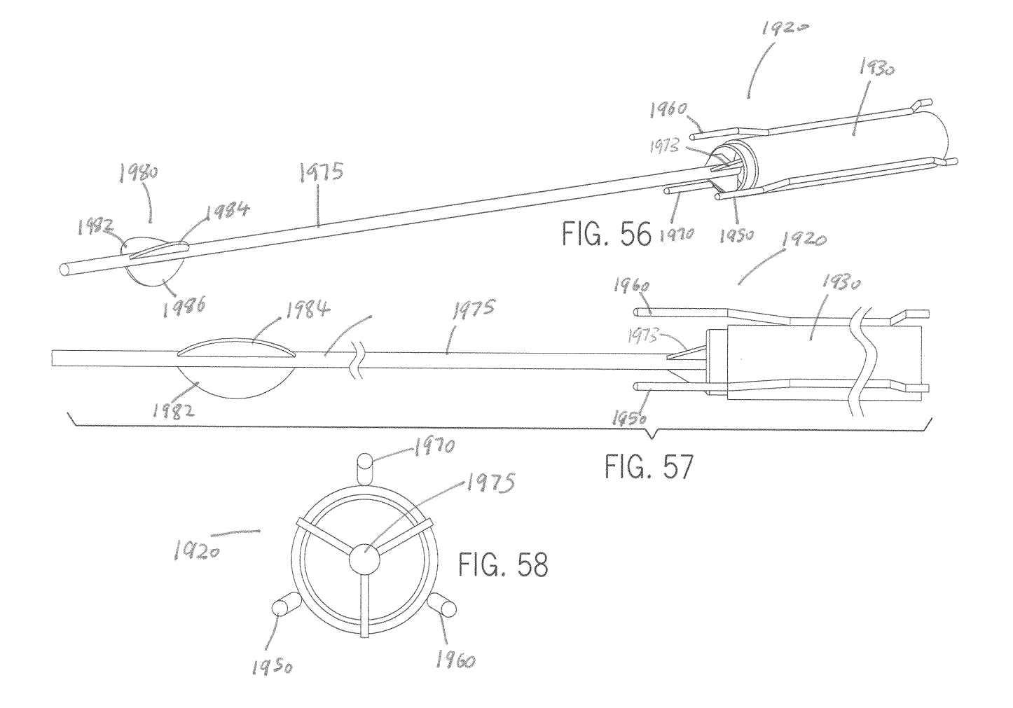

In some embodiments, the coalescing filter assembly 1900 can include one or more coupling and/or joining apparatus to aid in aligning and/or coupling portions of the coalescing filter assembly 1900 including the coalescing filter assembly 25 and the sealing assembly 1920. FIG. 55 illustrates a close up view of a region of the coalescing filter assembly 1900 shown in FIG. 54. FIG. 56 illustrates a perspective view of a sealing assembly 1920 in accordance with some embodiments of the invention. Further, FIG. 57 illustrates a side view of a sealing assembly 1920 in accordance with some embodiments of the invention, and FIG. 58 illustrates an end view of a sealing assembly 1920 in accordance with some embodiments of the invention. In some embodiments, the sealing assembly 1920 can comprise a plurality of stabilizers 1940. For example, in some embodiments, the sealing assembly 1920 can comprise a first stabilizer 1950, and/or a second stabilizer 1960, and/or third stabilizer 1970. In some embodiments, one or more of the stabilizers 1950, 1960, 1970 can couple to the main body 1930 and can extend at least a partial length of the main body 1930. In some embodiments, at least one of the stabilizers 1950, 1960, 1970 can extend away from the main body 1930 one on or both ends of the sealing assembly. For example, in some embodiments, one or more of the stabilizers 1950, 1960, 1970 can extend away from the main body 1930 at the first end 1932. In other embodiments, one or more of the stabilizers 1950, 1960, 1970 can extend away from the main body 1930 at the first end 1934. In some embodiments, at least a portion of the sealing assembly 1920 can couple with the coalescing filter assembly 25. In some embodiments, the stabilizers are not required to perform a stabilizing function.

In some embodiments, one or more of the stabilizers 1950, 1960, 1970 can be substantially linear. In other embodiments, one or more sections of the one or more of the stabilizers 1950, 1960, 1970 can comprise a bend or kink. For example, in some embodiments, the one or more of the stabilizers 1950, 1960, 1970 can comprise a bend or kink at one and/or both ends. In some embodiments, the one or more of the stabilizers 1950, 1960, 1970 can extend away from the main body 1930 in the region of the first end 1932 to accommodate coupling with a coalescing filter assembly 25. For example, in some embodiments, the one or more of the stabilizers 1950, 1960, 1970 can include a bend or kink and can extend outward from the main body 1930 in the region of the first end 1932 to accommodate coupling with a coalescing filter assembly 25. In some embodiments, one or more of the stabilizers 1950, 1960, 1970 can extend away from the main body 1930 at the first end 1932 and can couple with the coalescing filter assembly 25. As shown in FIG. 55, in some embodiments, one or more of the stabilizers 1950, 1960, 1970 can extend away from the first end 1932 and the main body 1930 and at least partially around the coalescing filter assembly 25 at the first end 27. In some embodiments, one or more of the stabilizers 1950, 1960, 1970 can extend away from the first end 1932 and couple to an outer surface of the coalescing filter assembly 25 at the first end 27 (e.g. between one or more of the plurality of lobes 40 extending between the first end 27 and the second end 29 of the coalescing filter assembly 25.) In some other embodiments, one or more of the stabilizers 1950, 1960, 1970 can extend away from the first end 1932 and the main body 1930 and at least partially into the coalescing filter assembly 25 at the first end 27. In some other embodiments, one or more of the stabilizers 1950, 1960, 1970 can extend away from the second end 1934 and the main body 1930. In some embodiments, one or more of the stabilizers 1950, 1960, 1970 can include a bend or kink and can extend outward from the main body 1930 in the region of the second end 1934. As depicted in at least FIGS. 49 and 53, in some embodiments, the one or more of the stabilizers 1950, 1960, 1970 can be substantially evenly spaced around the main body 1930 (i.e., the distance between the one or more of the stabilizers 1950, 1960, 1970 can be substantially the same). In some other embodiments, the one or more of the stabilizers 1950, 1960, 1970 can be substantially unevenly spaced around the main body 1930.

Further, as shown at least in FIGS. 54-55, in some embodiments, the coalescing filter assembly 1900 can comprise a coalescing filter assembly 25 that includes at least one mating rod 1975 (the mating rod shown also in FIGS. 56-57). In some embodiments, the mating rod 1975 can couple with a portion of the coalescing filter assembly 25. As shown in FIG. 54, in some embodiments, when coupled to the coalescing filter assembly 25 to form the coalescing filter assembly 1900, the mating rod 1975 can extend into the coalescing filter assembly 25. Further, in some embodiments, mating rod 1975 can comprise a plurality of fins 1980. As shown in FIGS. 56 and 57, in some the mating rod 1975 can comprise a first fin 1982, and/or a second fin 1984, and/or a third fin 1986. In some embodiments, one or more of the fins 1982, 1984, 1986 can comprise a generally curved profile extending outwardly from the mating rod 1975 and extending along at least a partial length of the mating rod 1975. In some embodiments, any of the fins 1982, 1984, 1986 can comprise a substantially convex outer surface extending away from the mating rod 1975 and extending along at least a partial length of the mating rod 1975. In some embodiments, the plurality of fins 1980 can be positioned inside the coalescing filter assembly 25 (e.g., when the mating rod 1975 is positioned extending into the coalescing filter assembly 25.) Further, in some embodiments, the mating rod 1975 can comprise one or more stabilizing structures coupled to the main body 1930. In some embodiments, the sealing assembly 1920 can comprise one or more supports 1973 extending from the mating rod 1975 can coupling with the main body 1930 proximate the first end 1932. In some embodiments, the sealing assembly can comprise three supports 1973 that are substantially evenly distributed around the mating rod 1975. Other embodiments can include more or less numbers of supports 1973.

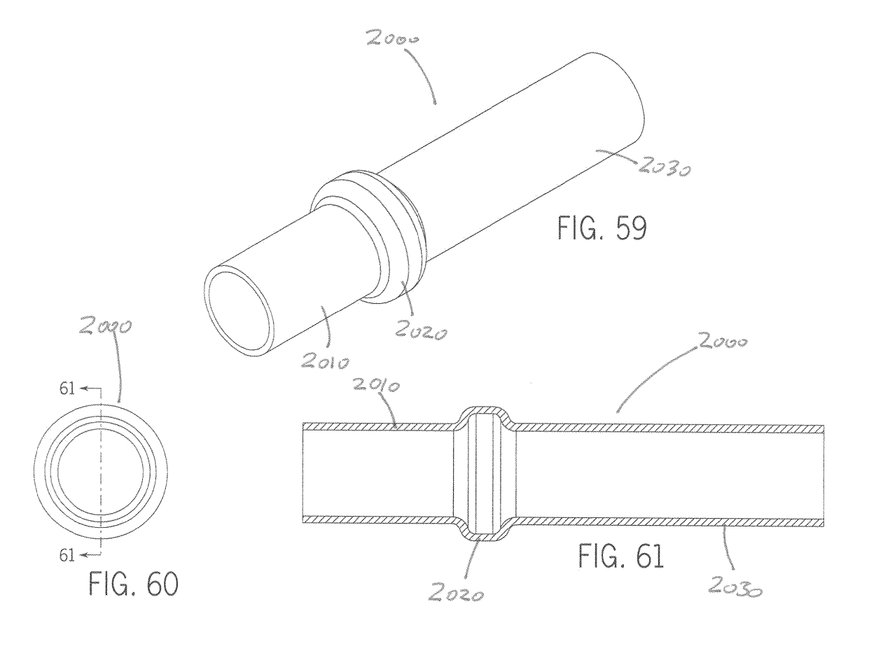

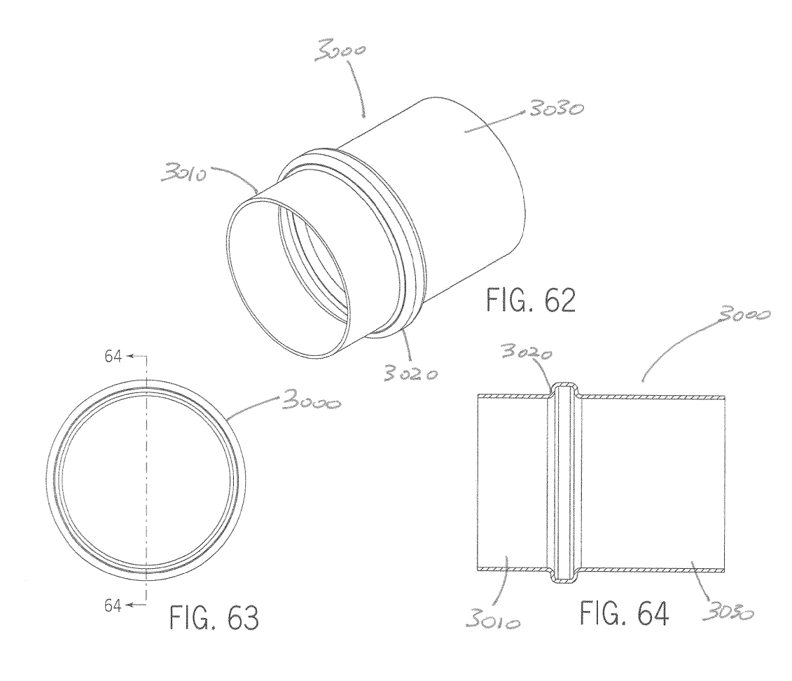

Some embodiments of the invention include sealing couplers that can be used to couple with the coalescing filter assembly 25. For example, FIG. 59 illustrates a perspective view of a sealing coupler 2000 in accordance with some embodiments of the invention. FIG. 60 illustrates an end view of the sealing coupler 2000, and FIG. 61 illustrates a side cross-sectional view of a sealing coupler 2000 in accordance with some embodiments of the invention. In some embodiments, the sealing coupler can comprise a first section 2010 and a second section 2030 coupled to the first section 2010 at a waist region 2020. Some further embodiments of the invention include sealing couplers that can be used to couple with the coalescing filter assembly 25. For example, FIG. 62 illustrates a perspective view of a sealing coupler 3000 in accordance with some embodiments of the invention. FIG. 63 illustrates an end view of the sealing coupler 3000, and FIG. 64 illustrates a side cross-sectional view of a sealing coupler 3000 in accordance with some embodiments of the invention. In some embodiments, the sealing coupler can comprise a first section 3010 and a second section 3030 coupled to the first section 3010 at a waist region 3020. As illustrated in FIGS. 59-60, and 62-63, in some embodiments, sealing couplers 2000, 3000 can comprise a substantially circular cross-section. In some embodiments either of the waist region 2020, 3020 can comprise an o-ring. In some embodiments, the waist region 2020, 3020 can comprise at least one sealing o-ring.

In some embodiments, the sealing couplers 2000, 3000 can couple with the coalescing filter assembly 25. For example, in some embodiments, the sealing couplers can extend into the coalescing filter assembly 25 at the first end 27. For example, in some embodiments, the sealing couplers 2000, 3000 can extend into the open end cap 35. As described earlier with respect to at least the embodiments in FIGS. 1A-1D, 2A-2B, and 3A-3B, in some embodiments of the invention, the coalescing filter assembly 25 can include a first end 27 that can comprise an open end cap 35 that can be partially closed and/or the include one or more apertures. In some embodiments, either of the sealing couplers 2000, 3000 can couple with and/or extend at least partially into the at least one filter element 20 of the coalescing filter assembly 25. In some embodiments, any of the coalescing filter assembly 1600, 1800, 1900 can comprise either of the sealing couplers 2000, 3000. For example, in some embodiments, the sealing couplers 2000, 3000 can be used to fluidly couple the sealing assembly 1650 to a coalescing filter assembly 25, and/or the sealing assembly 1850 to the coalescing filter assembly 25, and/or the sealing assembly 1920 to the coalescing filter assembly 25.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. Various features and advantages of the invention are set forth in the following claims.

1. A coalescing filter assembly comprising:
at least one filter element comprising at least one opening at a first end, at least one fluid inlet, and a plurality of lobes comprising at least one side wall, the at least one side wall comprising a plurality of fluid outlets; and
an open end cap positioned at the first end, the open end cap comprising a main opening fluidly coupled to the at least one opening; and
a closed end cap positioned at a second end of the filter element, the closed end cap comprising a plurality of end cap lobes coupled to the plurality of filter lobes.

2. The coalescing filter assembly of claim 1, wherein a cross-section of at least a portion of the at least one filter element comprises a substantially trefoil shape.

3. The coalescing filter assembly of claim 1, wherein the plurality of filter lobes comprises at least three lobes having substantially similar shapes and dimensions.

4. The coalescing filter assembly of claim 1, wherein the at least one side wall is shared between the plurality of filter lobes.

5. The coalescing filter assembly of claim 1, wherein the at least one filter element includes at least one concave region positioned substantially between at least two of the plurality of filter lobes.

6. The coalescing filter assembly of claim 5, wherein the plurality of filter lobes and the at least one concave region extend at least partially along the longitudinal length of the at least one filter element.

7. The coalescing filter assembly of claim 1, wherein the plurality of filter lobes includes more than three lobes.

8. The coalescing filter assembly of claim 1, wherein the open end cap comprises a plurality of open end cap lobes; and
wherein at least one of the open end cap lobes is fluidly coupled to at least one of the at least one openings.

9. The coalescing filter assembly of claim 1, wherein the at least one wall comprises a filtration media.

10. The coalescing filter assembly of claim 9, wherein the filtration media comprises a plurality of fluid passages.

11. The coalescing filter assembly of claim 1, wherein at least a portion of the at least one filter comprises a surface property that is at least one of a hydrophobic surface, a super-hydrophobic surface, and a super-oleophobic surface.

12. A coalescing filter assembly comprising:
at least one filter element comprising at least one opening at a first end, at least one fluid inlet, and a plurality of lobes comprising at least one side wall, the at least one wall comprising a plurality of fluid outlets;
an open end cap positioned at the first end, the open end cap comprising a main opening fluidly coupled to the at least one opening;
a closed end cap coupled to a second end of the filter element; and
wherein at least a portion of the at least one filter element comprises a surface property that is at least one of a hydrophobic surface, a super-hydrophobic surface, and a super-oleophobic surface.

13. A filter assembly comprising;
a filter vessel housing a plurality of coalescing filter assemblies, each coalescing filter assembly comprising:
at least one filter element comprising at least one opening at a first end, at least one fluid inlet, and a plurality of lobes comprising at least one side wall, the at least one wall comprising a plurality of fluid outlets;
an open end cap positioned at the first end, the open end cap comprising a main opening fluidly coupled to the at least one opening; and
a closed end cap coupled to a second end of the filter element;
wherein the plurality of coalescing filter assemblies comprises at least one central filter assembly positioned at a substantial center of the filter vessel, and a plurality of outer filter assemblies positioned substantially encircling the at least one central filter assembly.

14. The filter assembly of claim 13, wherein the plurality of outer filter assemblies includes at least a first outer ring of filter assemblies substantially encircling the at least one central filter assembly.

15. The filter assembly of claim 14, further comprising a least a second outer ring of filter assemblies substantially encircling the first outer ring of filter assemblies.

16. The filter assembly of claim 13, wherein at least one of the plurality of coalescing filter assemblies is rotated by about 120° relative to at least one neighboring coalescing filter assembly.

17. A fluid coalescing filter assembly system comprising:
a filter vessel including a vessel inlet and a vessel outlet, the filter vessel defining a lower sump and an upper sump; and
a plurality of coalescing filter assemblies positioned within the filter vessel, each coalescing filter assembly comprising:
at least one filter element comprising at least one opening at a first end, at least one fluid inlet, and a plurality of lobes comprising at least one side wall, the at least one wall comprising a plurality of fluid outlets; and
wherein at least a portion of the at least one filter element comprises a surface property that is at least one of a hydrophobic surface, a super-hydrophobic surface, and a super-oleophobic surface; and
an open end cap positioned at the first end, the open end cap comprising a main opening fluidly coupled to the at least one opening;
a closed end cap positioned at a second end of the filter element; and
wherein the plurality of coalescing filter assemblies comprises at least one central filter assembly positioned at a substantial center of the filter vessel, and a plurality of outer filter assemblies positioned substantially encircling the at least one central filter assembly.

18. The filter assembly system of claim 17, wherein the filter housing encloses a tube sheet comprising a plurality of openings, the tube sheet positioned between the upper sump and the lower sump.

19. The filter assembly of claim 17, further comprising a plurality of risers each including a first end and a second end, the plurality of risers positioned coupling the first end to the plurality of openings.

20. The filter assembly of claim 19, wherein the plurality of risers include end cap portions at the second end; and
wherein the plurality of coalescing filter assemblies are coupled to the plurality of risers by coupling the main opening to the end cap portions.

21. The filter assembly of claim 19, wherein the plurality of coalescing filter assemblies comprises at least one central filter assembly positioned at a substantial center of the filter vessel, and a plurality of outer ring filter assemblies positioned substantially encircling the at least one central filter assembly.

22. The filter assembly of claim 21, wherein the plurality of outer ring filter assemblies includes at least a first outer ring of filter assemblies substantially encircling the at least one central filter assembly and at least a second outer ring of filter assemblies substantially encircling the first outer ring of filter assemblies.

23. The filter assembly of claim 17, wherein at least one of the plurality of coalescing filter assemblies is rotated by about 120° relative to at least one neighboring coalescing filter assembly.
